(19) United States
(12) Patent Application Publication
(10) Pub. No.: US 2003/0216964 A1
(43) Pub. Date: Nov. 20, 2003

(54) Apparatus and method of distributing and tracking the distribution of incentive points

(76) Inventors: Trevor Robert MacLean, Toronto (CA); Jerry Philip, Oakville (CA); Stephen Paul Ogden, Toronto (CA); Darlene Higbee Clarkin, Delta (CA)

Correspondence Address: R. Lewis Gable, Cowan, Liebowith & Latman, P.C., 1133 Avenue of the Americas, New York, NY, 10036, US

(21) Appl. No.: 10/404,995

(22) Filed: Apr. 1, 2003

Related U.S. Application Data
(60) Provisional application No. 60/369,409, filed on Apr. 2, 2002.

(51) Int. Cl. G06F 17/60

(52) U.S. Cl. 705/14

(57) ABSTRACT

A system and method are disclosed in the illustrative context of a loyalty program (LP) for managing the distribution of currency units (points or miles) from at least one currency issuer (LP manager) to at least a selected one of a plurality of currency recipients (LP members) associated with the currency issuer. The currency issuer maintains an account for keeping the balance of currency units held by each of its currency recipients. The currency user also must approve each primary user to which it issues currency units. The system and method facilitate at least one primary user to acquire currency units from the one currency issuer and to distribute same to selected of the plurality of currency recipients.

### PATENT APPLICATION

This application is related to U.S. Provisional Application, which is entitled “APPARATUS AND METHOD OF DISTRIBUTING AND TRACKING THE DISTRIBUTION OF INCENTIVE POINTS,” assigned Serial No. 60/369,409, and filed Apr. 2, 2002 in the names of Trevor R. Maclean, Jerry Philip, Stephen P. Ogden and Darlene Higbee Clarkin, and is incorporated herein by reference.

### FIELD OF THE INVENTION

This invention relates to apparati and methods of managing the acquisition and distribution of currency units. An illustrative embodiment of this operation may be applied to loyalty programs, which issue currency units known variously as points or miles to a plurality of currency recipients known as members. In particular, this invention illustratively supports such loyalty programs and, in particular, permits one or more primary users to acquire and distribute currency units to selected of the members.

### BACKGROUND OF THE INVENTION

This invention has in at least one embodiment an application to loyalty programs (LPs). LPs are designed, as the name suggests, to create and maintain the loyalty of a customer to a particular product or service. The source of such services and/or products is typically also the issuer or distributor of currency units to its members and the redeemer of those currency units for rewards. LPs are based on the concept of encouraging its members to continue to purchase products and/or services from one source, whereby the member is repetitively issued currency and, over a period of time, will accumulate sufficient currency units that may be redeemed for a valuable reward. LPs are created for any number of commercial entities as would be recognized by one skilled in the art. Presently, there are four main types of LPs: 1) travel (airlines, car rentals and hotels), 2) financial (credit cards), 3) retail, and 4) networks (AirMiles, ClickRewards and WebMiles). For example, if a potential member takes an airplane flight, that airline will award its member a corresponding number of units of currency; that potential member has now become a currency recipient or member. In the context of an airline, such units of currency are often referred to as miles. In the context of retailers and credit card companies, units of currency are often referred to as points. In these LPs, the retailer, the credit card company and the airline are often the issuer or source of the currency. In other words, the currency issuer or source may also (but not necessarily) be the commercial entity, whose services and/or products are being promoted by such LPs.

There are now over 5 trillion LP units of currency outstanding around the world. Annually 500 billion new units are issued. Each of these currency units represents real economic value to both the member and the issuer or source. LP's which issue currency units must carry them on their balance sheets as a contingent liability (for example, Business Week has reported that in American Airlines' case this number is greater than $800 million). In some cases, LPs are also using units as a revenue-generating product that sources sell to marketing partners.

The number of LPs has exploded in recent years, thus making it difficult for the members to be knowledgeable about their LP plans, much less interested in participating in them. Presently there are over 90 LPs sponsored by the airlines, i.e., frequent flyer programs. There are hundreds of credit card programs sponsored by financial institutions. There are over 8500 LPs sponsored by retail companies. The number of members who have participated in LPs is greater than 350 million. Globally, there are more than 200 million members participating in frequent flyer LPs, of which 160 million customers participate in LPs sponsored by US airlines. 75% of the UK population carry a loyalty card, while 66% of Canadian households belong to LPs of AirMiles or Sears Club.

The issued units of currency that have not been redeemed has now grown to staggering numbers. There are presently 3.5 trillion currency units in the market today in the North American LPs alone. 500 Billion new units are generated annually in frequent flyer LPs alone. Each unit has an economic value, which can be expressed in monetary units or currency units. Accumulated in the numbers mentioned above, unredeemed units represent huge assets. In addition, unredeemed units represent a liability to the currency source in terms of the future cost to redeem these units. While presenting a liability to the currency sources, they also represent a huge asset base, which is growing annually, as most LPs are accruing more units each year than their currency recipients are redeeming. This positive issue/redeem ratio is expected to continue in the future. Thus while the liability of many currency sources has increased, the opportunity of generating revenue streams for many of the currency sources has grown. Presently, such large currency sources have income from the sale of currency units to their existing members, but also to other business entities.

Currency units typically have a limited life from their date of issuance. Thus, many currency units will expire as a result of a lack of interest in participating in a LP plan, much less in redeeming the awarded currency units. In 1998, 68 billion units expired. The lack of interest and participation results in part from the number of available plans, the complexity of a particular plan, the inability to readily ascertain the balances in the LP's accounts to which a customer may belong and the relatively small value of the currency units. There are billions of units that sit in accounts with very limited redemption options and low utility to a member, i.e., the units are kept in accounts with balance that are below redemption levels, or at levels with limited redemption options. The growing number of LPs have led members to join a number of LPs, thus spreading the units issued to a particular member among the many programs and preventing any one of these plans from accumulating a significant number of units. For the above reasons, few members are achieving significant value from the LPs thereby preventing a LP from meeting its goal of achieving recipient loyalty to a particular LP or source of products and/or services.

There are presently available a number web sites that offer services related to LP programs. MaxMiles and MileageMiner are web sites offering management services to frequent flyers. MaxMiles automatically gathers frequent flyer balances of currency units, e.g., miles, and account information from airlines, hotels, and credit cards, analyzes the most current currency offers, searches for missing currency credits, and sends a personalized report of all currency units via email to the member. The personalized reports are updated daily.

Miles Direct.com is a web site that automatically gathers and reports all of the member's currency units balances from airlines, hotels and credit cards into one consolidated statement. Miles Direct also tracks expiring currency units, activity, and elite levels.

Points Universe is a web site that keeps track of points, miles and other currencies in one statement. A member can also earn currency units, award units, and join a currency universe loyalty program. By shopping/visiting sites, these currency units can be used to redeem products on the Awards Store Catalogue. The AwardMaximizer tool tells you what products can be purchased with your currency units.

Milesandpoints.com is a web service that keeps track of your currency units in one location. The site alerts you about new promotions and offers based on your preferences. The site also reminds its customers when the currency units are about to expire.

MilePoint.com is a web site service that converts any or all of its members' currency units from a plurality of participating frequent traveler programs into a single, common currency to be spent at an assortment of online merchants. Every unit of the common currency is valued at a set rate. For example, if you have 500 units of the common currency and the set rate is $0.02/unit, a customer's common currency units may be converted in a monetary currency, e.g. $10. The common currency is called MilePoint Money and may be used for partial payment of purchases with merchants within the MilePoint network. In addition, Mile Point permits its members to set up accounts and to add selected LPs to its portfolio.

The Netcentives web site provides relationship marketing technologies and services creating loyalty programs for brick-and-mortar, click-and-mortar, and pure-play online companies to maximize the value of their relationships with its customers, employees and business partners. Netcentives creates private label rewards for its clients or can have it's clients participate in ClickRewards.

None of the above described services or web sites recognize much less address the primary problem with LPs, namely that most customers do not accumulate sufficient numbers of currency units at which the recipients can effect redemption's for the rewards. In particular, these services do not teach how currency units may be accumulated into one account. In addition, the above described web sites do not disclose how to efficiently communicate with selected LPs, as well as to manage the liability created by the unredeemed units and, additionally, to generate new and enhanced steams of revenue.

In the situation where the currency issuer or source is also the entity that seeks to promotes its products and/or services, the source must maintain a record of each of its customers who receives its currency, i.e., the members. Typically, a suitable database is employed with a memory for each currency recipient. When currency is either awarded or redeemed, the corresponding units must be correspondingly incremented or decremented against the total units for that recipient. The currency recipients that belong to a particular LP can access its LP's database and, in particular, the particular memory assigned to that recipient to determine the total number of currency units that are presently held by the LP for that particular recipient.

### SUMMARY OF THIS INVENTION

It is an object of this invention to support a system comprising at least one currency issuer or source and a plurality of currency recipients or members, to facilitate at least one primary user to acquire currency units from the currency issuer and to distribute the currency units to selected members of the one primary user.

It is a further object of this invention to distribute currency units to unidentified recipients and to facilitate the subsequent redemption and crediting of such currency units to the accounts of the currency recipients.

It is a still further object of this invention to facilitate the collection and transmission of information regarding a particular primary user to a currency issuer, whereby the currency issuer may agree or refuse to distribute currency units to the particular primary user.

It is another object of this invention to keep track of the currency units distributed to the primary user and to the plurality of currency recipients.

In accordance with these and other objects of this invention, there is disclosed a system for managing the distribution of currency units from at least one currency issuer to at least a selected one of a plurality of currency recipients associated with the currency issuer, which maintains an account for keeping the balance of currency units held by each of its currency recipients. The system facilitates at least one primary user to acquire currency units from the one currency issuer, and to distribute the currency to selected of the plurality of currency recipients. The system includes a host computer, which is programmed to respond to a prompt of the one currency issuer to generate and transmit over a network a first message to the one primary user soliciting information as to the characteristics of the one primary user. The computer is further programmed to retrieve the characteristics information of the one primary user and to generate and transmit over the network to the one currency issuer's computer terminal a second message bearing the retrieved characteristics information, whereby the one currency issuer may approve or decline to issue currency units to the one primary user. Finally, the host computer is programmed to then respond to the one currency issuer's approval of the one primary user to generate and transmit over the network a third message bearing a unique password to the one primary user's computer terminal, whereby the approved one primary user is enabled to communicate with the one currency issuer to acquire currency.

In a further aspect of this invention, the host computer is further programmed to cause the third message to also set up an account for the one primary user for keeping the balance of the current units held by the one primary user, and to distribute the currency units from the one primary user to at least a selected one of the plurality of currency recipients, whereby the distributed currency units are deducted from the account of the one primary user and added to the account of the selected one currency recipient.

In a still further aspect of this invention, a method is disclosed for managing the distribution of currency units from at least one currency issuer to selected of a plurality of currency recipients associated with the currency issuer who maintains an account for keeping the balance of currency units held by each of its recipients. At least one primary user acquires currency units from the currency issuer and transmits this currency to selected of its plurality of currency recipients. In particular, the method comprises the steps of responding to a request from the one primary user for approval of the one currency issuer to acquire currency units from the one currency issuer by facilitating the communication of information regarding the characteristics of the one primary user to the one currency issuer, whereby the currency issuer may approve or decline to issue currency to the one primary user and, if the one primary issuer is approved, creating an account for the one primary user to receive its balance of currency units. Further, a set of currency units is distributed and added to the account of the primary user.

In a further aspect of this invention, a method for managing is disclosed for gathering and transmitting information about the one primary user to the one currency issuer to facilitate its approval or decline to issue currency units to the one primary user. If the one currency issuer approves, an account is created for keeping the balance of currency units acquired by the one primary user and for assigning a password to the one primary user, whereby the primary user may gain access to its account. Thereafter, a primary user may use the password to gain access to its account.

In a still further aspect of this invention, a method is disclosed for prompting the one primary user to determine the number of currency units to be distributed and whether the selected number of currency units are to be transmitted by a first or second transaction. If the selected number of currency units are to be transmitted by the first transaction, the one primary user is prompted to determine a unique account identification of the currency recipient to which the first transaction will be transmitted. If the selected number of currency units are to be transmitted by the second transaction, a unique identification is assigned to the second transaction.

In a still further aspect of this invention, a method is disclosed for effecting, in response to a request of a one primary user, a plurality of transactions to acquire currency units from a one currency issuer, whereby the characteristics of each of the plurality of transactions is determined by one or more parameters. The method further stores in a memory the parameters defining the characteristics of each of the plurality of transactions, selects the parameter(s) indicative of the desired characteristics, and then performs a search of the stored parameter for the desired characteristics of the plurality of transactions.

In a further aspect of this invention, a method is disclosed for carrying out in response to the request of a one primary user, a plurality of transactions to distribute the currency units stored in the primary user's account to select of the plurality of currency recipients. Thereafter, the parameters of each of a plurality of effected transactions is stored in a memory. Then, the parameter(s) of the desired transaction characteristics are selected, before the parameters stored in the memory are searched for the desired characteristics of the transactions.

### BRIEF DESCRIPTION OF THE DRAWINGS

Many details and advantages of the present invention will be apparent to those skilled in the art when this document is read in conjunction with the attached drawings where matching reference numbers are applied to the matching element and where:

FIG. 1 shows a functional block diagram illustrating a preferred embodiment of this invention in the context of a loyalty program that permits one or more so called primary users to acquire currency from a currency issuer and selectively distribute the currency units to select of the currency recipients, each of which is associated with a currency issuer, e.g., is a member of a particular loyalty program that issues the currency units, e.g., points, miles etc.;

FIGS. 2A and B are a first illustrative embodiment of the flow diagrams of the steps executed by the programmed host computer shown in FIG. 1, whereby at least one primary user is approved by a currency issuer, an account is assigned to the approved primary user who is granted access to its account and currency points are transmitted from the at least one currency issuer, retained in the primary user's account and, then, distributed to selected of the plurality of currency recipients;

FIGS. 3A and B show a flow diagram for permitting an approved primary user to use a password to gain access to its account to acquire and distribute currency points to select of the plurality of currency recipients;

FIGS. 4A-L illustrate a plurality of screens or web pages generated by the host computer shown in FIG. 1 to implement the steps shown in the flow diagrams of FIGS. 2A and B;

FIGS. 5A-K illustrate a plurality of screens or web pages generated by the host computer shown in FIG. 1 to implement the steps shown in the flow diagrams of FIGS. 3A and B;

FIG. 6A illustrates a more detailed flow diagram of a further illustrative embodiment of this invention for permissioning a primary user to access its account to acquire currency units from a currency issuer and to distribute such units to selected of a plurality of currency recipients;

FIG. 6B is a more detailed showing of a flow diagram of a subroutine that facilitates a proposed primary user to disclose its characteristics to a currency issuer and to be accepted or rejected by the currency issuer;

FIG. 6C is a detailed flow diagram of a process for facilitating a currency recipient of one or more currency certificates to redeem the distributed currency units and to credit them to the currency recipient's account; and

FIGS. 7A to AD illustrate a plurality of screens or web pages generated by the host computer shown in FIG. 1 to implement steps variously shown in the flow diagrams of FIGS. 6A, B and C.

### DESCRIPTION OF THE PREFERRED EMBODIMENT OF THIS INVENTION

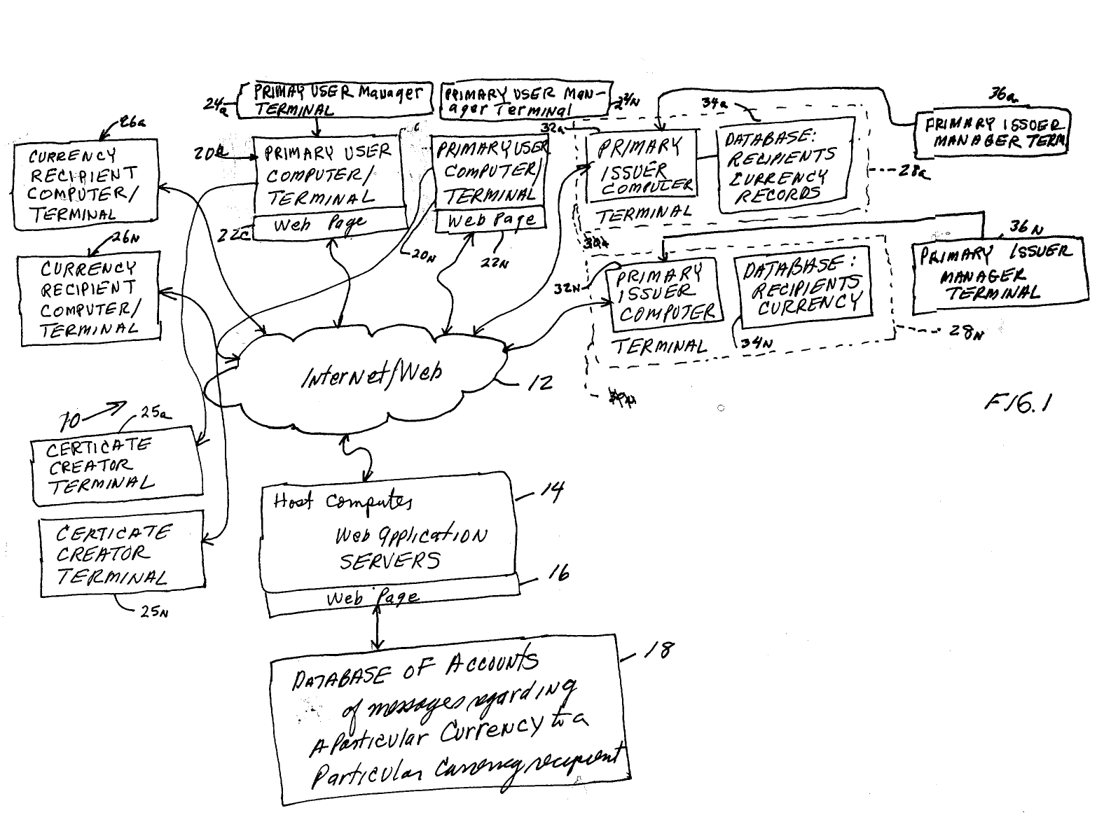

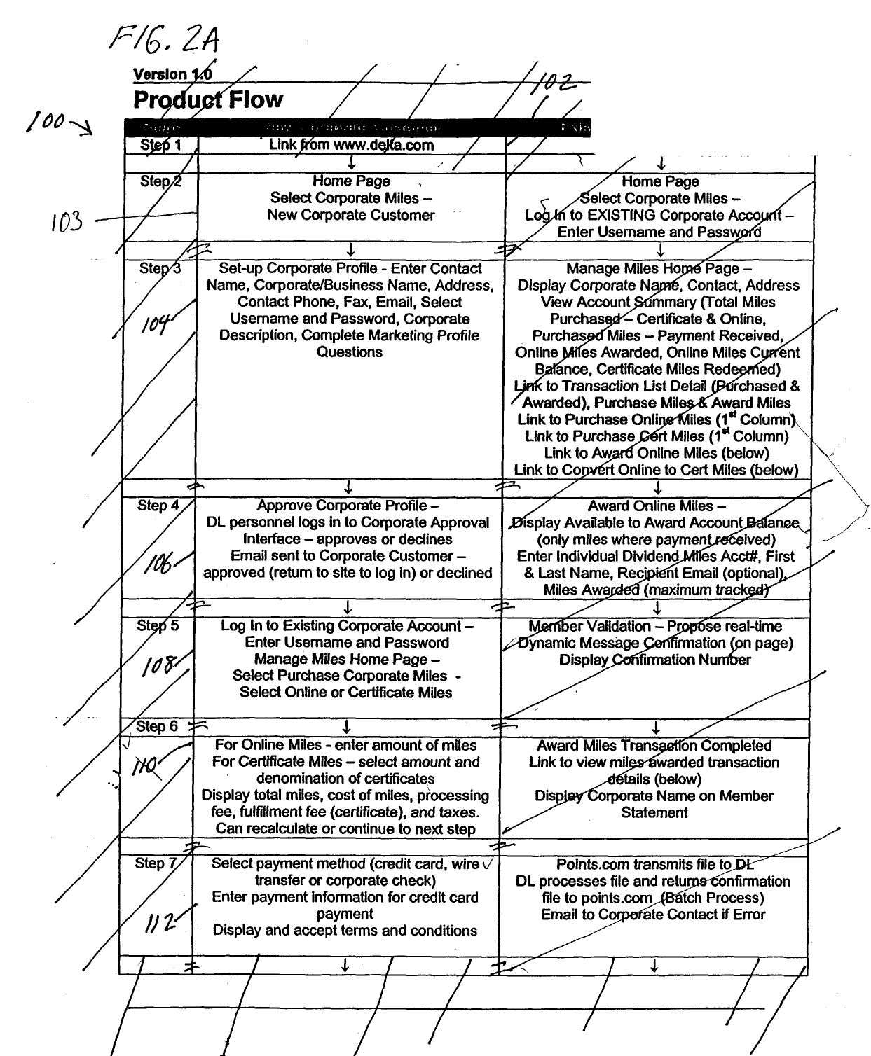

Referring now to the drawings and in particular to FIG. 1, there is shown a functional block diagram of a preferred embodiment of a system 10 for distributing units of currency among a plurality of entities that are associated with the currency distribution system 10 in accordance with the teachings of this invention. Illustratively, the entities include: 1) at least one primary currency issuer for issuing and redeeming the currency units; 2) at least one currency recipient, i.e., the customer or the member to whom the currency units are awarded or otherwise distributed; and 3) at least one primary user who purchases or otherwise acquires currency units from the primary currency issuer and awards or otherwise distributes its currency units to selected of the currency recipients. It is appreciated that this invention contemplates that more than one of each of the above named entities can be readily accommodated by the currency distribution system 10 of this invention. These entities are interconnected with each other over a data path, which illustratively may take the form of the Internet 12 or any other of the data paths and/or networks that are known to those skilled in this art. Communications between these entities are controlled by a host computer 14.

In particular, each primary currency issuer operates its primary currency issuer terminal 28, which includes a primary issuer computer 32 and a database 34 for storing a record for each currency recipient that has been awarded or otherwise received the particular currency units from its corresponding primary currency issuer. This inventions contemplates that there may be a plurality of primary currency issuers and that each such issuer may issue its own distinct units of currency. FIG. 1 shows a plurality of the primary issuer computer terminals 28a-28n, each processing its unique kind of currency in a preferred embodiment of this invention. Each terminal 28 includes a primary currency issuer manager terminal 36 whereby a manager, illustratively (though not necessarily) an employee of the primary currency issuer, can use its terminal 36 to communicate with a host computer 14 and its database 18, and/or a selected one of a plurality of primary user computer terminals 20. Each of the primary issuer computer terminals 28 is connected with its corresponding primary issuer manager computer terminal 36 to enable the manager to communicate with a corresponding one of the primary currency issuer's terminals 28a-n and with the host computer 14.

Further, each of a plurality of terminals 26a-n, is provided for the corresponding currency recipient or customer to communicate with a selected currency issuer and a corresponding one of the primary currency issuer terminals 38a-n, with a selected primary user and a corresponding one of the primary user terminals 20a-n., and with the host computer 14.

Illustratively, each of the primary issuer terminals 28a-n is related to its own currency and to its own Loyalty Program LP. For example, the primary currency issuer could illustratively be American Airlines and the units of the currency could illustratively be AAdvantage Miles. The currency recipient may also be a member of the LP; in the American Airline example, the currency recipient would illustratively be an AAdvantage Mile Member. Note that a currency recipient may be a member of more than one LP. In an illustrative embodiment of this invention, the recipient's currency database 34 is comprised of a plurality of records, wherein the current total number of the currency units uniquely associated to this particular primary issuer terminal 28 and its LP, is stored. It is appreciated that a particular currency recipient can typically only own or hold a particular currency if that recipient is properly associated, e.g., is a member of the LP, with the primary currency issuer and its terminal 28. In this illustrative example, the database 34 of the corresponding terminal 28 has a currency account record for each recipient of this kind of currency, typically a member of this LP. In this fashion, each currency recipient or member can access its current total of units of a particular currency by transmitting an inquiry from a recipient's terminal 26 via the internet 12 to the corresponding primary issuer terminal 28 and, finally, to its database 34. In this illustrative embodiment, it is appreciated that each of the plurality of currency issuer terminals 28a—n is established and/or maintained by a distinct entity. For example, the primary issuer terminal 28a could be operated by Delta Airlines, while terminal 28b is maintained by the American Express Co. It is contemplated that in at least one illustrative embodiment of this invention, that the host computer 14 and its database 18 are established and/or maintained by an entity that is distinct from either of the operators/managers of the primary issuer terminals 28. In this illustrative embodiment, the entity establishing and/or operating the host computer 14 provides computer software services to the currency issuer terminals 28a—n.

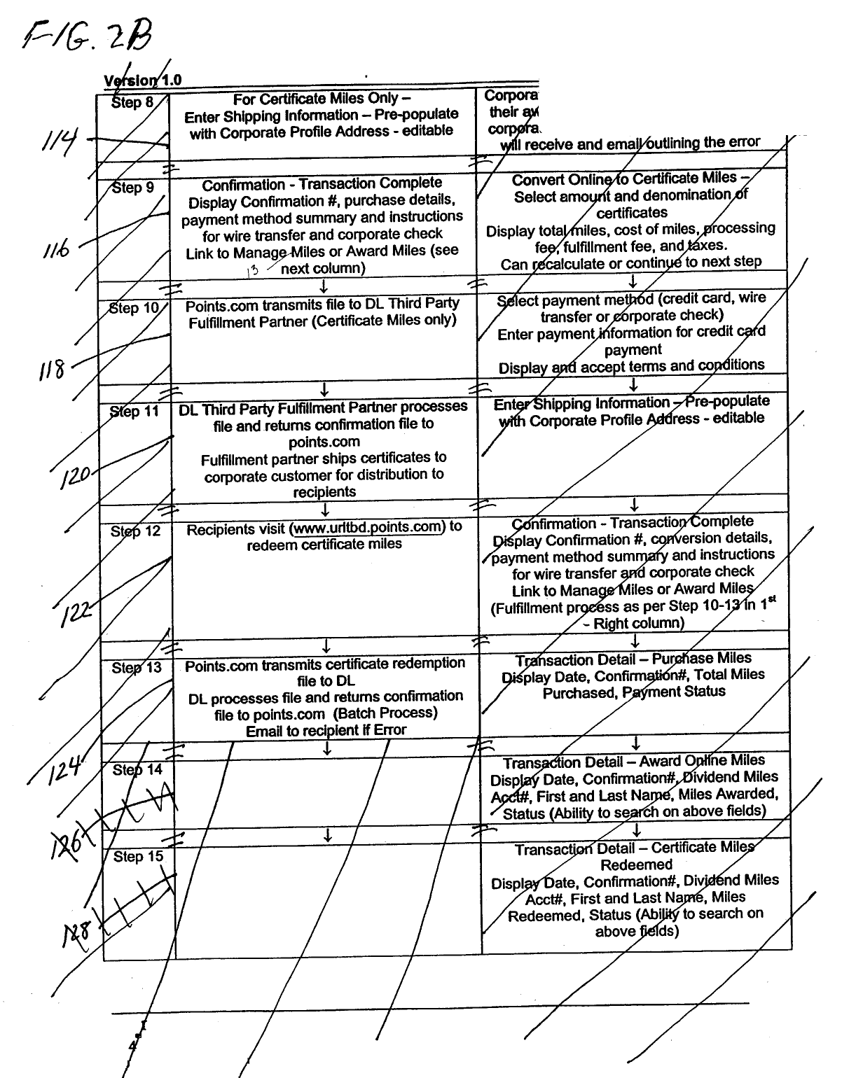

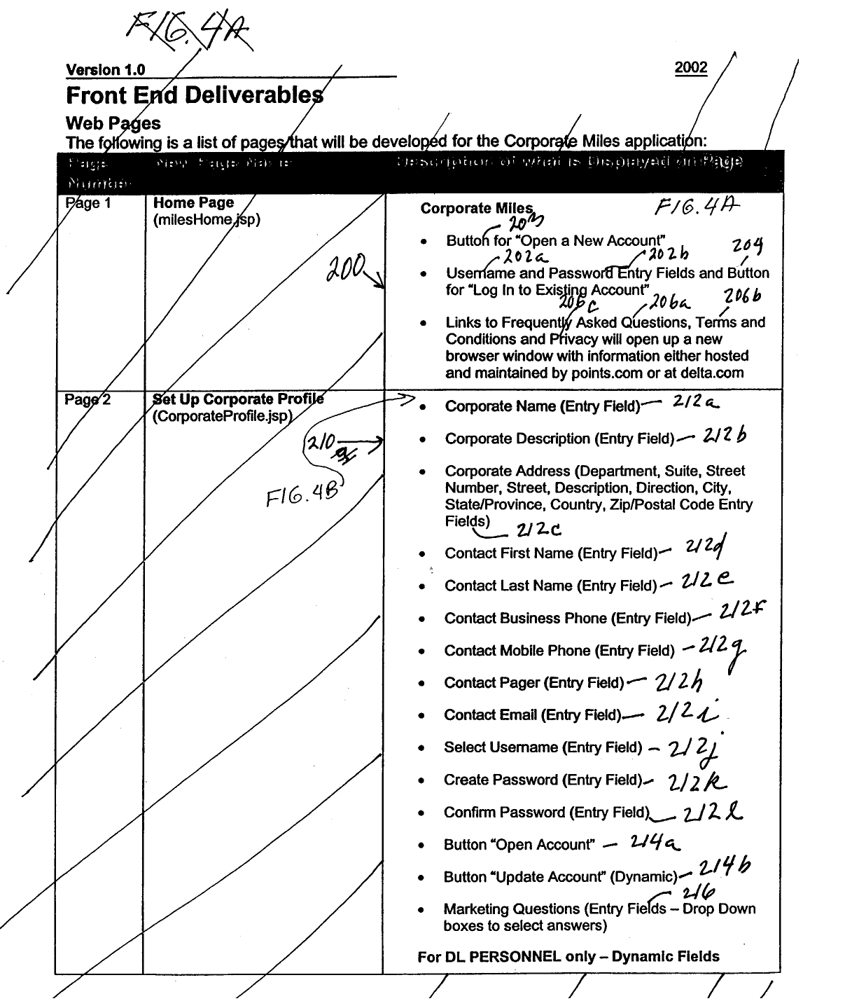

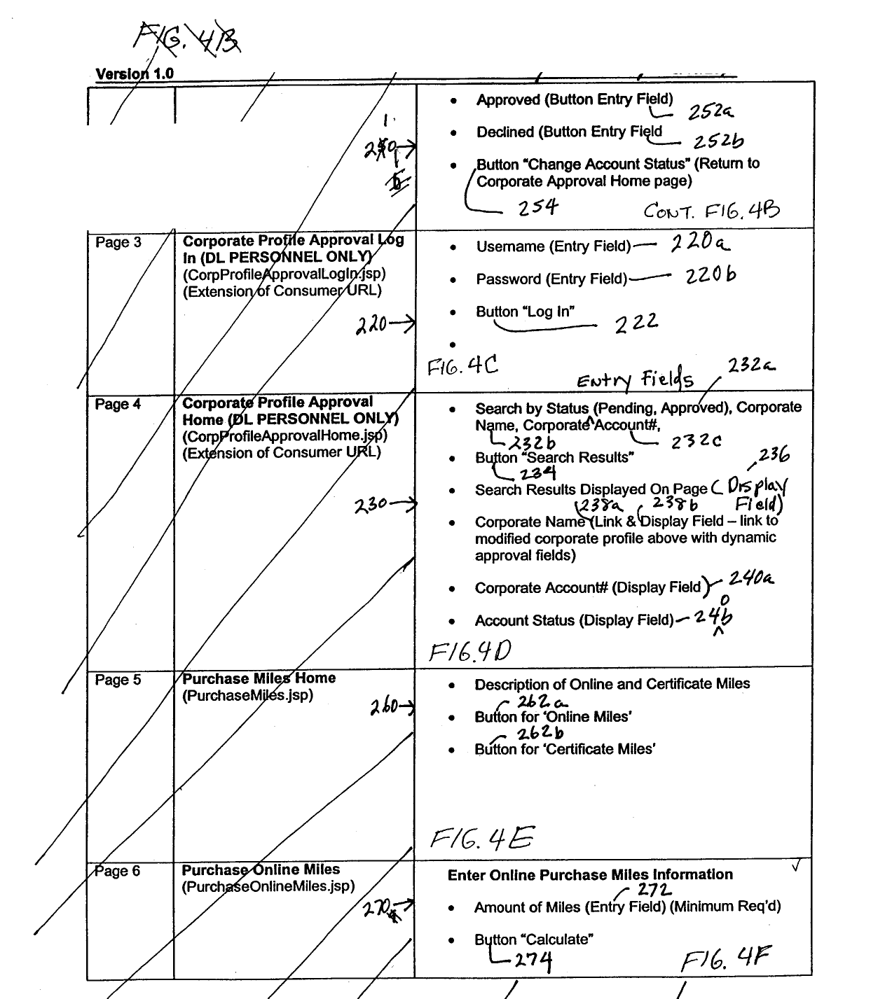

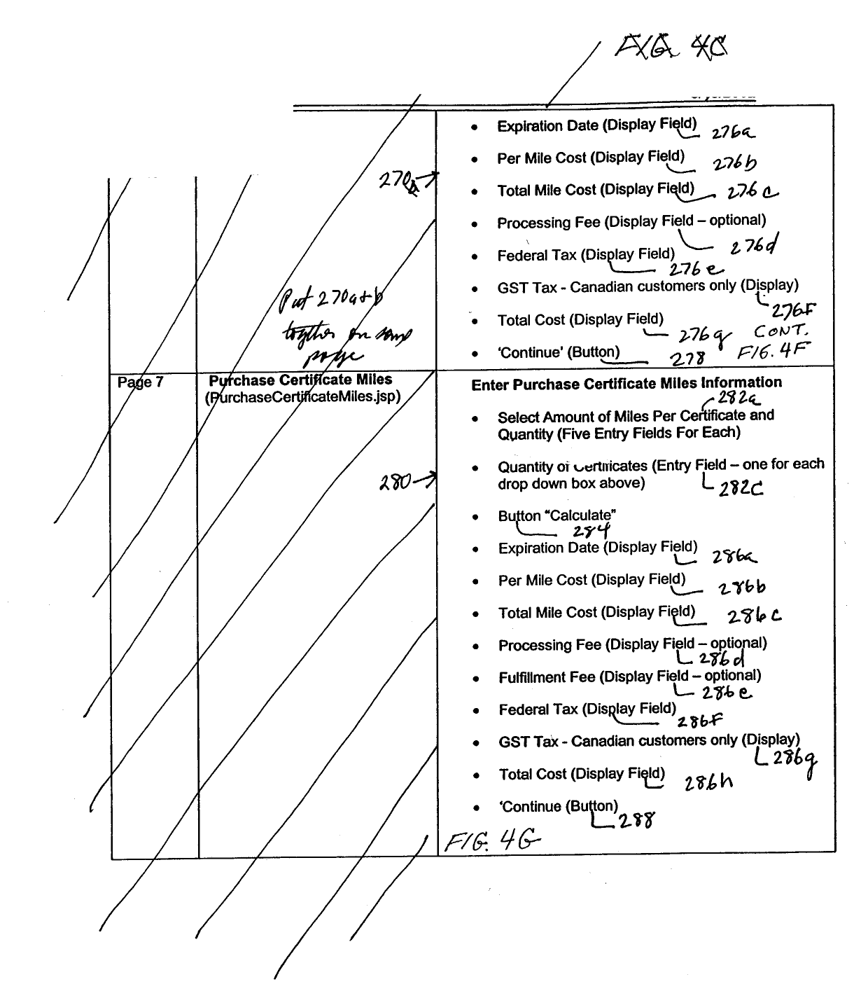

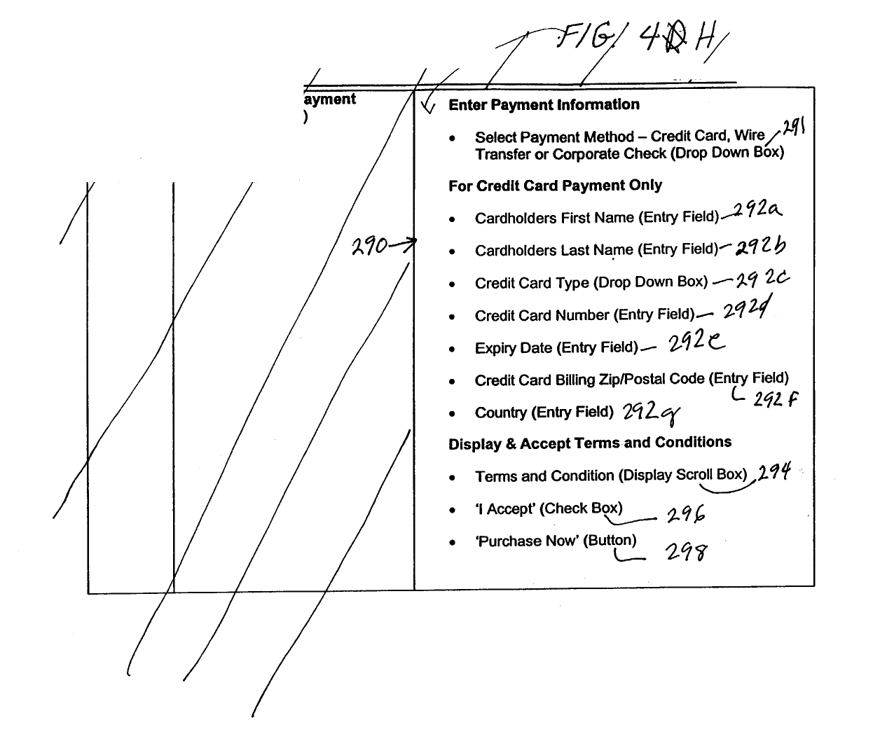

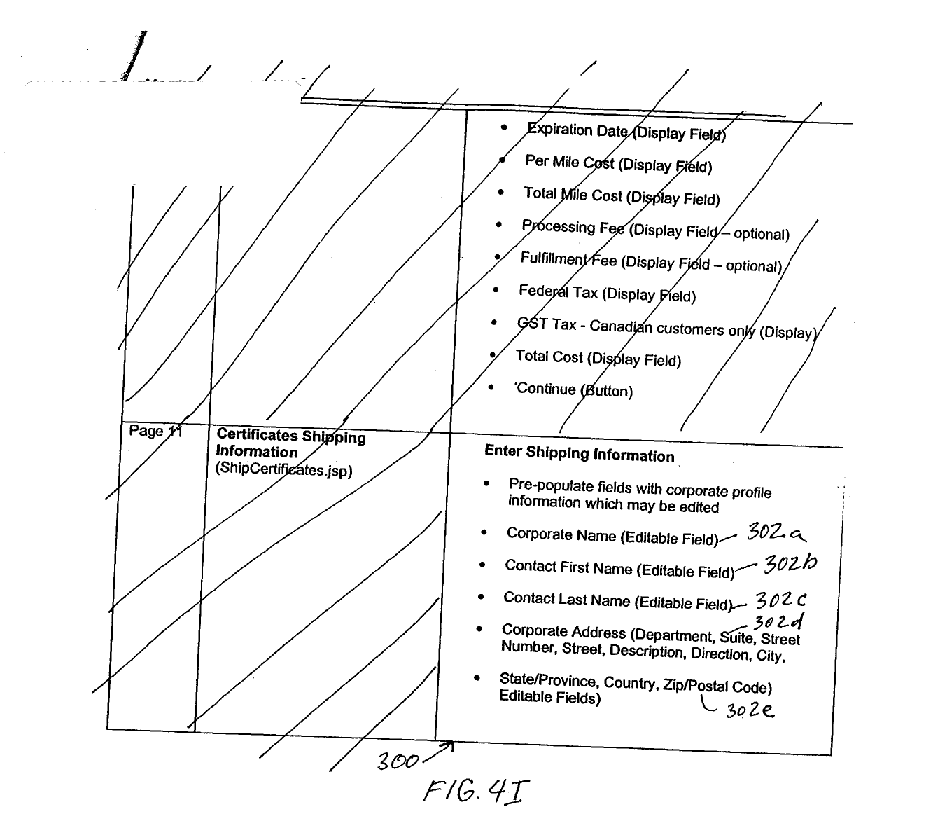

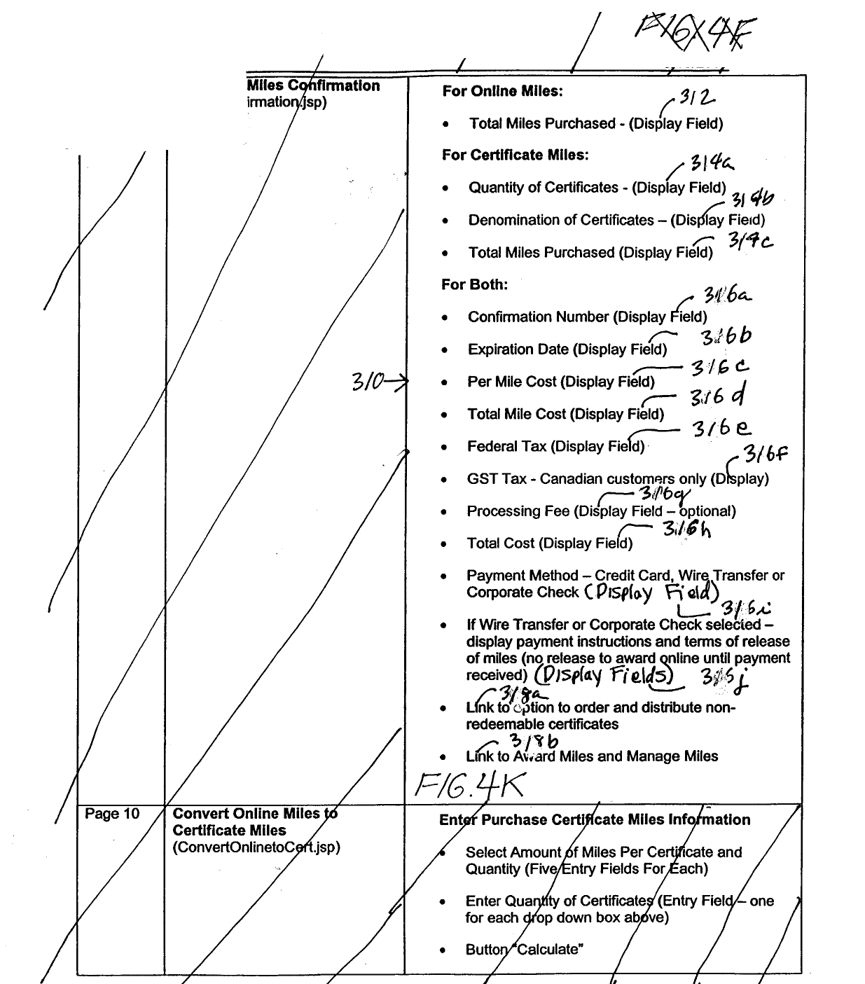

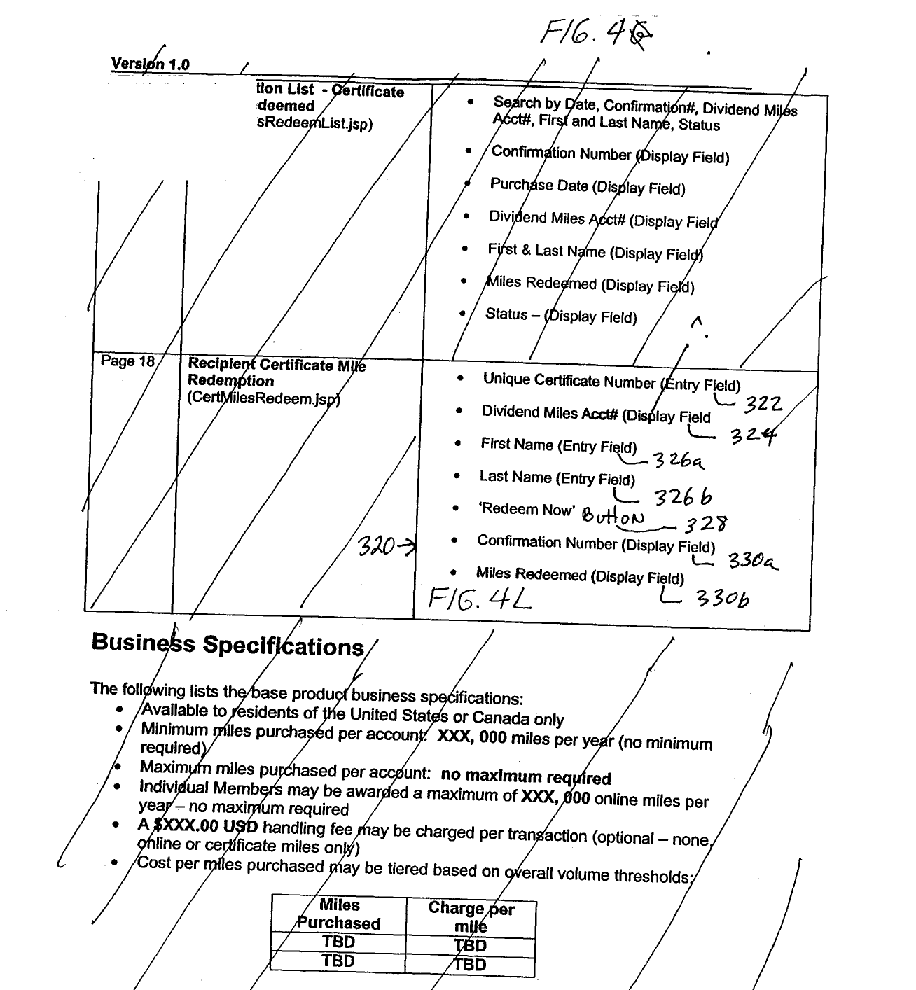

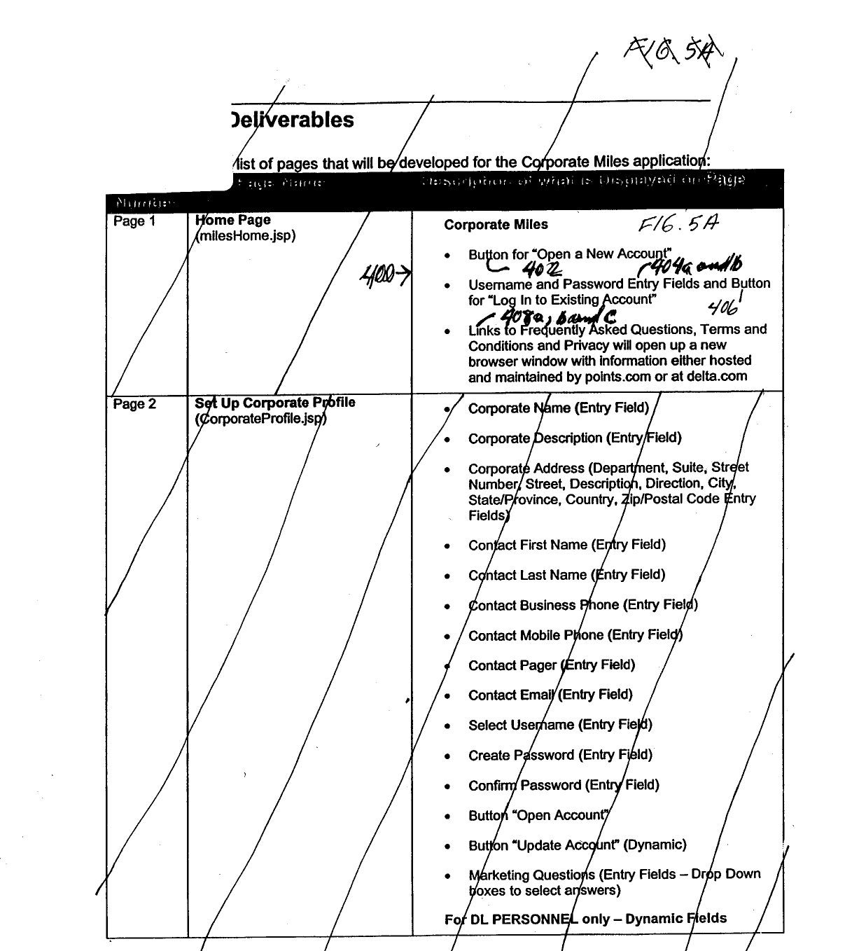

Referring now to FIGS. 2A and B, and FIGS. 4A-L, there is respectively shown the flow diagram of a web application software 100 with which the host computer 14 (FIG. 1) and its web application servers are variously programmed, and a series of web pages or screens, which are created in the course of executing the flow diagrams as shown in FIGS. 2A and B. Initially in step 102, a manager of one primary user actuates its terminal 24 to log on for the first time to a “home” web page 200 that is shown in FIG. 4A. The “home” web page 200 is created on each of the primary currency issuer computers 32a-n. The “home” web pages 200 may be typically designed to reflect the private-label of the currency issuer, e.g., Delta, and to handle the various functions of the Delta LP. As shown in FIG. 4A, the “home” web page 200 includes a button 203, which may be actuated by the primary user manager to initiate the creation of a new account for the primary user. The “home” web page 200 further comprises data entry fields 202a and b for entering respectively the name of the primary user and its password, and a button 204 to permit the primary user manager to log into an existing account of its primary user. Further, links 206a, b and c are provided to actuate pull down displays of frequently asked questions, terms and conditions and privacy policies, respectively.

Upon initial access to the “home” web page 200, the manager of the primary user will click on the button 203, that will link the manager in step 104 to a “set up a primary user” web page 210 as shown in FIG. 4B. The web page 210 permits the manager to create a composite primary user profile and includes data entry fields 212a-l for entering respectively the primary user's name, corporate description, address, first name of the contact, e.g., the primary user manager, the last name of the contact, phone number of the contact, mobile phone number of the contact, pager number of the contact, contact Email address, selected username, password, and confirm password. After the above data has been entered and the profile for the new primary user has been created, the primary user manager clicks on the button 214a to open an account for the new primary user. There is further provided a button 214b, which the manager may actuate to update the primary user's account, and a data entry field 216, which may be actuated by the primary user manager to ask questions about the currency units being issued.

Next, a manager of the corresponding currency issuer uses its terminal 36 to access in step 106 into the web page 210 as shown in FIG. 4B, which is stored in a corresponding database 34 and effects the display of the profile of the potential primary user on an issuer manager terminal 36. The web page 210 is displayed to the currency issuer's manager on its terminal 36. The web page 210b includes an approval button 252a and a disapproval or declined button 252b. There is further included a “Change Account Status” button 254, which may be actuated by the currency issuer manager to return to the home pages 200 (FIG. 4A) where the status, i.e., pending, approved or disapproved, of the particular currency issuer may be changed. The currency issuer manager will then actuate one of the “approval” button 252a or the “declined” button 252b to indicate whether the constructed primary user profile is approved or disapproved, and a message, e.g., an Email, is sent to the corresponding primary user informing it whether it had been approved or declined. Typically, each primary currency issuer has its own set of rules for approving or declining a potential primary user. For example, a potential primary user must in one illustrative embodiment be at least an organization; individuals are not accepted. There may also be limits as to the income of an organization, as well the type of business in which a primary user is engaged. Further, there may be a rule that a particular currency issuer may not accept more than one primary user in the same type of business. Though the above embodiment contemplates that an employee of the primary currency issuer would review the primary user profiles, a particular profile could be compared with a set of the rules of a currency issuer by well known Artificial Intelligence techniques.

After a particular primary user has been approved by the primary currency issuer manager in step 106, the primary user manager is returned in step 108 to the site where a “primary user profile approval log in” web page 220 is displayed as shown in FIG. 4C at a terminal 24 (FIG. 1) of a corresponding primary user manager. A primary user profile approval log in web page 220 includes a data entry field 220a for inputting the name of the primary user whose profile was approved in step 106, and a data entry field 220b for entering the password of that primary user whose account was approved in step 106. After the primary user name and the password have been so entered, the primary user manager clicks on the “log in” button 222, whereby the primary user manager has access to the approved primary user profiles, which are stored in an accounts database 18. The database 18 is connected to the host computer 14 as shown in FIG. 1.

As shown in FIG. 4D, the currency issuer manager has access via its terminal 36 (FIG. 1) to the previously stored primary user accounts and, in particular, to a “primary user profile approval home” page 230. The web page 230 facilitates the currency issuer manager's entry of parameters to search for a profile of a corresponding primary user and, in particular, includes a primary user status (pending or approved) entry field 232a, a primary user name entry field 232b and a primary user account number entry field 232c. After entry of a particular primary user search parameter (or set thereof), the currency issuer manager clicks on a “search results” button 234, whereby the names of all of the primary users matching the entered search parameters are displayed on a display field 236. The currency issuer manager can click on a link 238a for a selected primary user name, whereby a corresponding profile will now appear with dynamic approval fields in a display field 238b. The currency issuer manager may now change or update the data about the corresponding primary user. The current primary user account number and status will appear in the corresponding display fields 240a and b.

After the primary user profile (for a particular currency) has been approved in step 106 (FIG. 2A) by the corresponding currency issuer manager, the primary user (using this particular currency) may now continue in step 108 to a “purchase miles home” web page 260 as shown in FIG. 4E, which permits the primary user manager to purchase a number of currency units from the currency issuer who has approved this primary user's profile. The web page 260 includes an “online currency units” button 262a and a “certificate currency units” button 262b, to initiate the process either over the Internet 12 or by the issuance of certificates, which typically are hard copy or paper documents. After the primary user has purchased the currency, the primary user is then permitted as will be explained below to give, award or distribute the currency to selected of its customers, referred to herein as currency recipients. The motivation of the primary user is to promote the sale of its services or goods, by awarding currency units to selected currency recipient(s) in the context of marketing its products or services to those recipient(s). It is appreciated that there will be promotional situations where access to the Internet is not readily convenient, or the name or account number of a potential customer is not know. In these situations, paper certificates may be given manually to such prospective customers. As will be explained below, such a customer can then redeem its certificate(s) for currency, gift(s), money or other consideration.

After the primary user has clicked on the “online currency units” button 262a, the program displays in step 110 (FIG. 2A) a “purchase online currency units” web page 270 as shown in FIG. 4F on the primary user's manager's terminal 24 (FIG. 1), whereby the primary user manager may select the number of currency units to be given and the currency recipient to whom the currency will be given. The web page 270 includes a data entry field 272, into which the manager enters the number of currency units to be awarded or given. Thereafter, the primary user manager clicks on a “calculate” button 274, whereby various parameters of this transaction, e.g., currency units, are calculated and then displayed. In particular, the web page 270 further includes data fields for the expiration date 276a, the cost per currency unit 276b, the total cost of the awarded currency units 276c, the processing fee 276d, the federal tax 276e, other taxes (state, province, GST (Canadian) etc. 276f, and the total cost 276g. If the displayed entered data is acceptable, the primary user manager may accept the number of currency units by actuating a continue button 278 to proceed to the next step. If not acceptable, the manager may enter a different number of currency units into the display field 272 and click again on the “calculate” button 274 to recalculate the total cost.

If the primary user instead wishes to purchase currency unit certificates, the primary user's manager clicks on in step 110 the “certificate currency units” button 262b as displayed on the “purchase currency units home” web page 260 (FIG. 4E), whereby a “purchase certificate currency units” web page 280 is displayed as shown in FIG. 4G on the primary users manager's terminal 24 (FIG. 1). The web page 280 enables the manager to set the number of currency units to be awarded by a single certificate in its data field 282a, and the number of certificates desired in field 282c. There may a number of different fields 282a to permit different denominations to be generated, and a single field 282c for each of the fields 282a. After setting the denomination and the number of certificates, the primary user manager clicks on a “calculate” button 284, whereby a set of characteristics of the purchased currency units (similar to those defined on the web page 270) are displayed in data display fields 286a to 286h. If the displayed characteristics are not satisfactory, the manager may recalculate them by resetting the denominations of and the number of certificates in fields 282a and c respectively. If the characteristics of the purchased currency units are now acceptable, the primary user manager clicks on a “continue” button 288, whereby the program 100 proceeds to the next step.

In particular, the program 100 moves to step 112, as shown in FIG. 2A, whereby the primary user makes arrangements to pay the currency issuer for currency units purchased by the primary user. Step 112 causes a “purchase currency units” web page 290, as shown in FIG. 4H, to be displayed at the primary user manager's terminal 24 (FIG. 1). In particular, the web page 290 is displayed upon the terminal 24, and includes a drop down box 291 to permit the primary users manager to select payment by credit card, wire transfer or user check. If the primary user manager has selected credit card, the manager will fill in the credit card data into the following data entry fields: first and last names of credit card 292a and b, type of credit card 292c, credit card account number 292d, expiration date 292e, Zip code of credit card holder 292f, and card country 292g. After the credit card data has been entered, the terms and conditions as required by the currency issuer are displayed in a scroll box 294. If the primary user accepts, its manager clicks on a “I Accept” box 296 and a “purchase now” button 298.

If the primary user has selected in step 110 (FIG. 2A) to purchase currency unit certificates, the program now moves to step 114 as shown in FIG. 2B, whereby “a certificate shipping information” web page 300 as shown in FIG. 4I is displayed at the primary user manager's terminal 24 (FIG. 1) to facilitate the entry of shipping information. The web page 300 includes the following data entry fields: primary user name 302a, first name of a contact or manager of the primary user 302b, last name of the contact 302c, address of primary user 302d, and state/province name and Zip code 302e. Illustratively, the program 100 prepopulates these fields with previously entered data and then permits the primary user manager to edit and update this data with the current information.

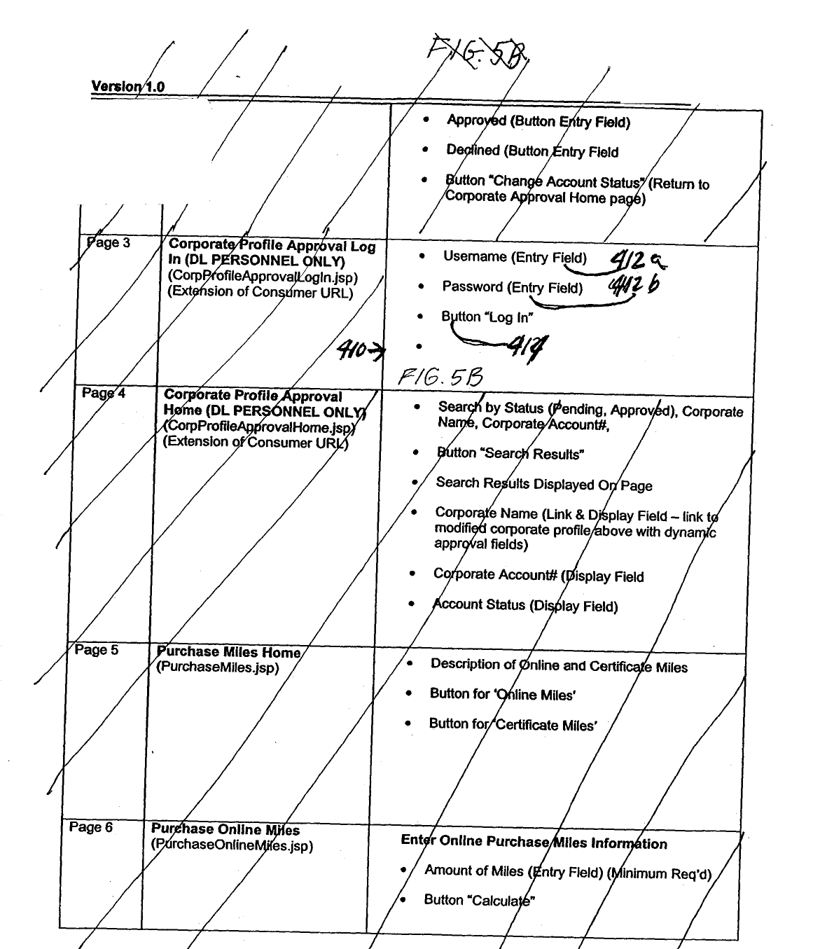

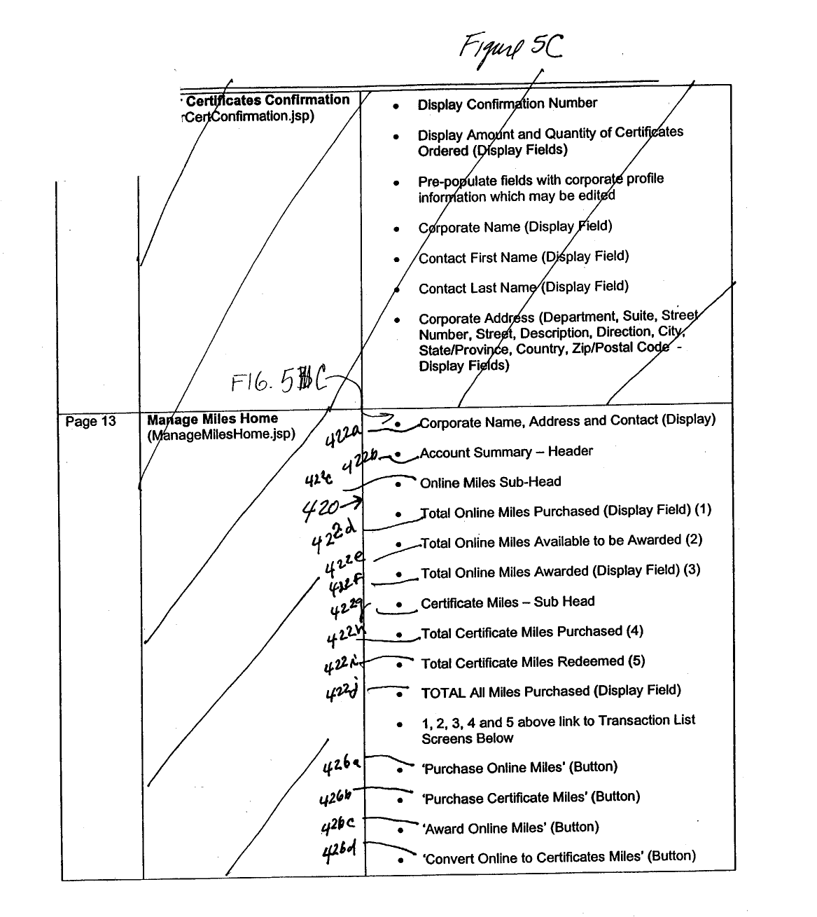

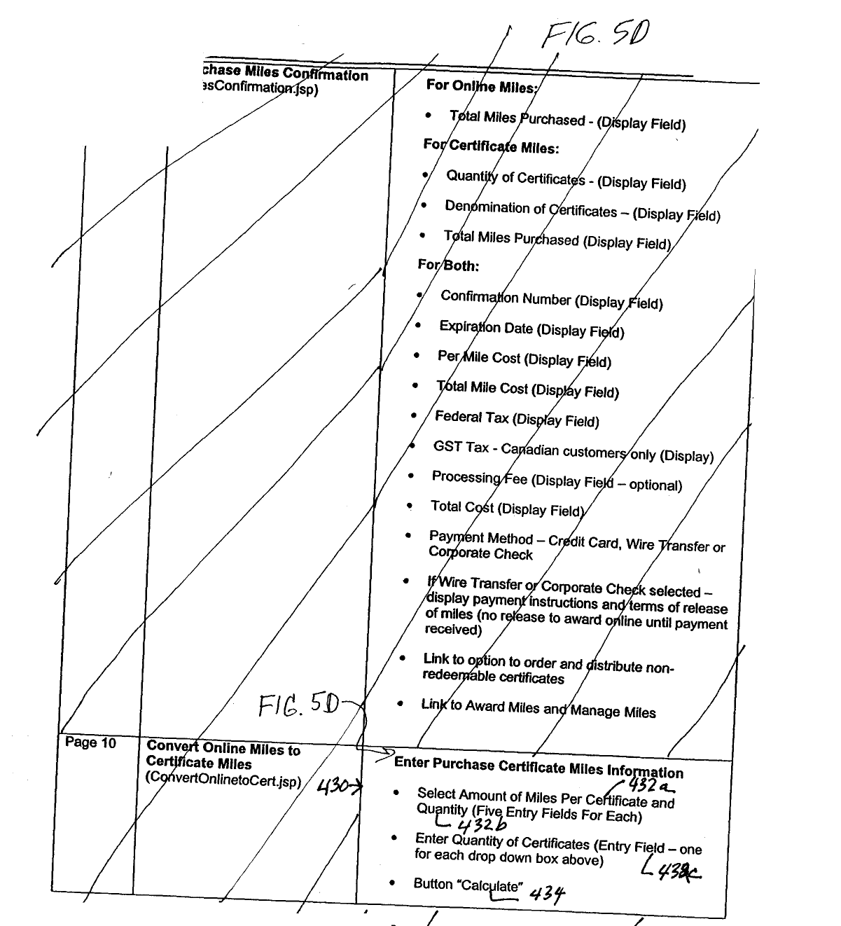

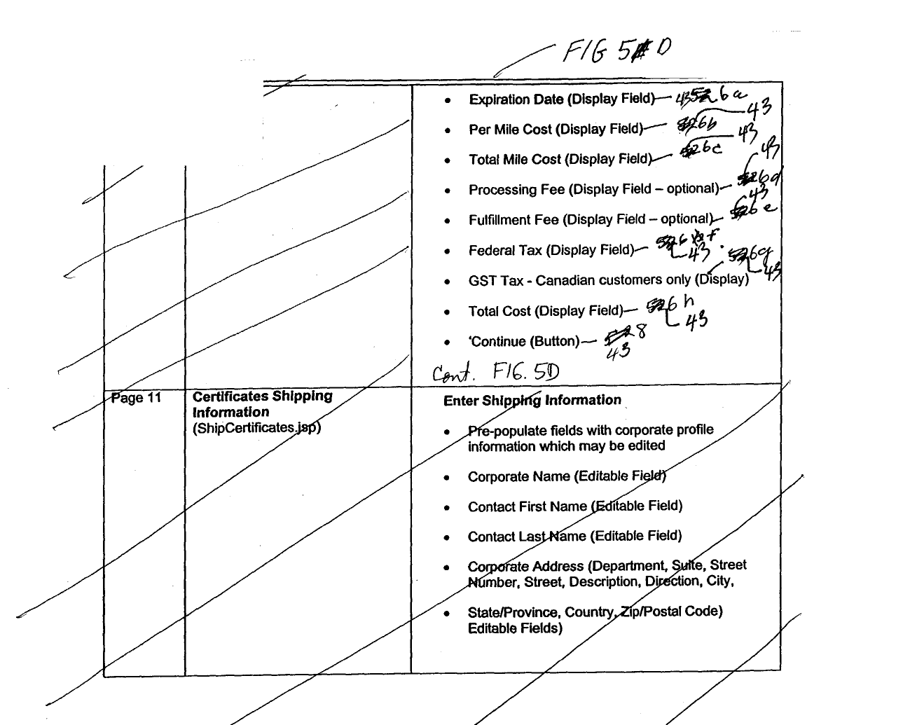

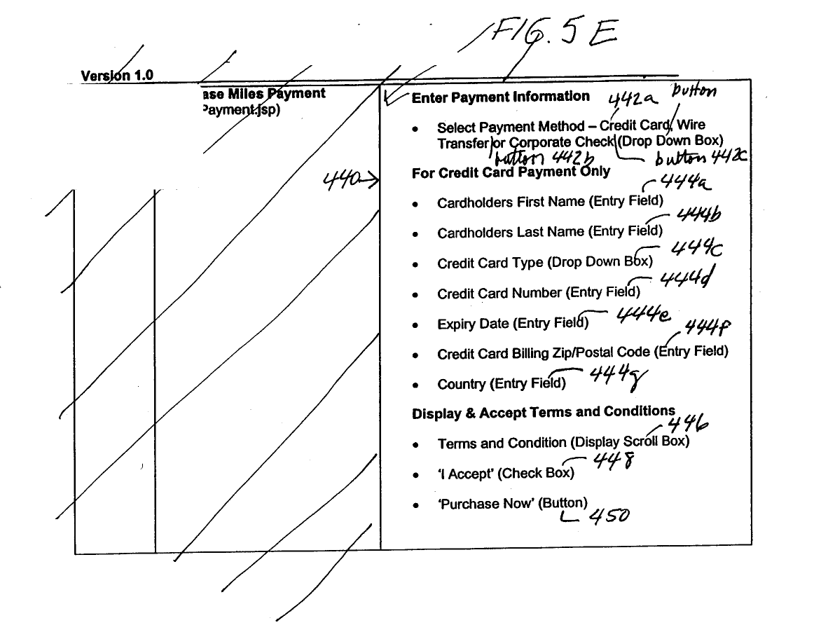

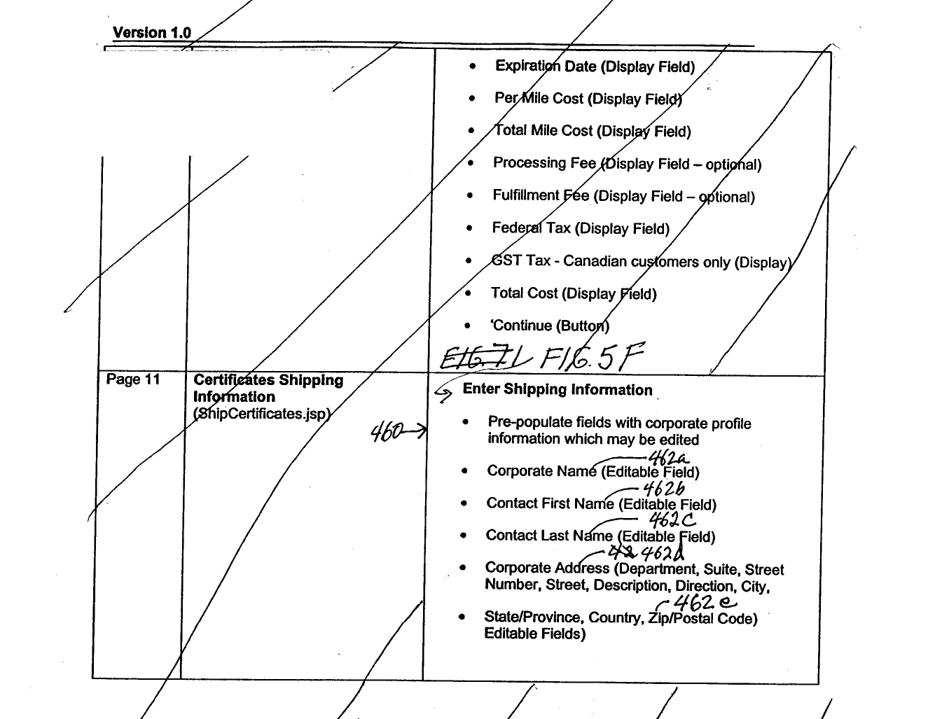

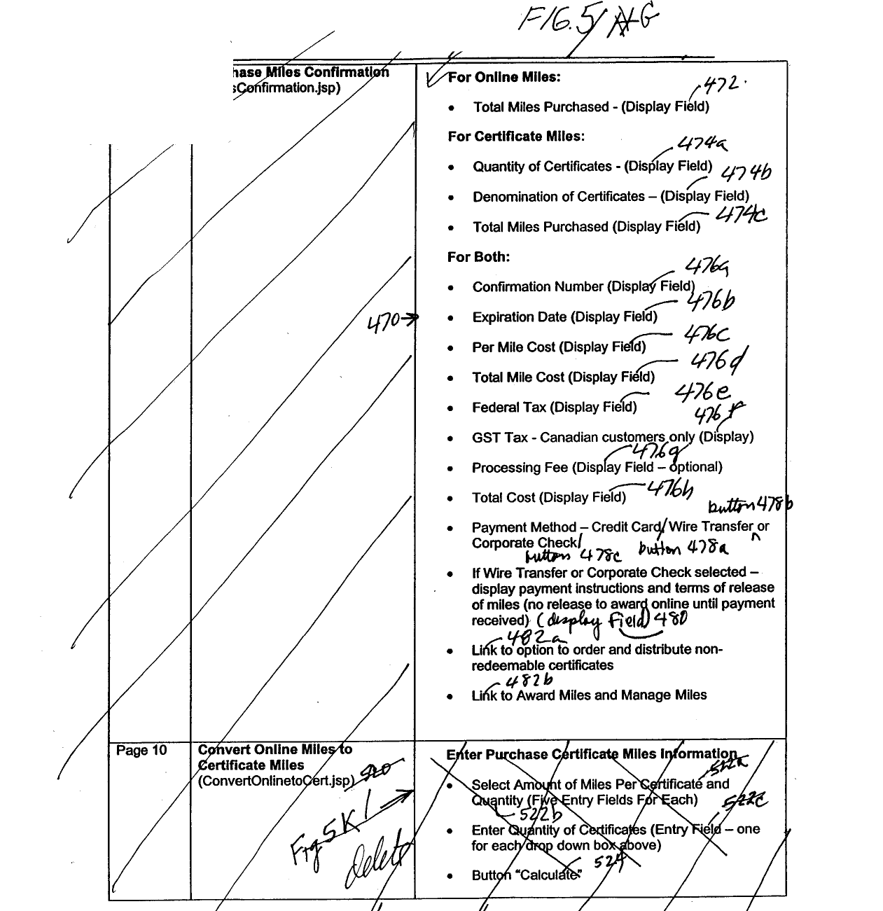

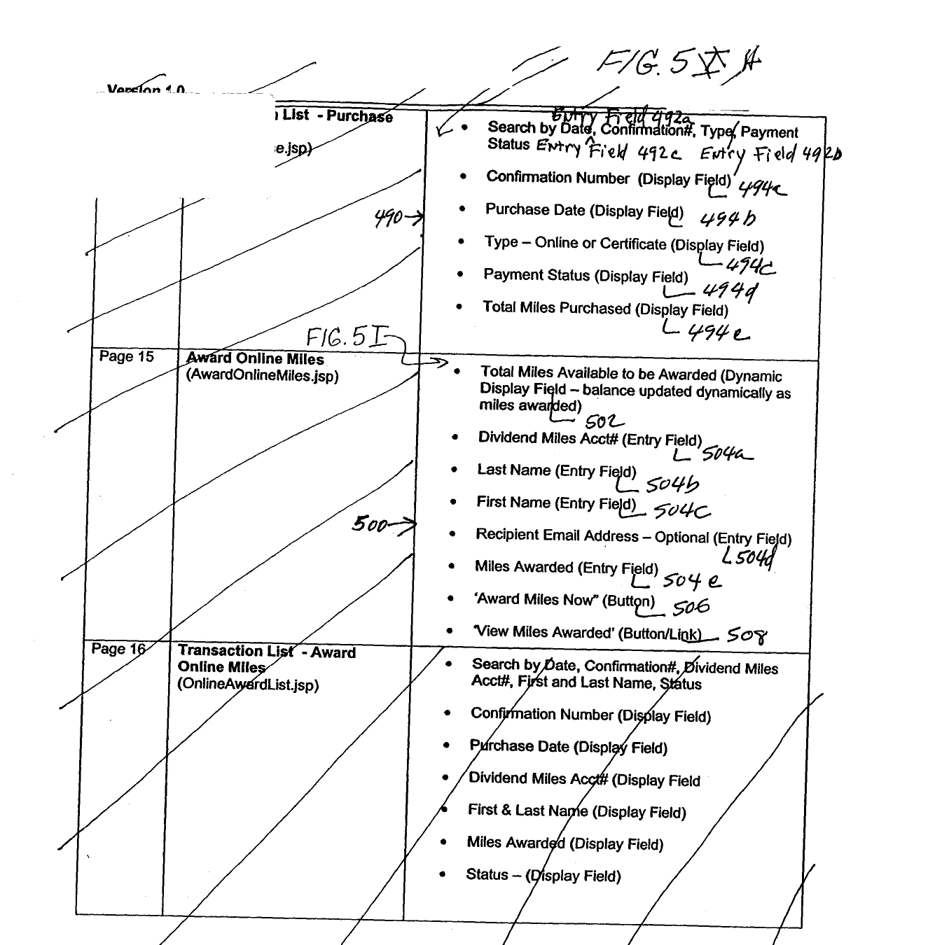

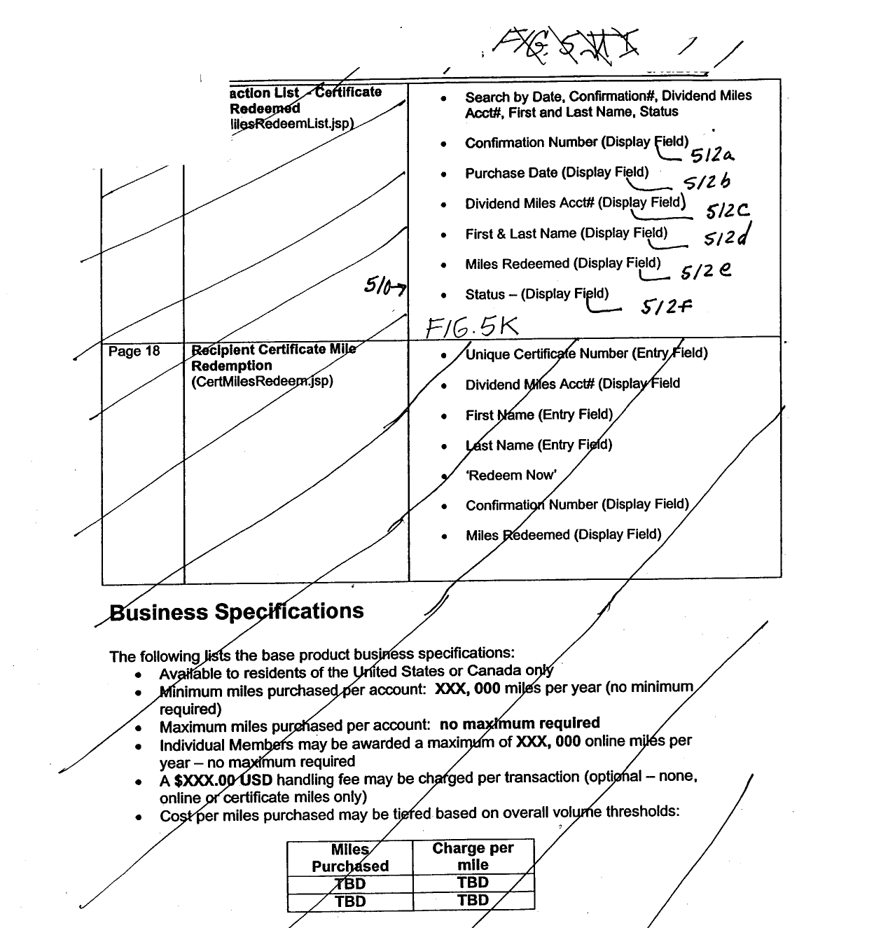

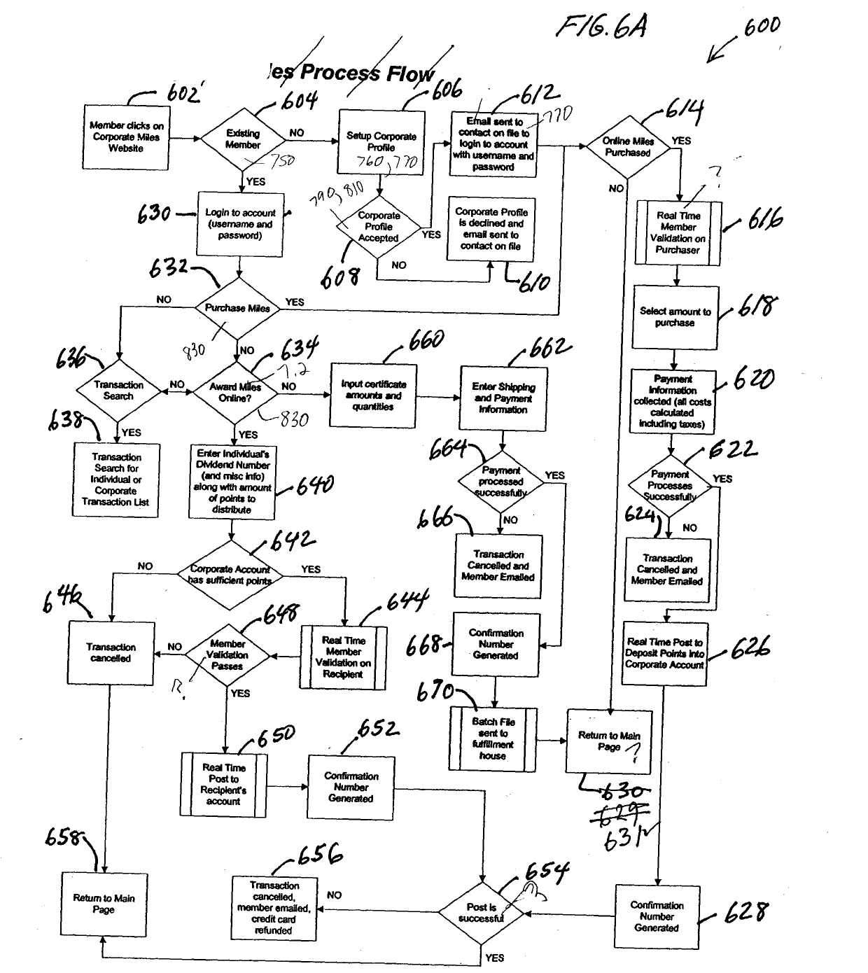

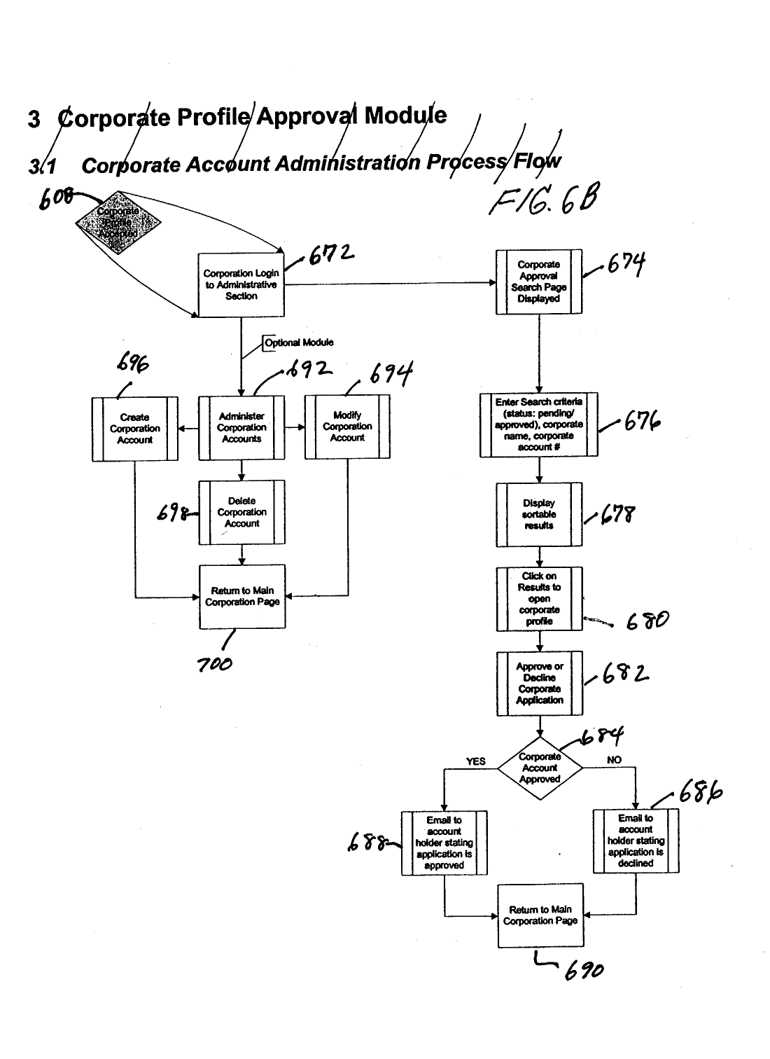

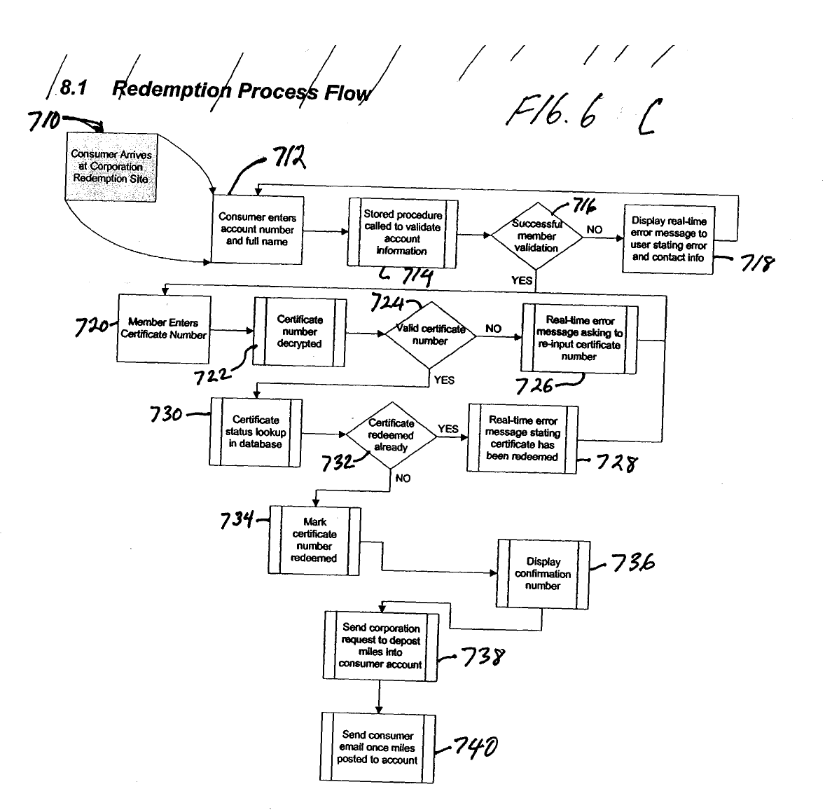

After the terms of the sale of currency units by the primary user have been accepted and this sale has been completed in step 112, a message confirming the acceptance of the sale is transmitted in step 116 to the primary user and, in particular, to the primary users manager's terminal 24, where a “purchase miles confirmation” web page 310 as shown in FIG. 4K displays the purchase details. In particular, the web page 310 displays the number of online or certificate units of currency that were purchased, as well as a sale confirmation number, purchase details, payment method summary and instructions as to payment. In particular, the web page 310 includes the following display fields: total online units of purchased currency 312, number of currency certificates 314a, denomination of certificates 314b, total number of certificate units of currency 314c, the confirmation number of the sale 316a, expiration date of the sold units of currency 316b, cost per unit of currency 316c, cost of the total of the currency units 316d, the federal tax 316e, GST Tax (a Canadian tax on purchasers) 316f, processing fee 316g, total cost 316h, selected method of payment 316i, and payment instructions 316j. Finally, the web page 310 includes a link 318a to open a manage miles web page 420 which will be explained below with respect to FIG. 5C, and a link 318b to open an award online units of currency web page 500 which will be explained below with respect to FIG. 5I.

After the primary user purchases in step 112 as shown in FIG. 2A certain certificates of currency units and a confirmation thereof has been sent in step 116 (FIG. 2B) to that user, the host computer 14 (FIG. 1) is programmed to send in step 118 a file to a partner or associate of the primary user; this file contains a record of the number of certificates purchased by this primary user, the number of currency units carried by each of these certificates, and the unique identifying number carried by each certificate. This partner may, for example, be an employee or an independent contractor of the primary user. In step 120, the partner receives the file and provides a confirmation file or message to the host computer 14 (FIG. 1) indicating that a given number of certificates and currency units has been received. In step 120, the partner processes the received file, produces or otherwise prints the ordered certificates and places the unique ID numbers thereon, before these certificates are delivered to the primary user placing the order. This primary user can now distribute the certificates to recipients of its choosing.

The currency recipient may now redeem the certificate that it was given by a particular primary user. Such redemption involves the transfer of the given number of currency units from the primary user to the recipient. Illustratively, the primary issuer of a particular currency maintains in its database 34 a first record of the number of units of its currency that have been purchased by a particular primary user and a second record of the number of currency units held by the recipient of the certificate and/or the online currency units and its designated number of currency units. In this illustrative embodiment, the host computer 14 (FIG. 1) sends a message to the computer 32 of the issuer of the transferred currency to effect a transfer of the designated currency units from the primary currency issuer's account to the recipient's account, both accounts being established in the corresponding database 34. It is appreciated that individual currency records of the currency recipient and the primary user are maintained in the database 34 of the primary currency issuer's terminal 28, and not in the database 18 of the of host computer 14. Rather, the database 18 associated with a particular issuer and its currency only stores the messages that are transmitted from the host computer 14 to the terminal 28 of a particular currency issuer to effect a transfer of that particular currency units from one account to another, e.g., from the account of a primary user to that of a recipient who has received an award or grant of currency units from that primary user to a particular currency recipient. The storing of the messages from each of the currency issuers, the primary users and the currency recipients in the database 18 associated with the host computer 14 permits the administrator of the host computer 14 to readily monitory the operation of the currency distributing system 10. In particular, the host's computer administrator track errors in the accounts of the primary users and the currency recipients. Further, the host computer can readily communicate by way of Emails, for example, with any of these system players and, in particular, provide them with information about their transactions as are stored in the database 18. Also, the host administrator can readily access the database 18 to permit him/her to change and/or update the software stored therein. Further, the database 18 provided storage for separate files for each of the currency issuers, the primary users and/or the currency recipients.

In an illustrative embodiment of this invention, certificate redemption is carried out on a web site 16 created on the host computer 14 with a particular URL or address. The currency recipients are notified, illustratively by the distribution to them of certificates that bear the web site's address, whereby the recipient can visit in step 122, as shown in FIG. 2B, this web site 16 to redeem the currency units as set out on its certificate. The web site 16 downloads a “recipient certificate currency unit redemption” web page 320, as shown in FIG. 4L, to a corresponding terminal 26 or a currency recipient to facilitate that recipient to redeem its certificate. In particular, the web page 320 includes the following data entry fields to facilitate a particular currency recipient using its terminal 26 to enter certain data: the unique ID number born by the certificate 322, the currency account number for a particular recipient 324, the first name of the currency recipient 326a, and the last name of the currency recipient 326b. After the data has been entered, the currency recipient clicks on a “redeem now” button 328, whereby the collected data is transmitted from the currency recipient terminal 26 via the Internet 12 to the host computer 14, where it is entered stored in a certificate redemption file of the database 18.

In step 124 as shown in FIG. 2B, the host computer 14 may illustratively transmit the certificate redemption file via the Internet 12 to the computer 28 of the issuer of the currency being distributed. The computer 28 processes this file and, in particular, checks that the currency recipient and the primary user have accounts with this issuer, and reduces the total currency units in the currency recipient's account by the number of the transferred units of currency, before transmitting back to the host computer 14 a confirmation message bearing the current, adjusted total number of currency units now held by the recipient. Upon receipt of the confirmation message, a confirmation number is displayed, as shown in FIG. 4K, in the display field 316a and the number of the redeemed units of currency is displayed in the units redeemed display field 314c. The currency issuer's computer 28 processes and returns the confirmation file to the host computer 14. If an error is detected, a message is transmitted to the currency recipient, e.g., by Email. Finally, the currency issuer's computer 28 will cause the set number of currency units to be transferred to the recipient's account that is stored in the database 34.

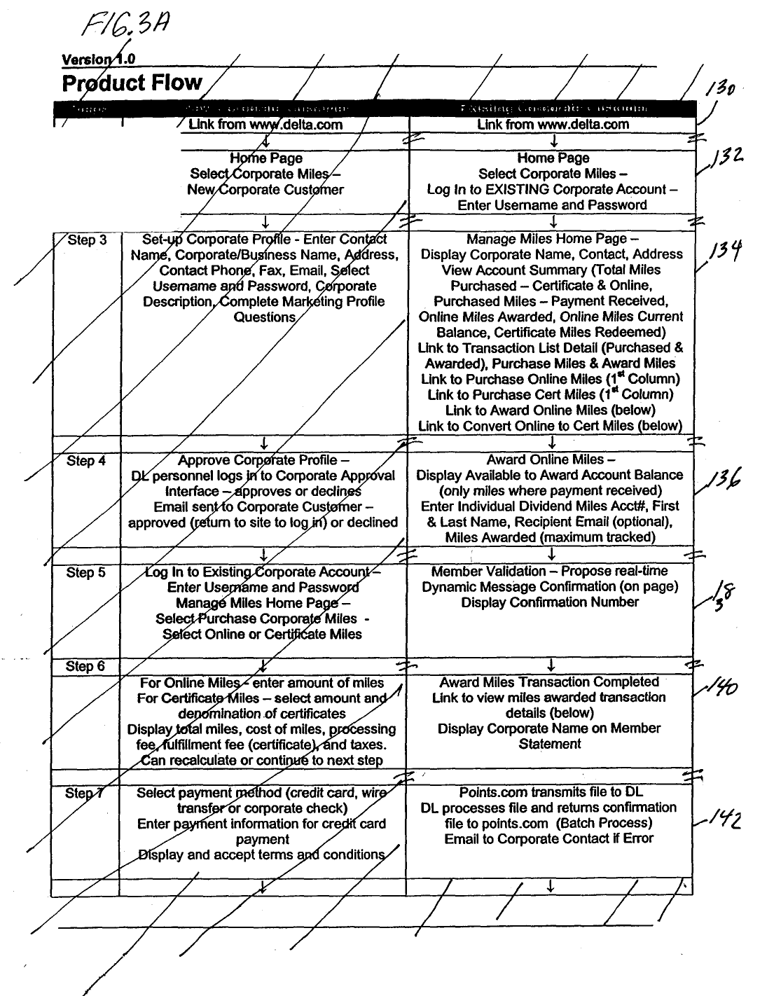

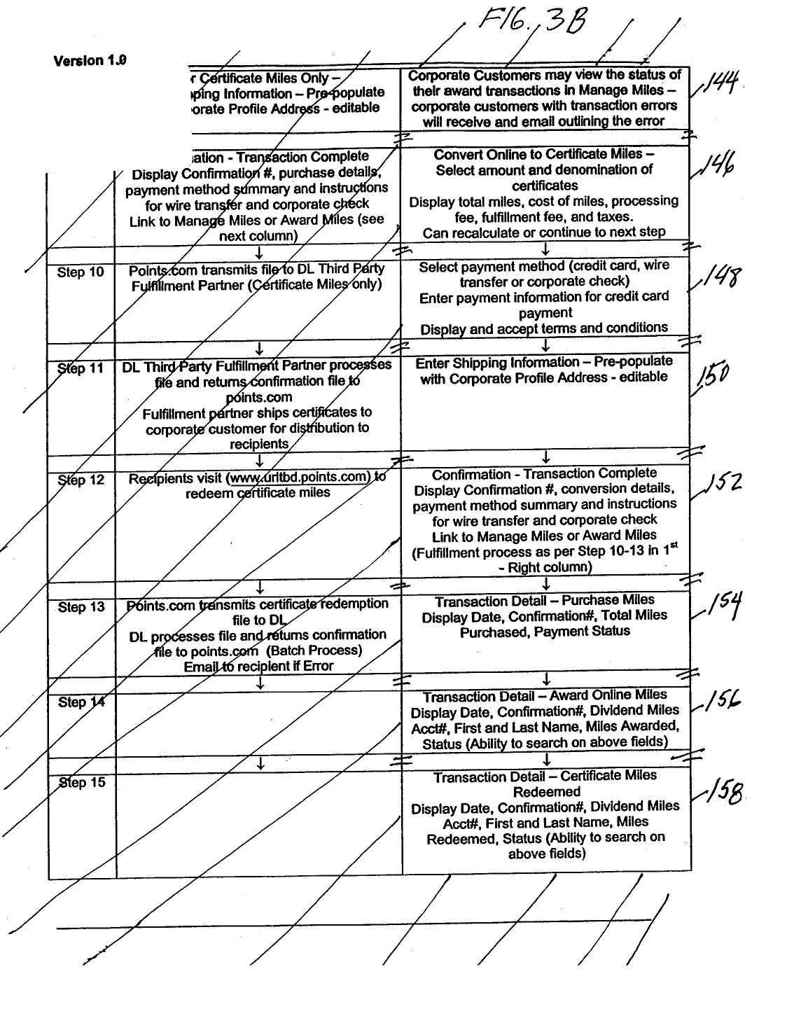

Referring now to FIGS. 3A and B, there is shown a program for permitting the primary user, who has an existing account with a particular currency issuer, to access or login directly to its account. Initially in step 130, the previously registered primary user accesses the web site 16 of that currency issuer as maintained at the host computer 14. In step 132 (FIG. 3A), a home page 400 as shown in FIG. 5A is displayed at the terminal 24 of the primary user's manager, and includes a log into an existing account button 406. The home web page 400 resembles the home page 200 which was described above with respect to FIG. 4A. The primary user's manger clicks on the button 406 to log in to the existing account of that primary user, before the manager enters the primary user's name and password into the data entry fields 404a and b, respectively. Links 408a, b and c are provided to permit the manager access to other information as explained above with respect to FIG. 4A.

The primary user manager can link from its web page 400 (FIG. 5A) to a “manage currency units home” web page 420 as shown in FIG. 5C, which is displayed in step 134 (FIG. 3A) to permit the primary user's manager to view various data representing currency units that are received and distributed by this primary user. The manage miles home web page 420 includes the following fields for displaying certain data: the name, address and contact data for the manger or contact 422a, an account of all of the units held by a primary user 422b, an account of the on line currency units 422c, the total online units of currency purchased by the primary user 422d, the total online units of currency available to be awarded 422e, the total online units of currency awarded 422f, the total certificate units of currency purchased 422g, the total certificate units of currency redeemed 422h, the total units redeemed 422i, and the total units of currency purchased 422j. The web page 420 includes the following display fields: 422d, 422e, 422f, 422g, 422h and 422j, which also serve as links to the transaction screens (not shown). These screens permit the user's manager to search the previous transaction history of purchases or awards by variable or field definition. Further, the manage miles home web page 420 includes a “purchase online units of currency” button 426a, a “purchase certificate units of currency” button 426b, an “award online units of currency” button 426c, and a “convert online to certificate units of currency” button 426d. Clicking on one of these buttons will bring the user manager to that part of the program. For example, when the primary user manager clicks on the “award online units of currency” button 426c, the program 100 moves to step 136 as shown in FIG. 3A, wherein the primary user's manager may award a selected number of such units to selected currency recipients.

In step 136, an “award online currency units” web page 500 is displayed as shown in FIG. 5I. Step 136 determines whether or not a particular primary user has paid a particular currency issuer for its ordered currency units. If so, step 136 dynamically updates the total currency units of the primary user by adding the paid for units to the previous currency total of the primary user, and subtracting those units from the primary user's total that are distributed to a currency recipient's account. The updated primary user's total of currency units is displayed in the display field 502. Further, the primary user's manager can enter data identifying a particular currency recipient including its account number into the a data entry field 504a, the last and first names of the currency recipient into the data entry fields 504b and c, and the recipient's email address into the data entry field 504d. After a particular currency recipient has been so identified, the primary user's manager enters the number of currency units to be awarded to the identified currency recipient into the entry field 504e, before the primary user's manager clicks onto the “award miles now” button 506, whereby the selected number of currency units are transferred from the primary user to the currency recipient. Thereafter in step 138, the host computer 14 transmits a message via the Internet 12 to the terminal 24 of a primary users manager to indicate that the distribution of currency units had been completed, to initiate an update of the account of that currency recipient, i.e., to add the number of units distributed by this primary user to the donee currency recipient's account, and to provide the primary user manager a confirmation number that confirms that this transaction has been completed. Each of the messages is related to a particular primary user, and is placed in a designated file and stored in the data base 18.

Further, the primary user's manager may click on a button/link 508, whereby the program 100 displays in step 140 to a “manage currency units home” web page 420, as shown in FIG. 5C, to permit the total units of currency awarded or distributed to be displayed in the display field 422f.

After processing the message generated and sent in step 138 to the primary users and, in particular, the data related to the currency units awarded by the primary user, the host computer 14 withdraws the awarded currency units data from the database 18 and transmits them in step 142 in the form of a confirmation file to a corresponding currency issuer terminal 32. The accounts for keeping a record of the currency units held by primary users are retained in the database 18 of the host computer 14. The host computer 14 processes the data held in a confirmation file to determine whether there was an error in the number of currency units distributed or awarded by a primary user to a recipient and, if there is an error, a message is sent, e.g., via Email or the Internet, to the terminal 32 of the involved primary user's manager. Thereafter as shown in FIG. 3B, the primary user manager may link in step 144 to the manage miles web page 420 as described above with respect to FIG. 5C to view the status of its currency distribution or awards. In addition, any primary user who has a transaction error will receive Email messages detailing that error.

When the primary user's manager clicks on to a “convert online to certificate” currency units button 426d of the web page 420, as shown in FIG. 5C, step 146 opens up a “convert online to certificate currency units” web page 430 as shown in FIG. 5D. The primary user's manager enters on its terminal 24 the amount of currency units per certificate in the data entry field 432a, the denominations of the certificates into the data entry field 432b, and the quantity of the certificates into an date entry field 432c. Thereafter, the manager clicks onto a “calculate” button 434, whereby the total miles, cost of the miles, processing fee, fulfillment fee, taxes and other related parameters are displayed in the fields 436a-h. Thereafter, the manager may continue to the next step 148 by clicking on a “continue” button 438, or recalculate by entering another set of data into the fields 432a-c and clicking again on the “calculate” button 434.

If the primary user's manager elects to continue the process of converting online miles to certificate miles and actuates the “continue” button 438 (FIG. 5D), step 148 displays a “purchase currency units payment” web page 440 as shown in FIG. 5E to facilitate the selection of the method of payment. In particular, the primary user's manager selects the method of payment by clicking on one of the “credit card data entry” button 442a, the “wire transfer data entry” button 442b or the “user check data entry” button 442c. Thereafter if pay is to be made by credit card, the primary user manager enters the related credit card data into the data entry fields 444a-g. Thereafter, the conditions and terms are displayed in a display scroll 446. If the primary user's manager accepts these terms, he or she clicks on an “I Accept” box 448, before clicking on the “purchase now” button 450.

After the currency unit certificates have been purchased, the shipping data, e.g., the address of the primary user that purchased the certificates, may be double checked and corrected in step 150. In particular, a “certificate shipping information” web page 460 as shown in FIG. 5F, whose editable data fields are pre-populated with a primary user name 462a, a first name of the manager 462b and a last name of the primary user's manager (contact) 462c, a primary user address 462d and a state, country and postal code 462e. The primary user's manager edits the displayed data from its terminal 24.

Next in step 152 as shown in FIG. 3B, the host computer 14 (FIG. 1) confirms the completion of ordering and distributing the units of currency by downloading for display at a selected primary user terminal 24 (FIG. 1) a “purchase currency units confirmation” web page 470 as shown in FIG. 5G. In particular, the web page 470 includes the following display fields for displaying: the total currency units purchased 472, the quantity of certificates 474a, the total certificate currency units purchased 474c, the confirmation number 476a, the expiration date 476b, the per currency unit cost 476c, the total currency units cost 476d, the federal tax 476e, the GST Tax 476f, the processing fee 476g, and the total cost 476h. Further, the web page 470 includes a credit card select button 478a, a wire transfer select button 478b and a corporate check select button 478c, and a display field 480 showing payment instructions and terms for the release of currency units. Further, the primary user's manager may actuate a link 482a to order and distribute nonredeemable certificates, and a link 482b to the “award online currency units” web page 500 as shown in FIG. 5I.

Next in step 154 as shown in FIG. 3B, the host computer 14 (FIG. 1) provides on request of the primary user's manager a “transaction listing-purchase currency units” web page 490 as shown in FIG. 5H. In particular, the web page 490 includes the following data entry fields for receiving search parameters to search the accumulated primary user transaction data: date 492a, confirmation number 492b, type 492c, payment method 492d and status 492e. The web page 490 displays the results of these searches on the following display fields: confirmation number 494a, the purchase date 494b, the type of online certificate 494c, the payment status 494d and the total currency units purchased 494e.

Next in step 156 as shown in FIG. 3B, the host computer 14 (FIG. 1) provides on request of the primary user's manager an “award online currency units” web page 500 as shown in FIG. 5I. In particular, the web page 500 facilitates the primary user's manager to award miles to particular currency recipients and, in particular, to provide a display field 502 for displaying the total currency units available to be awarded by the primary user. To that end, the web page 500 further includes data entry fields to facilitate the primary user's manager to enter the following parameters of the currency units: their account number 504a, the last name of the recipient 504b, the first name of the recipient 504c, the email address of the recipient 504d, and the set number of currency units to be awarded to each currency recipient in the data entry field 504e. After the particular currency recipient and the number of currency units to be distributed have been entered as described above, the primary user's manager actuates an award currency units button 506 to effect the awarding of such units to the designated recipient(s). The primary user manager may now actuate a “view currency units awarded” link 508, whereby the program moves to step 158.

Next in step 158 as shown in FIG. 3B, the host computer 14 (FIG. 1) provides to the terminal 24 of the requesting primary user's manager, a “transaction detail/list—certificate currency units redeemed” web page 510 as shown in FIG. 5K. The web page 510 permits to that primary user's manager to search the transaction data of the certificate currency. In particular, the web page 510 permits a search by entering data in the following data fields: date 511a, confirmation number 511b, currency units account number 511c, the first name of the currency recipient 511d, the last name of the currency recipient 511e, and the status of the recipient 511f, whereby any currency units matching the entered search parameters is identified, and the remaining characteristics of the redeemed currency units are displayed in corresponding of the following display fields 512a-f.

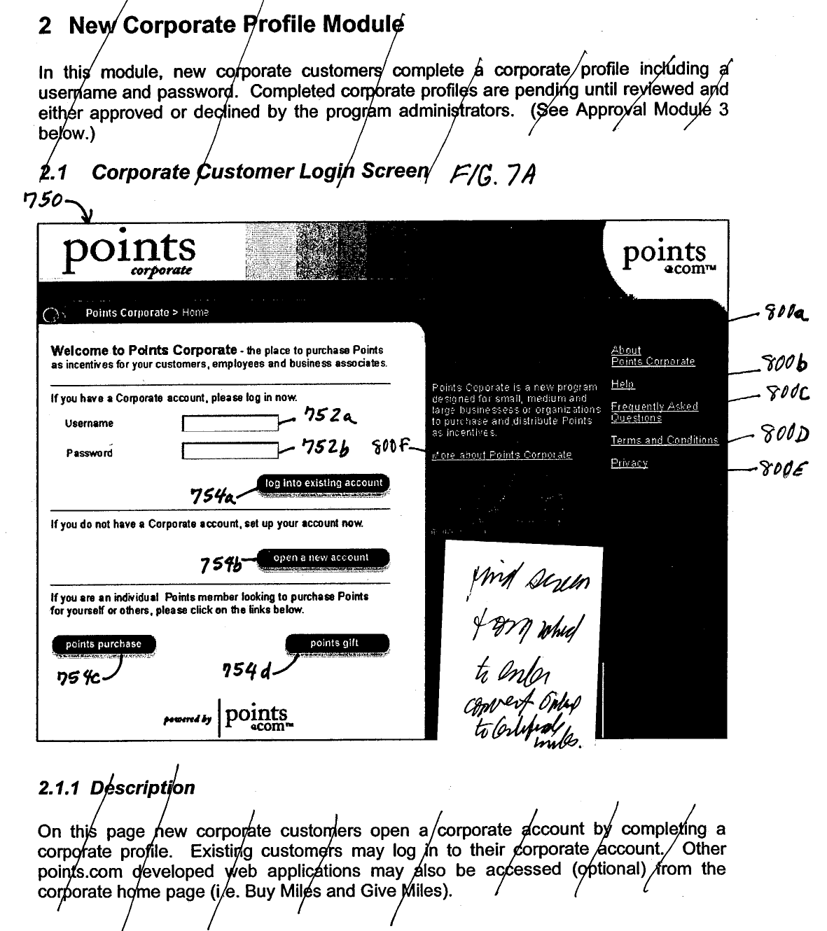

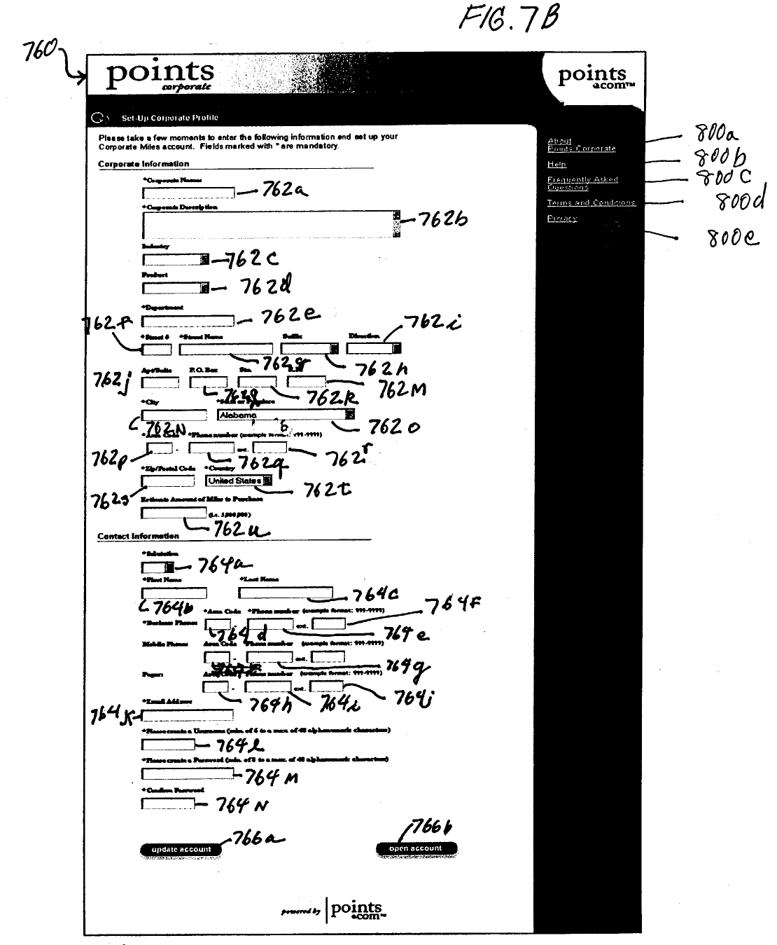

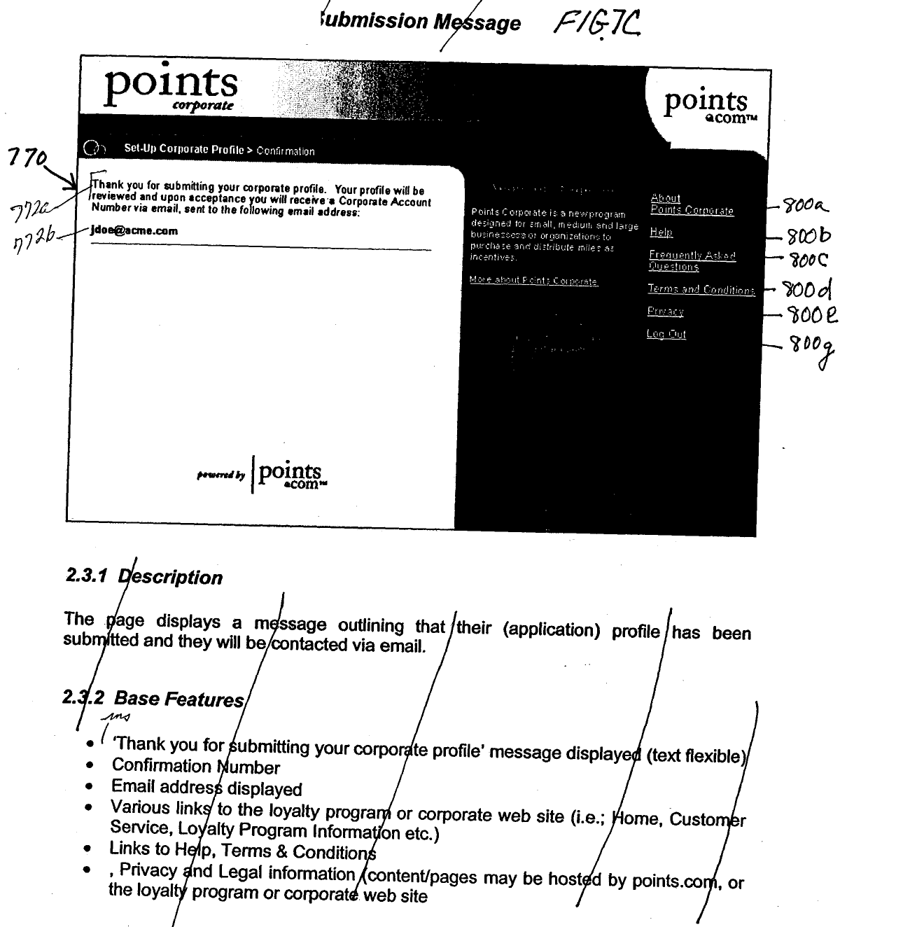

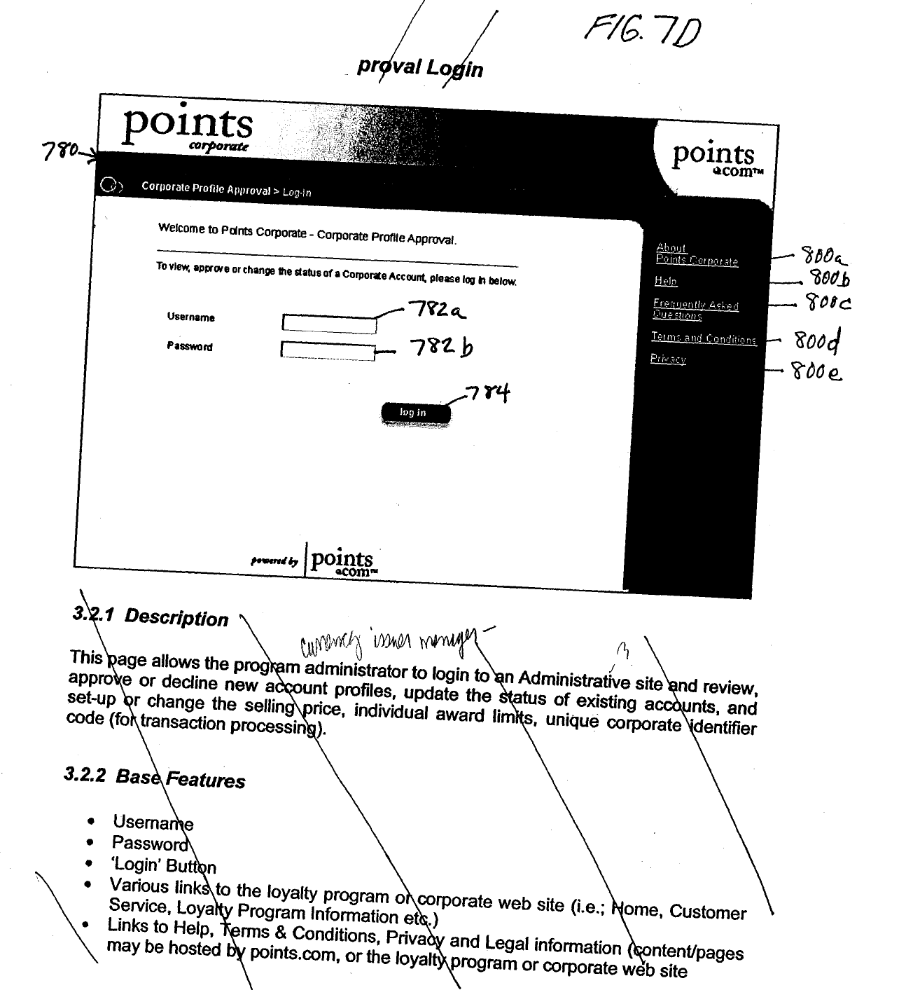

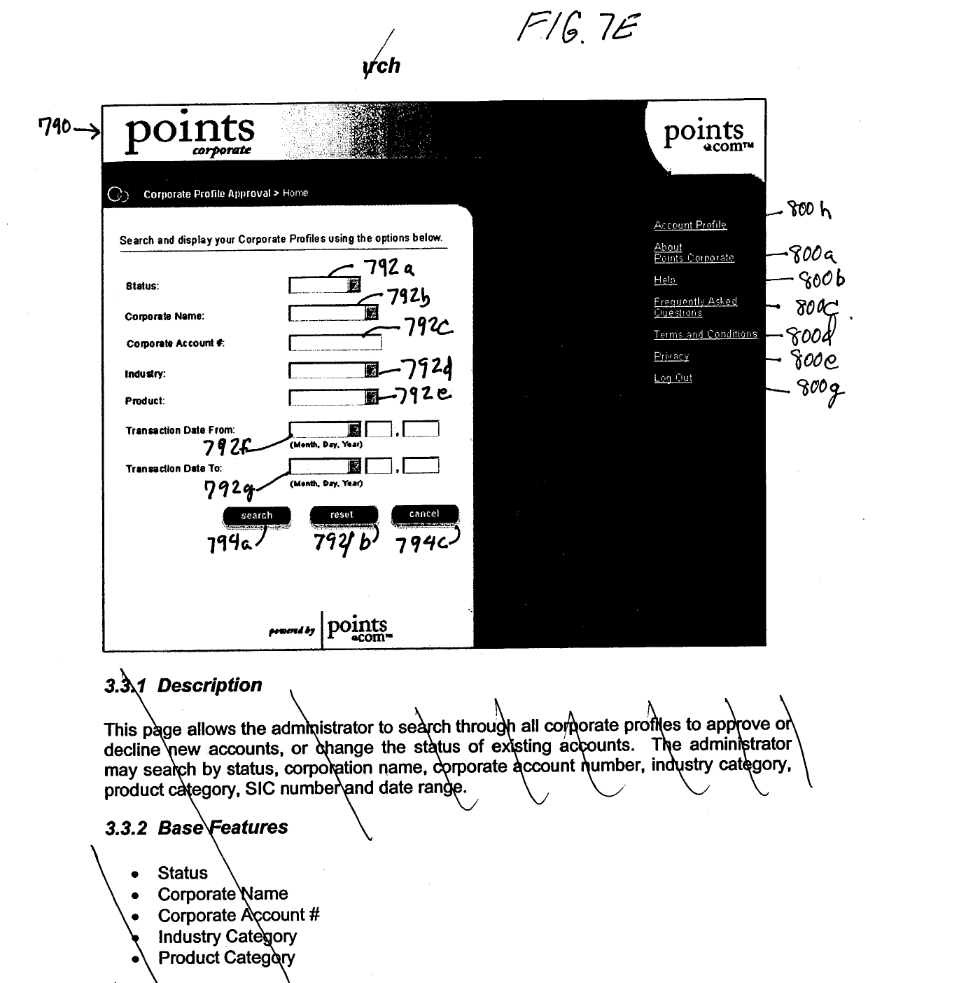

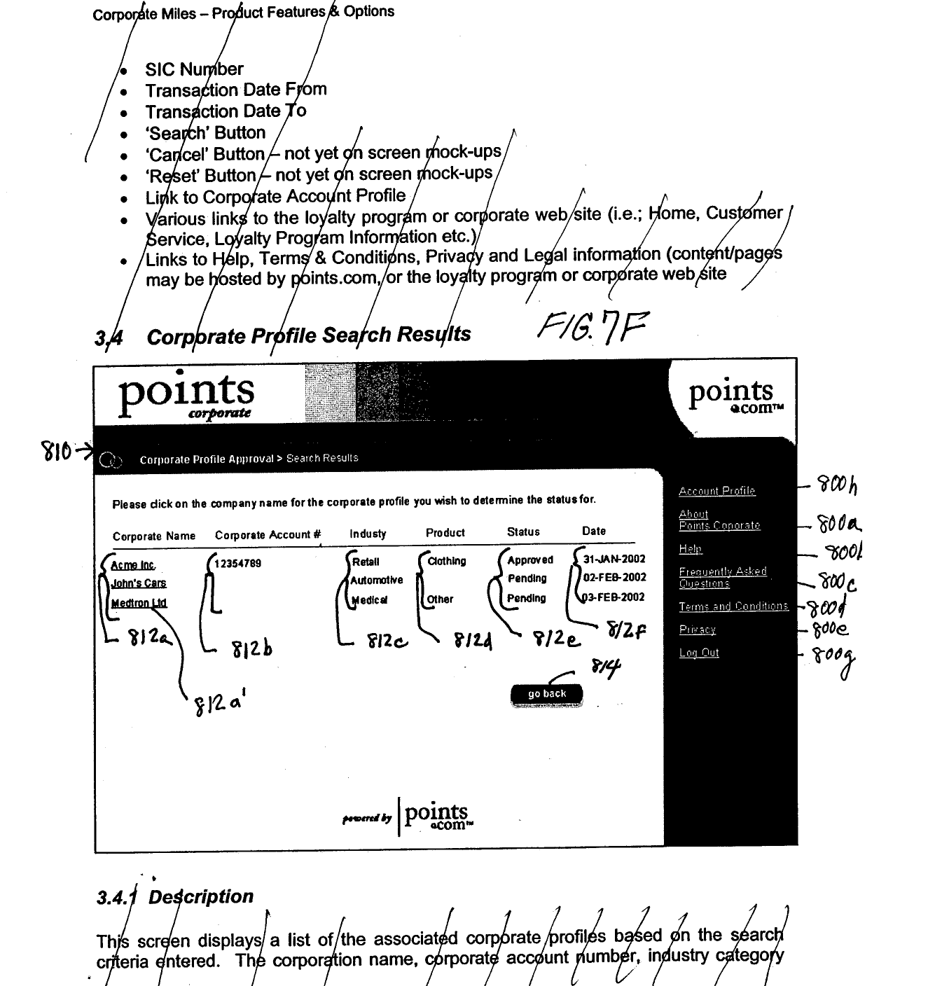

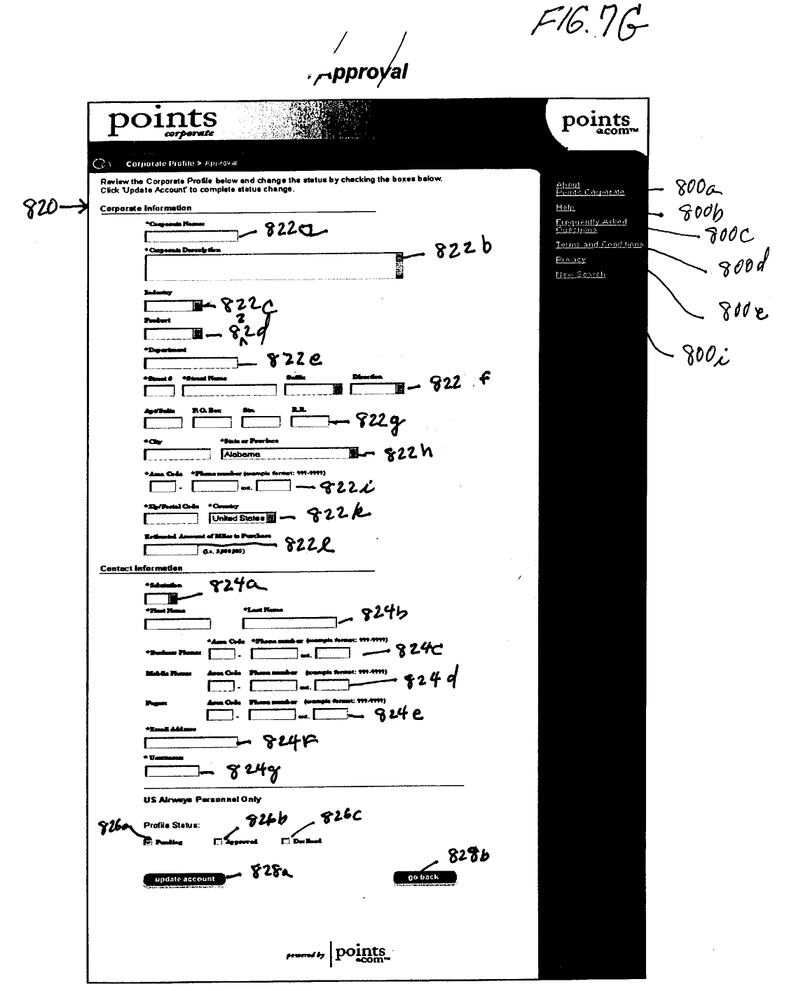

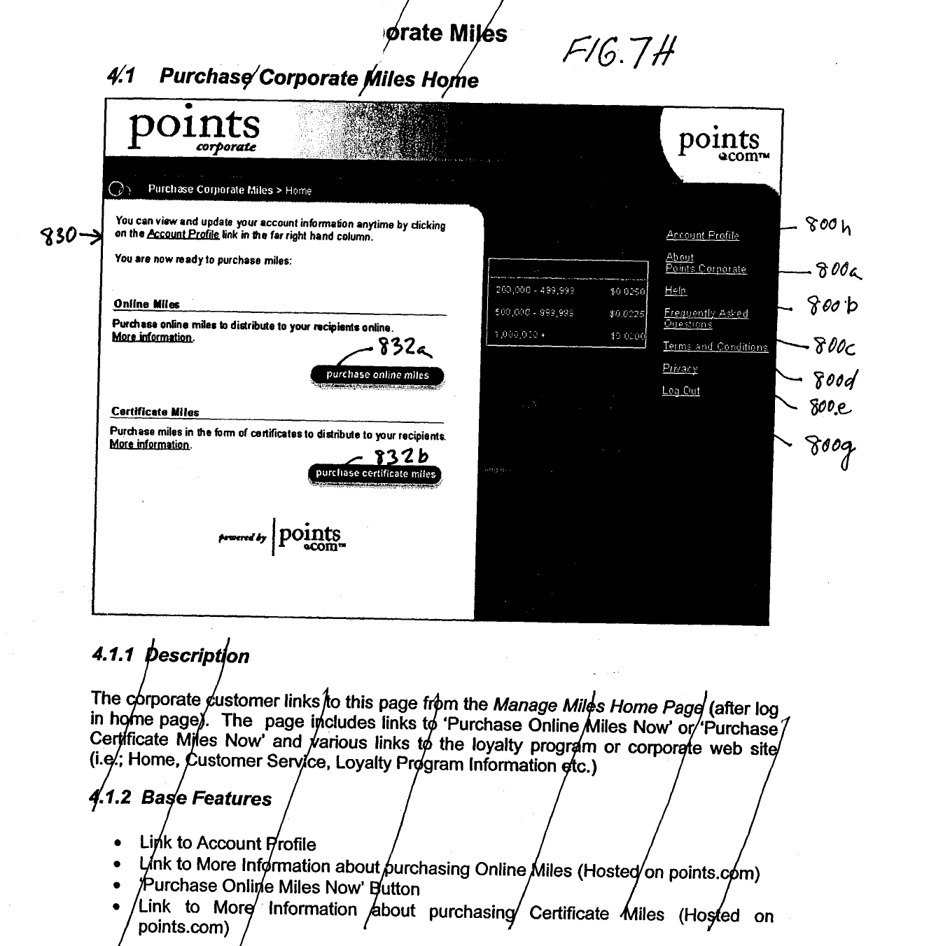

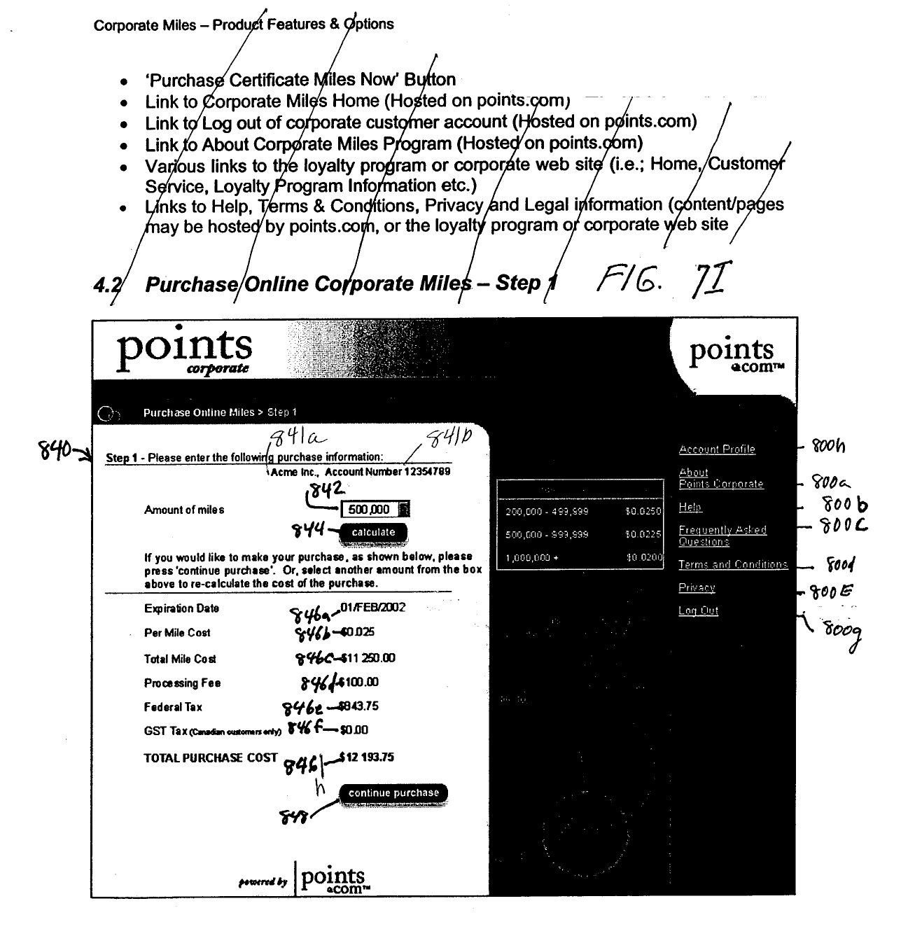

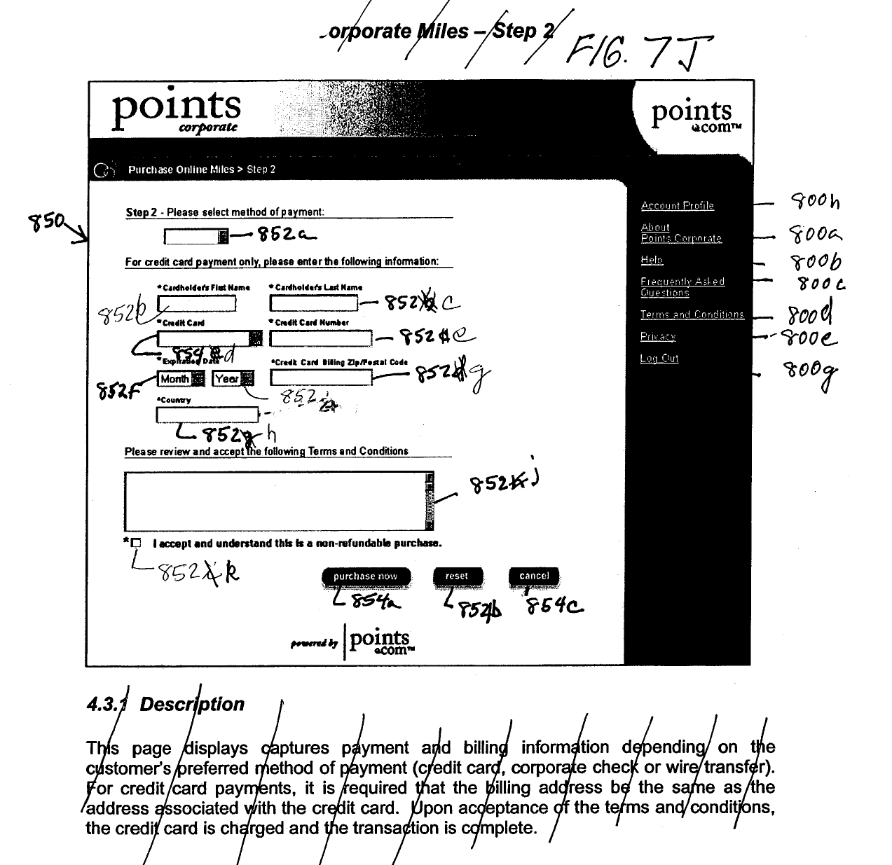

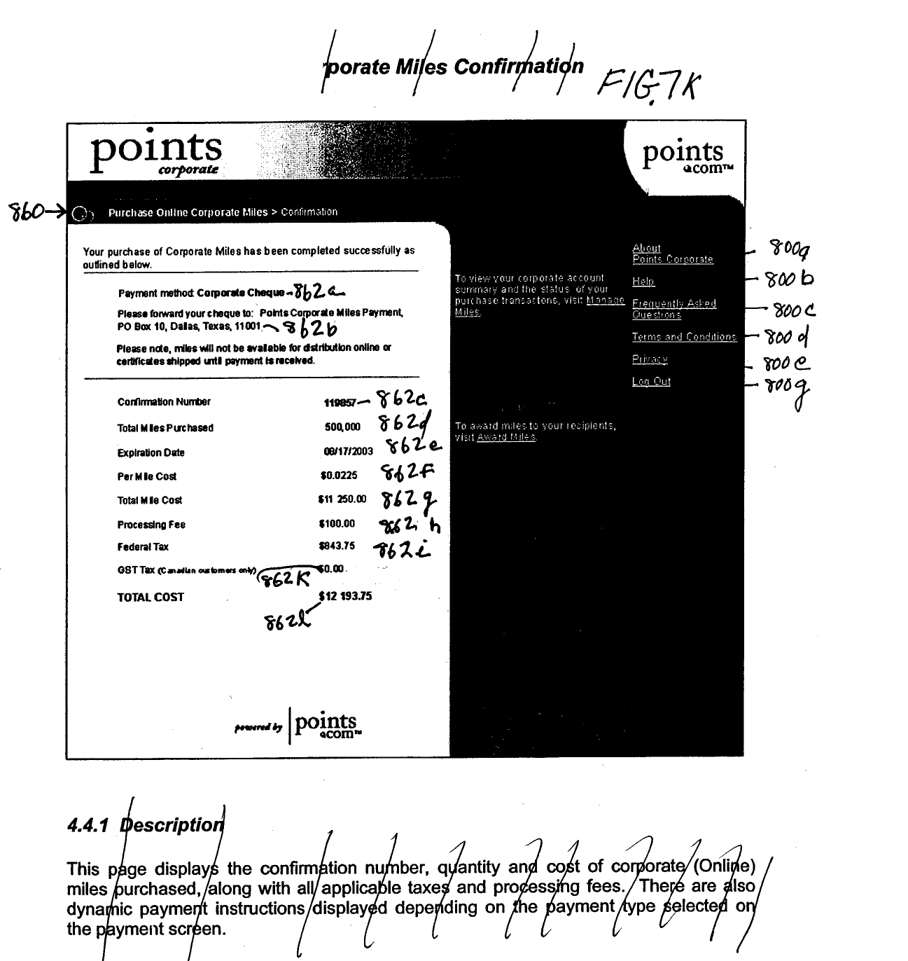

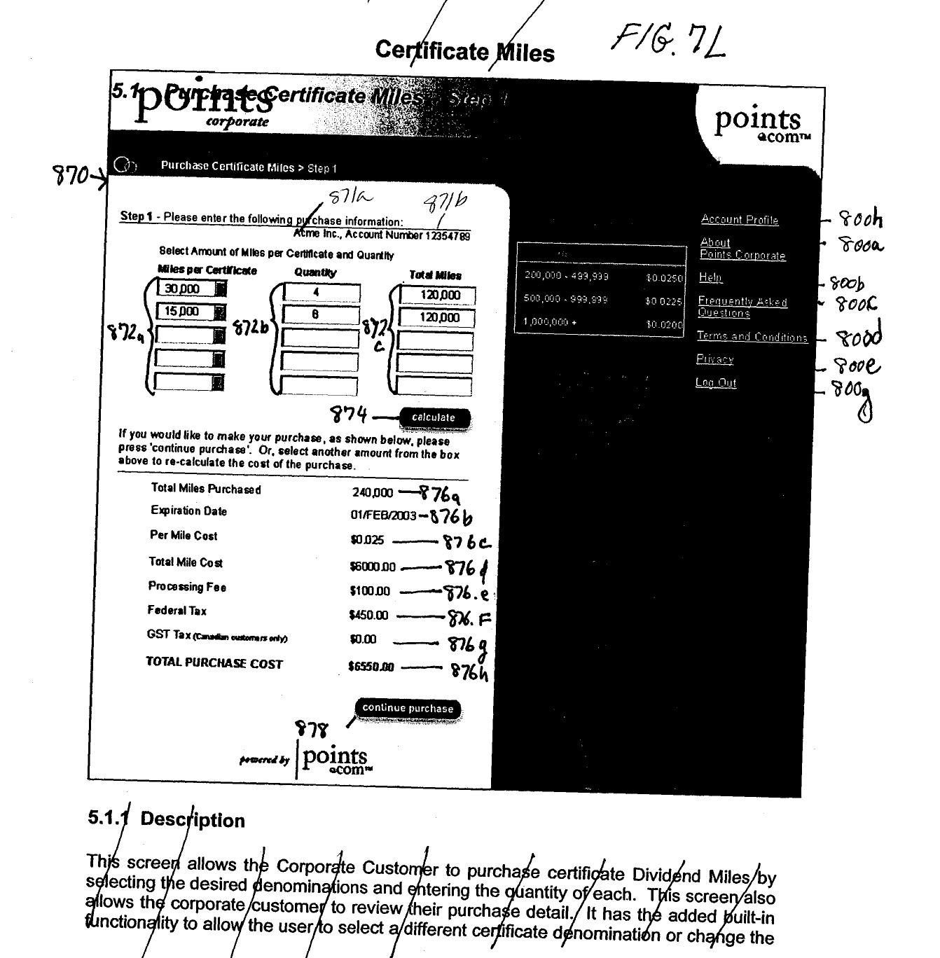

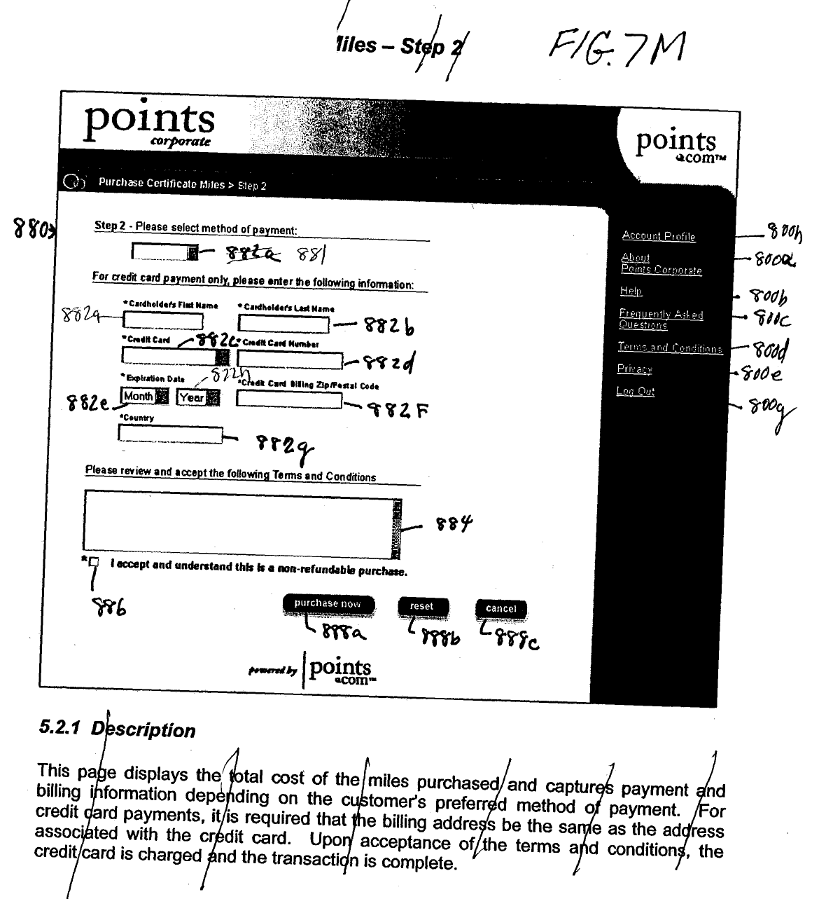

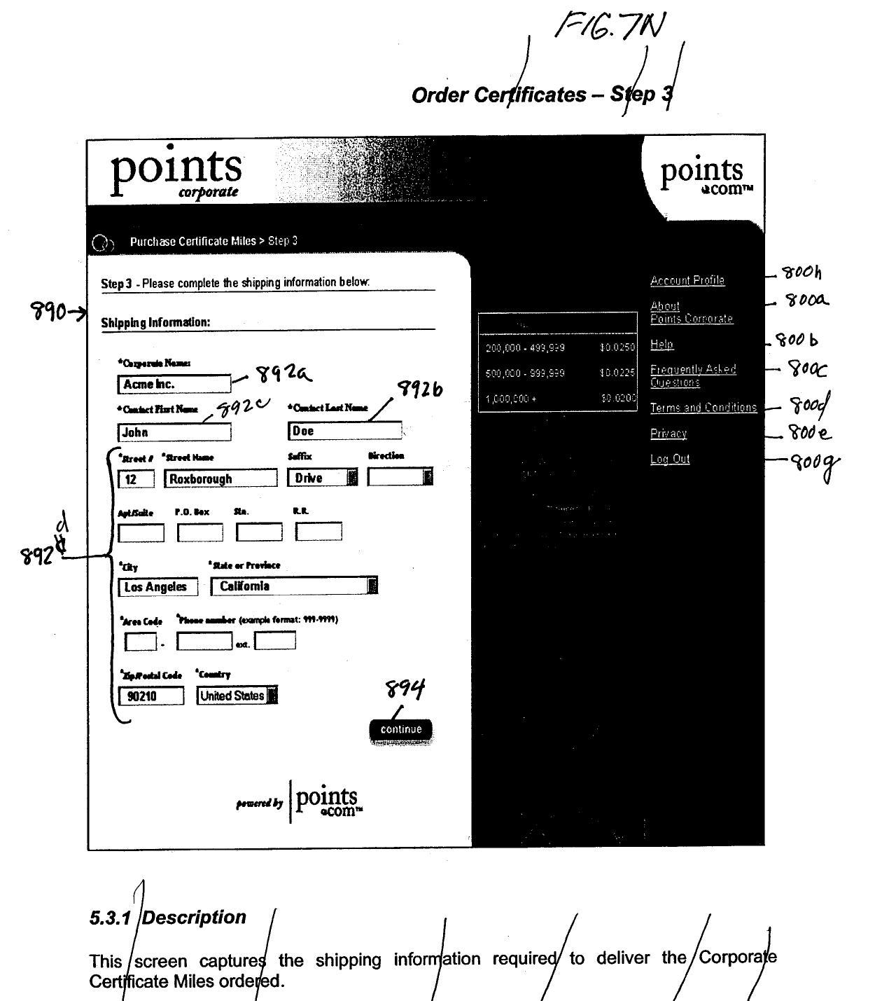

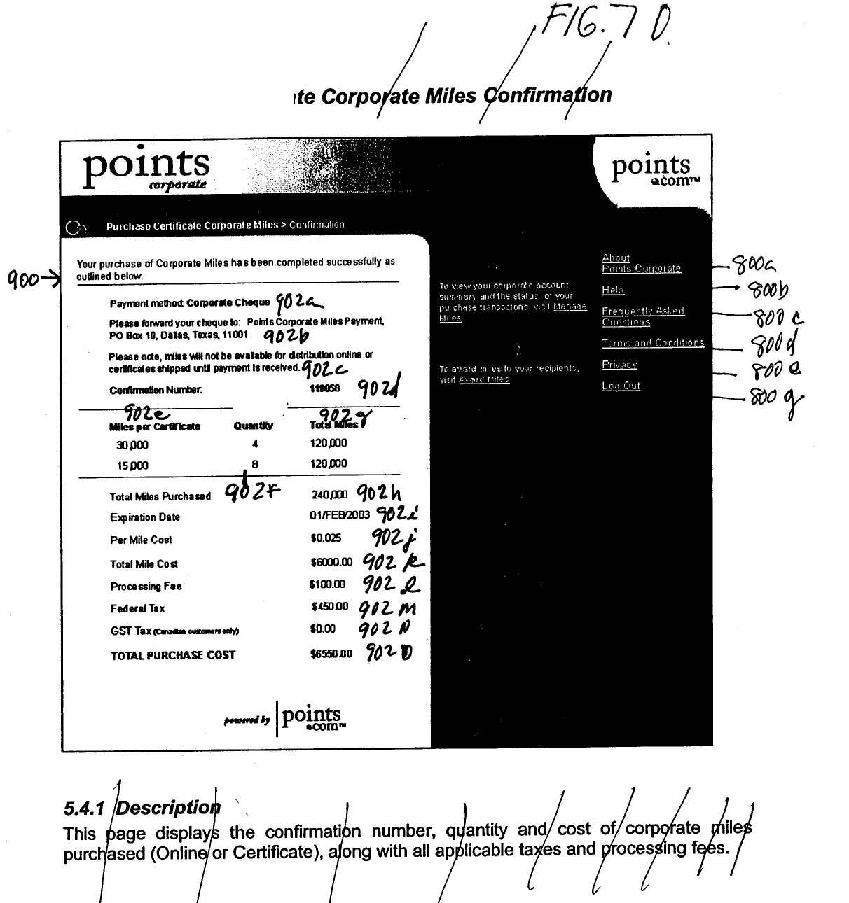

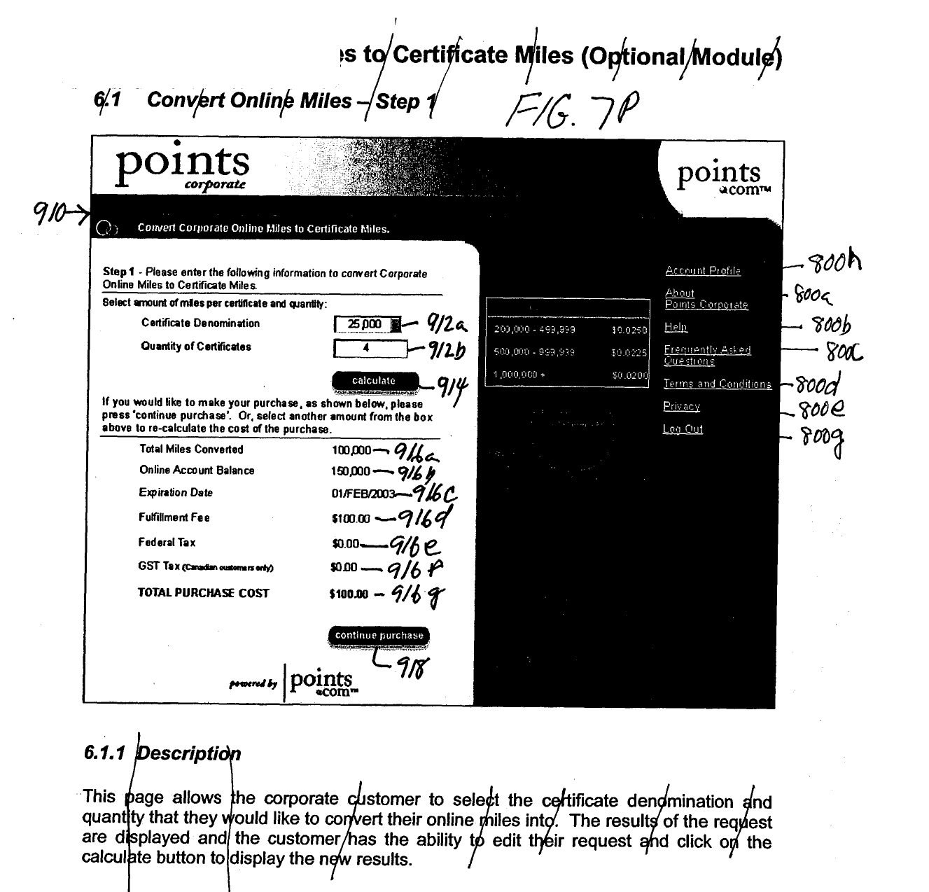

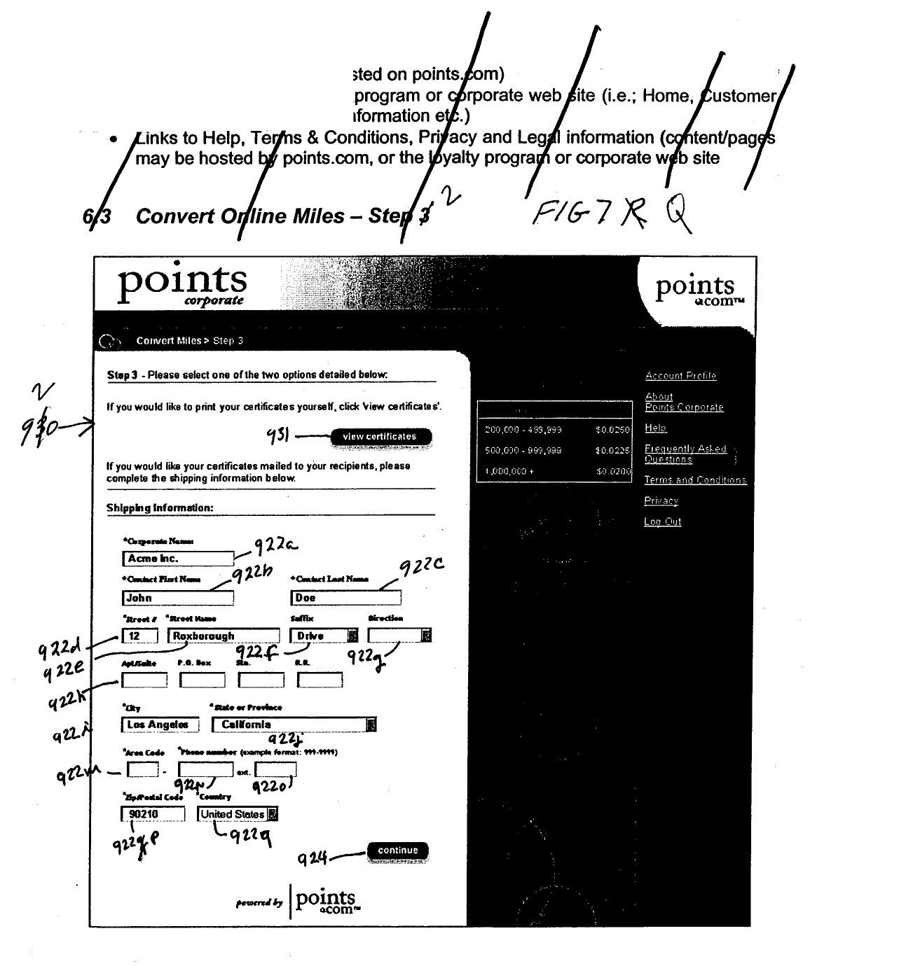

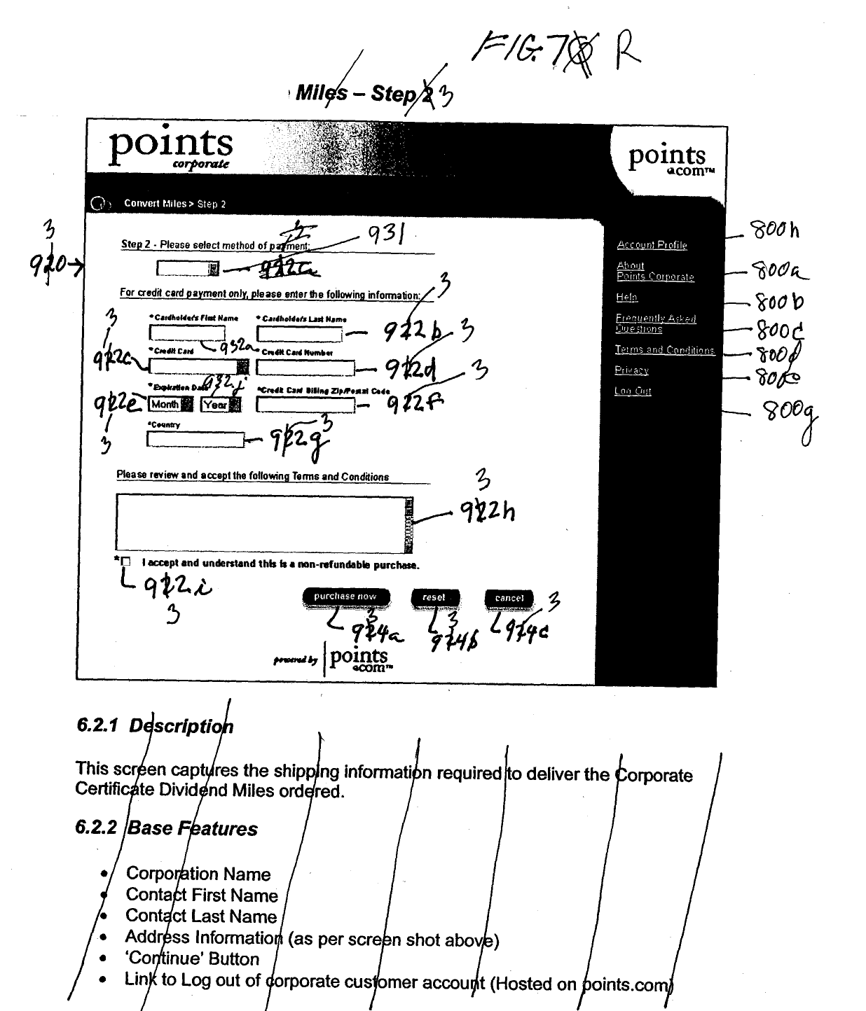

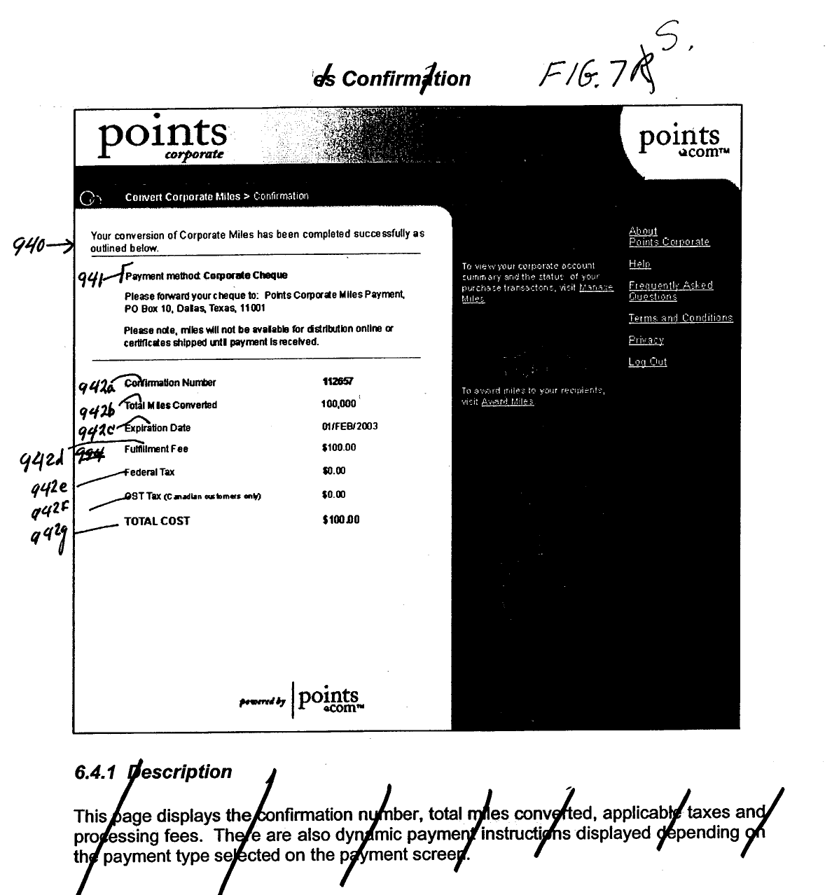

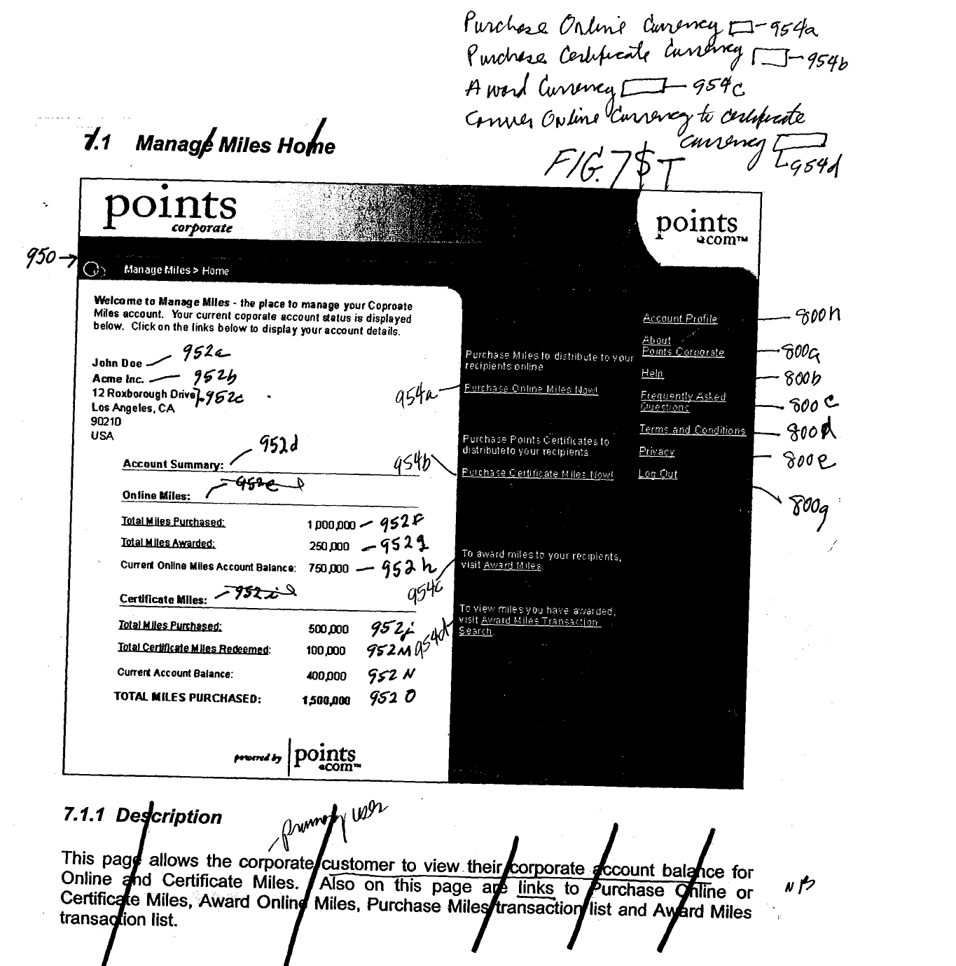

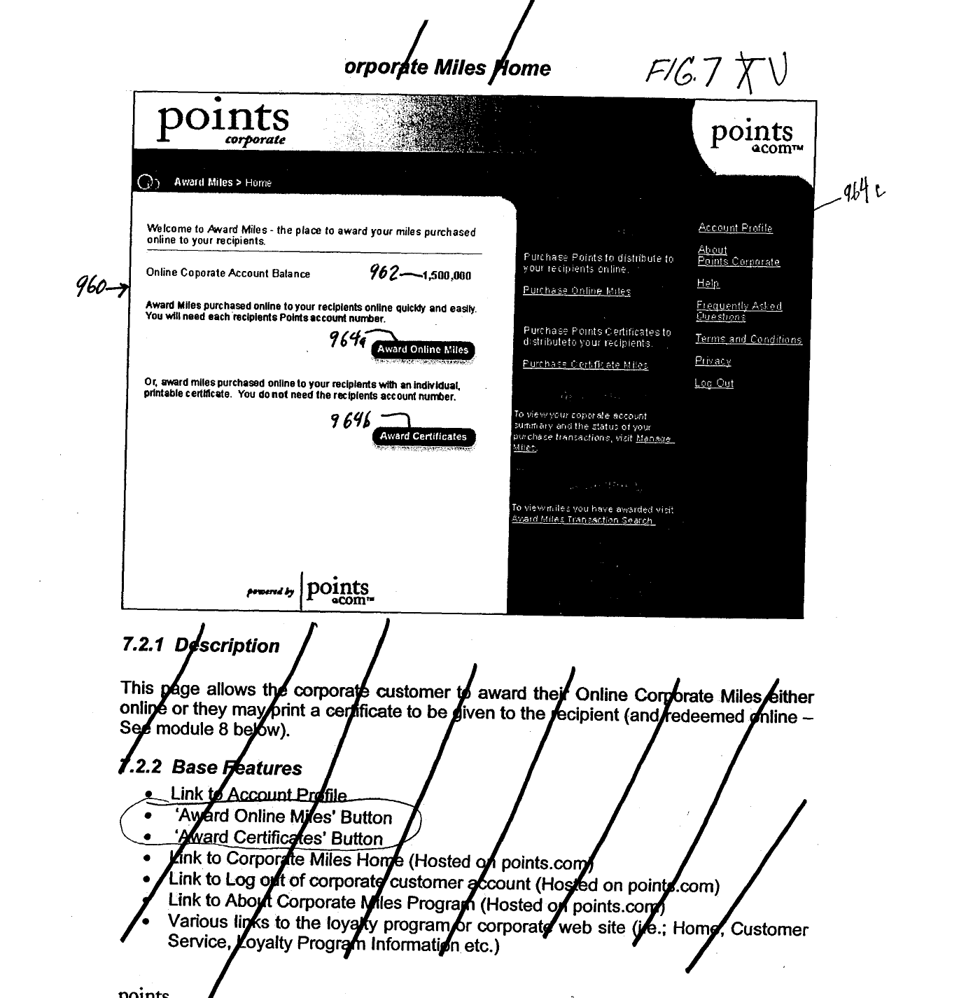

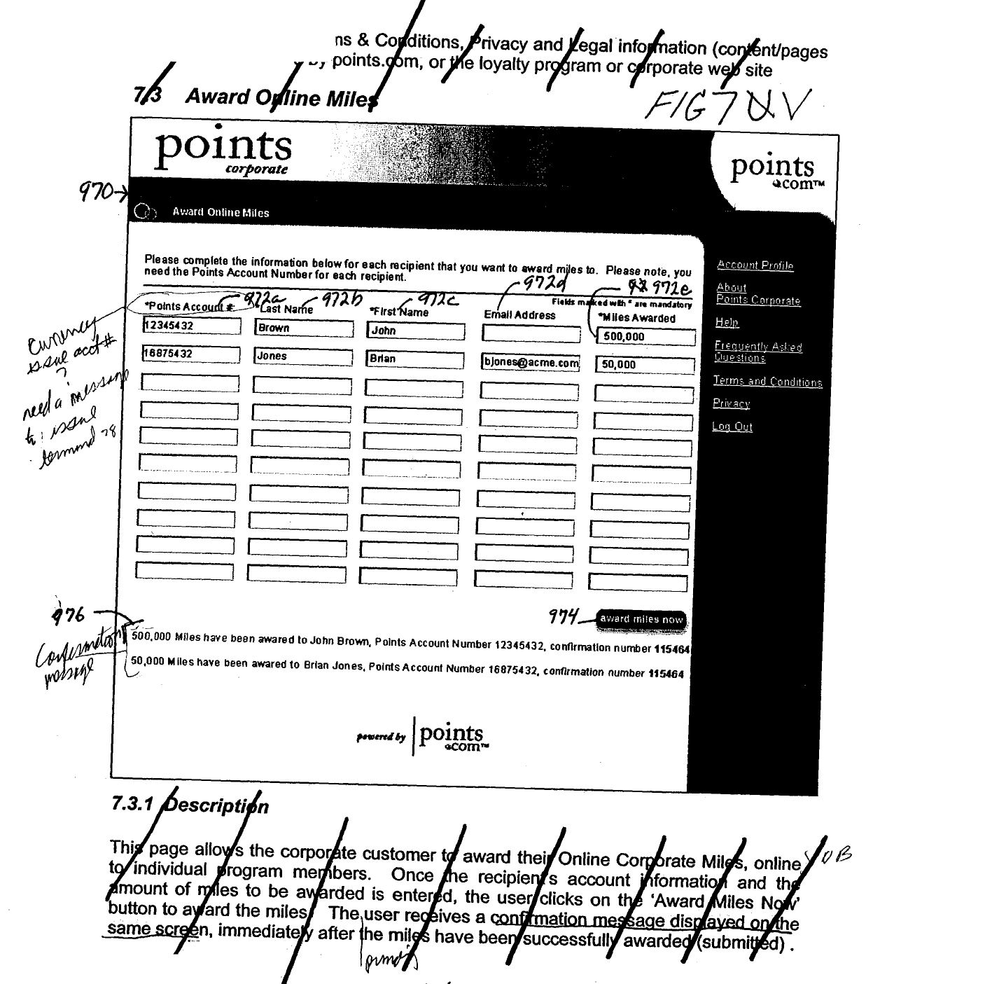

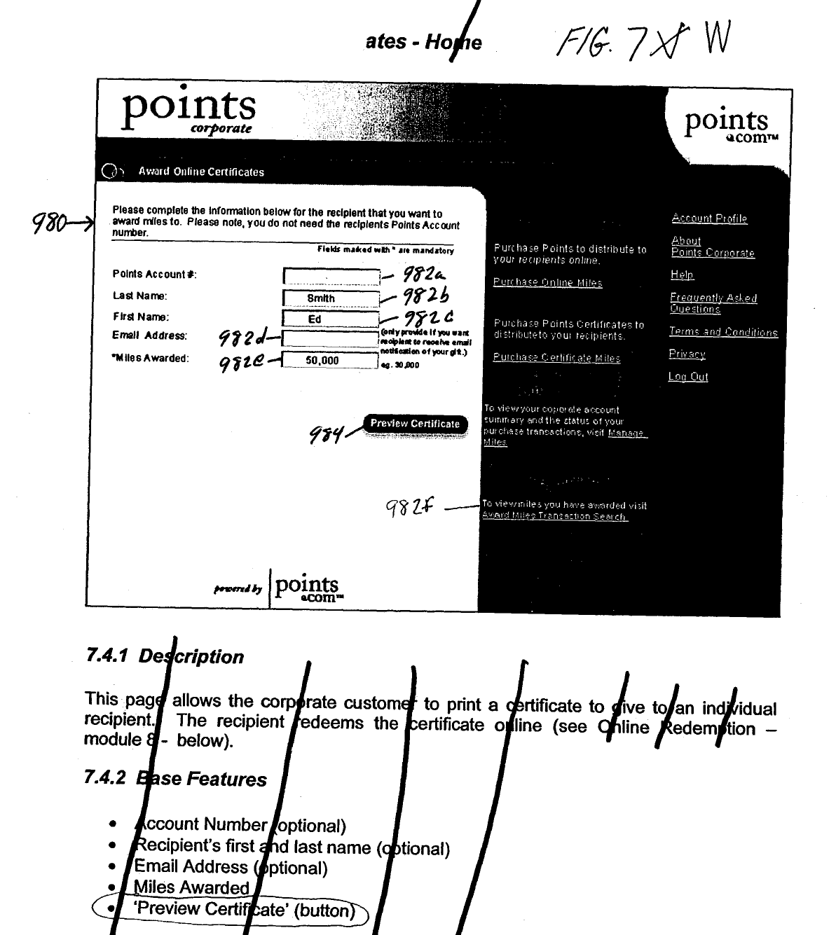

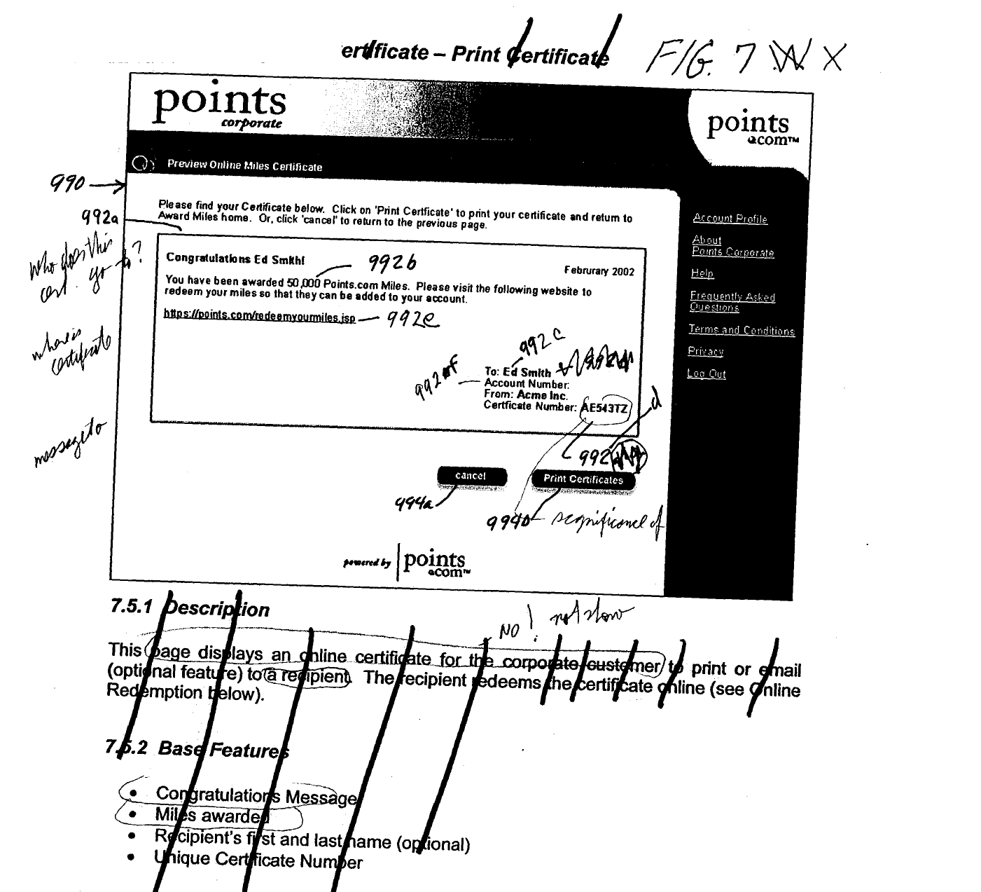

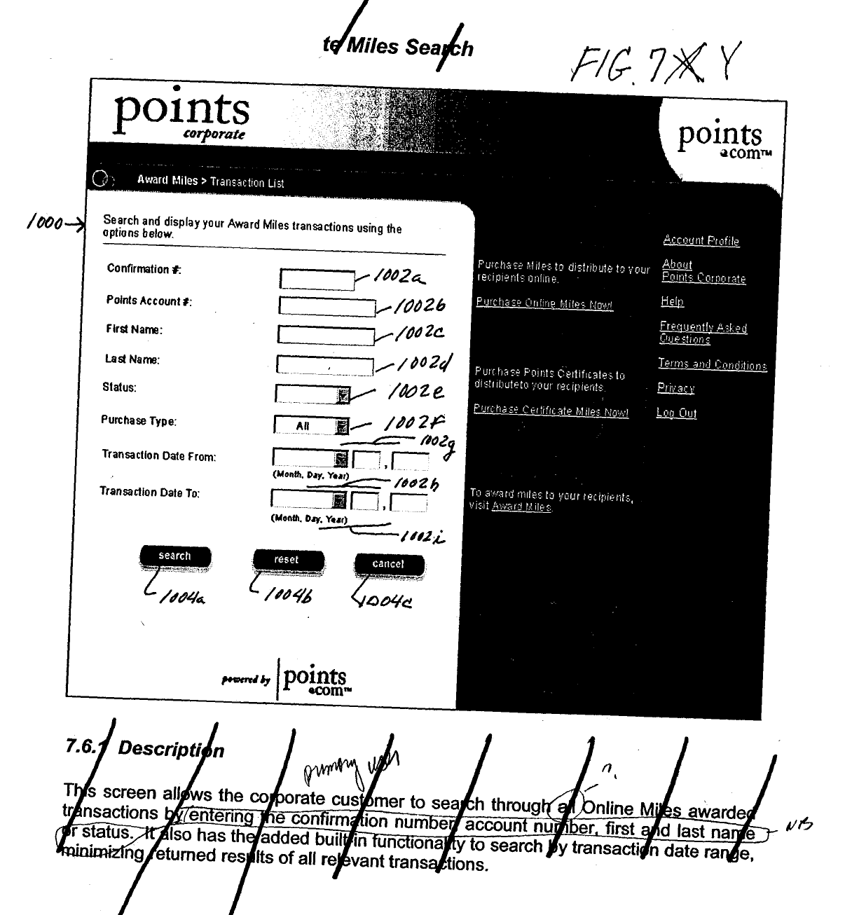

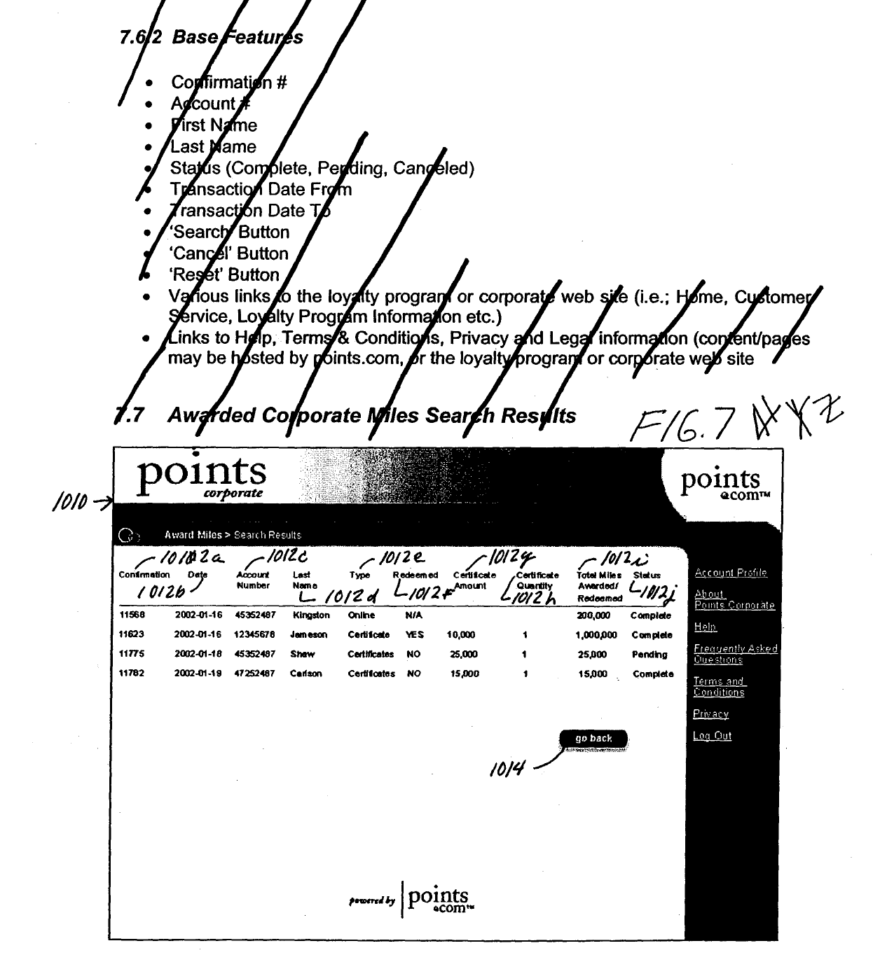

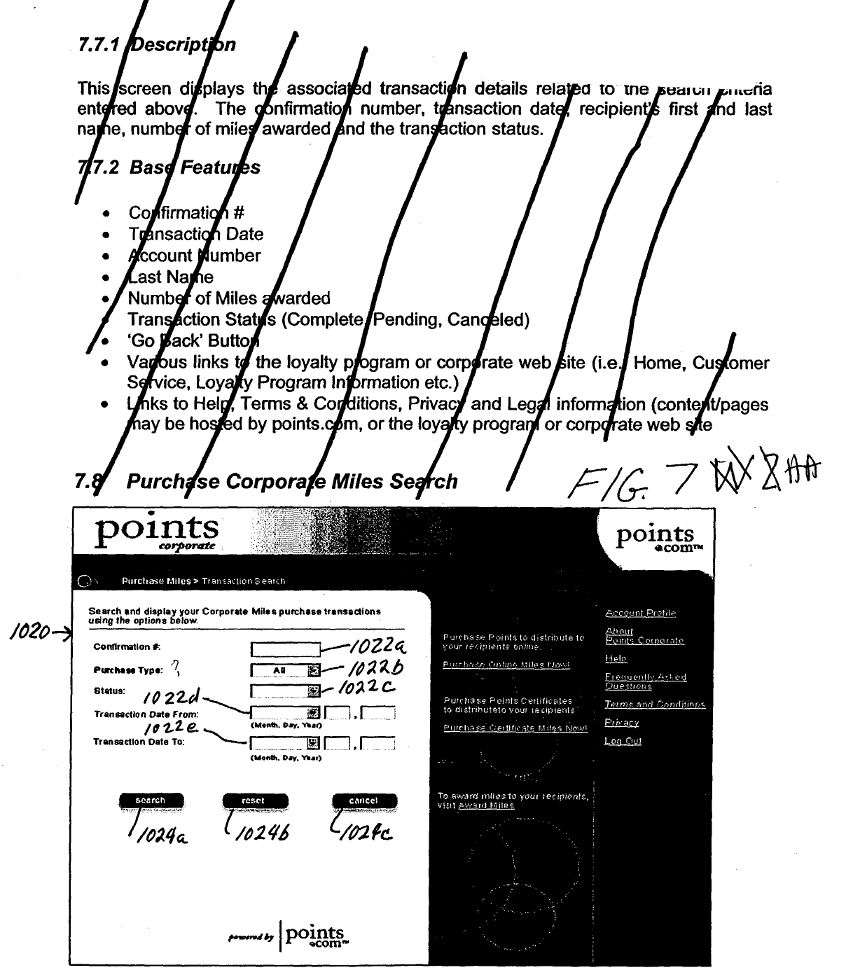

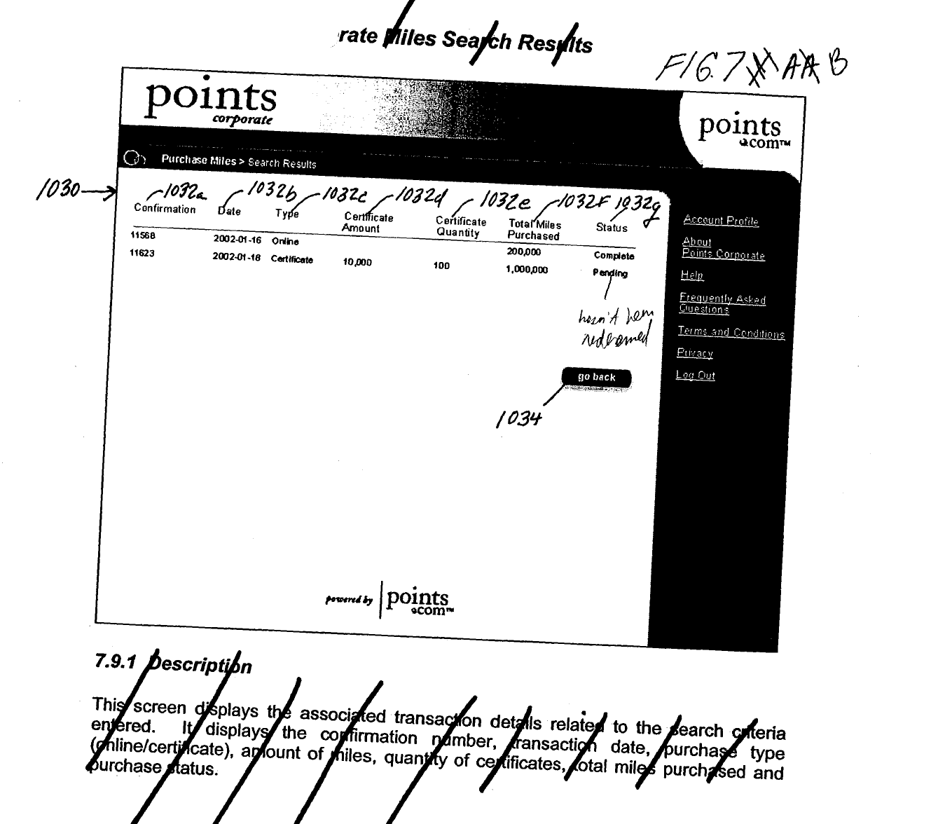

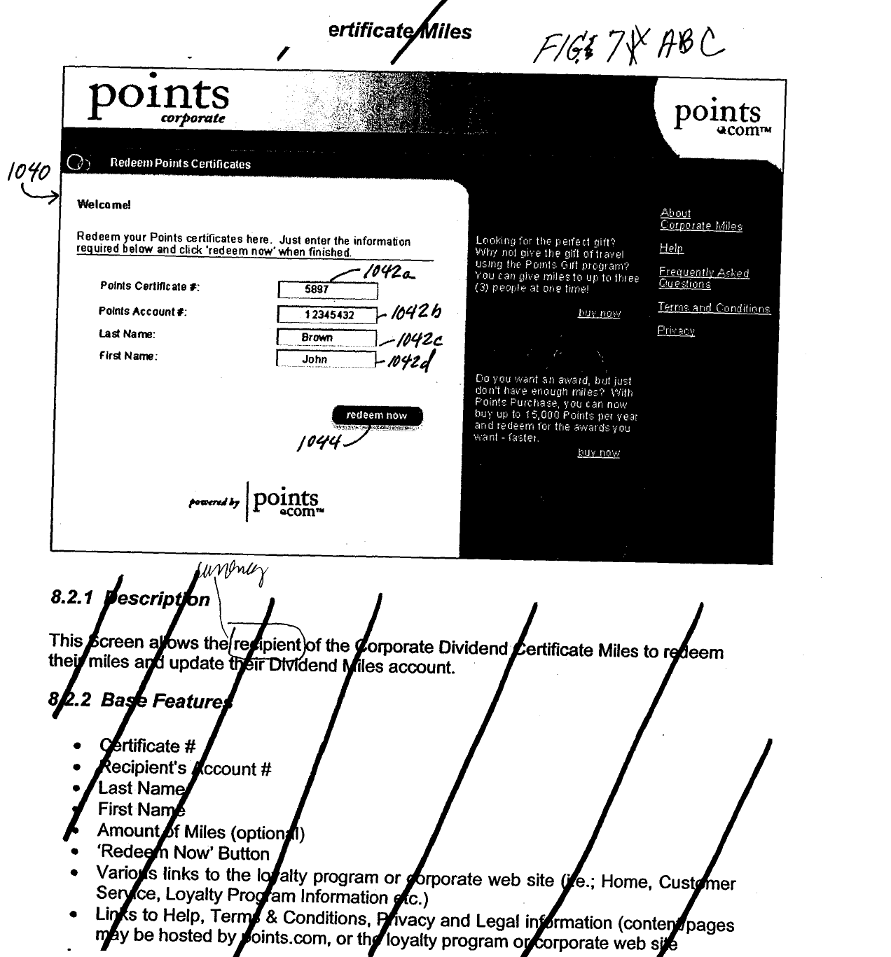

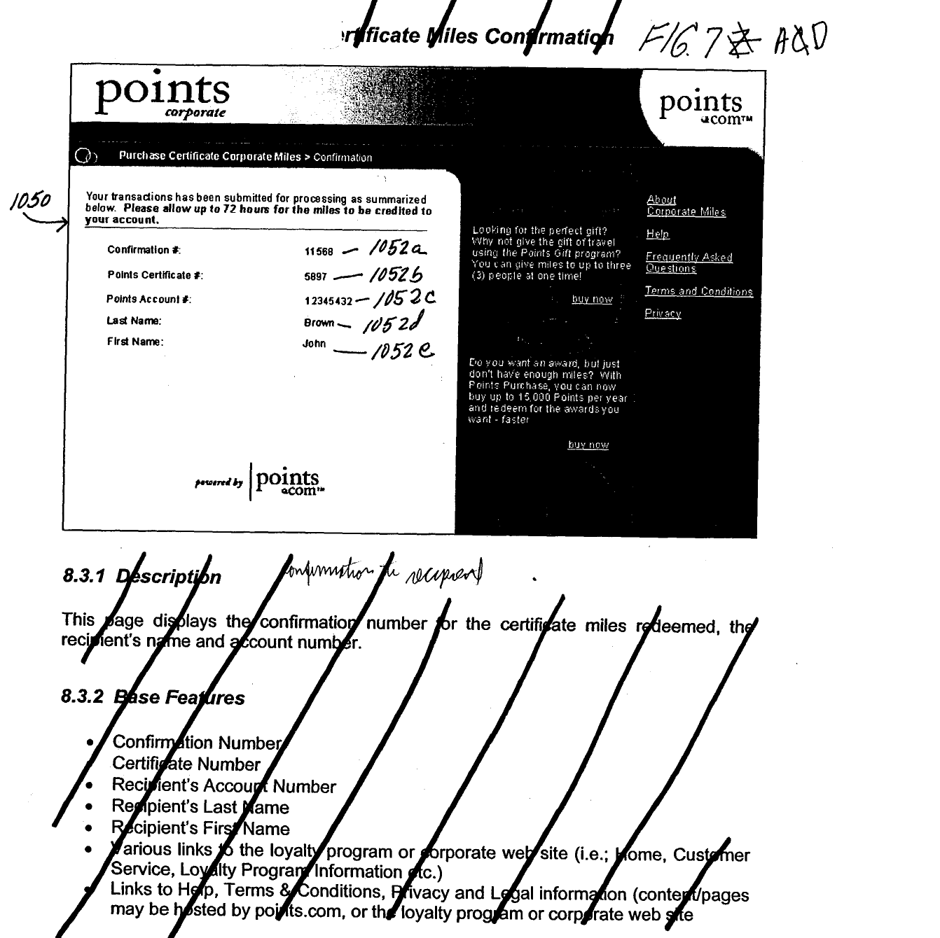

Referring now to FIGS. 6A, B and C, there is shown a further illustrative embodiment of this invention and, in particular, a second flow diagram of the web application software 600, that may be stored and executed by the host computer 14 (FIG. 1). Further, there are a plurality of web pages and/or screens as shown in FIGS. 7A-AD, selected of which are accessed as the flow diagram of FIGS. 6A, B and C is executed to be displayed on selected of the primary user manager's terminals 24, the primary currency issuer manager's terminals 36 and the currency recipient terminals 26. Initially in the execution of the web application software 600, as shown in FIG. 6A, one of the primary user's managers clicks on in step 602 to the primary user currency units web site to step 604, which accesses and displays on the primary user manager's terminal 24 a “primary user login” web page 750 as shown in FIG. 7A. The web page 750 permits primary users to open a primary user account by actuating an “open new account” button 754b. Primary users with existing accounts may log in to their primary user account by actuating a “login to the existing account” button 754a. Other points.com developed web applications may also be accessed (optional) from the corporate home page (i.e., Buy Miles and Give Miles). After actuating the button 754b, the primary user's manager inserts the user's name and pass word respectively into the data entry fields 752a and 752b. The web page 750 includes the following links: purchase currency link 754c, and gift currency units link 754d to initiate the purchase and awarding of points respectively.

If the primary user's manager actuated the open a “new account” button 754b (FIG. 7A), the program 600 moves to step 606 (FIG. 6A). Initially, step 606 displays as shown in FIG. 7B, a “primary user profile” web page 760 which facilitates a new primary user to provide its profile information and to set-up its primary user account. In particular, the web page 760 includes the following data entry fields to permit the primary user's manager to enter the primary user's data: primary user name 762a, business description 762b, corporate name (to be displayed on members' statements (not shown), address information 762f-o, expected purchase amount 762u, purpose/use of currency units (not shown), industry description 762c, product description 762d, deportment description 762e Dun and Bradstreet number (not shown); user salutation 764a, first name 764b, last name 764c, business phone (includes area code and extension) 764d, e and f, mobile phone (includes area code and extension) 764g, pager (includes area code) 764h, i and j, email address 764k, a username 764l, a password 764m, and confirm password 764n. After entering the primary user data into the various data fields, the primary user's manager actuates the an “open account” button 766a to initiate an approval process carried out typically by the currency issuer's manager at its terminal 36 (FIG. 1). Primary users' accounts are assigned various statuses. New primary user accounts are assigned a pending status until the approval process is completed, and are either approved or declined by the currency issuer's manager. If the manager wished to update an approved primary user account, the manager may enter new data in the above listed data fields 762a-u and 764a-n, before actuating an update account button 766a, whereby the old data in the establisher primary user account is updated with the newly entered data.

Thereafter in step 606, a “corporate profile submission message” web page 770, as shown in FIG. 7C, is transmitted to the primary user's manager at its terminal 24 to display a message thanking the primary user for submitting its primary user profile and indicating that upon completion of the primary user's profile evaluation by the currency user, that a decision would be emailed to the submitting primary user from the currency issuer as to whether the issuers would provide the requesting primary user with an allotment of its currency units. In particular, the web page 770 includes a data display 772a for showing a “Thank you” for submitting its corporate profile message, a data display (not shown) for a confirmation number, and a data display 772b for the email address to where the response would be made.

Next in step 608, as shown generally in FIG. 6A and in detail is FIG. 6B, a currency issuer's manager reviews in step 608 the submitted primary user's profile as whether to accept or reject the primary user and, in step 612, sends its response by email to the submitting primary user. With reference to FIG. 6B, step 608 comprises in one illustrative embodiment of this invention a subroutine, whose first step 672 allows the currency issuer's manager to login to a currency issuer web site to review, to approve or decline step 672 the primary user's account profiles, and to update the status of existing profile accounts. As shown in FIG. 7D, step 672 displays at the currency issuer manager's terminal 36 a “primary user profile approval login” web page 780 that bears the data entry fields 782a and 782b. To login, the currency issuer's manager enters the currency issuer's name in the data entry field 782a and its password in the data entry field 782b. Then, the currency issuer clicks on a “login” button 784.

Thereafter in step 674 (FIG. 6B), the web site 780 displays as shown in FIG. 7E a primary user's approval search page 790 on the currency issuer manager's terminal 36. This search page 790 allows the currency issuer's manager to search through all corporate profiles to approve or decline new accounts, or change the status of existing accounts. The currency issuer's manager may search by various parameters, e.g., status, corporation name, corporate account number, industry category, product category, SIC number and date range. In particular, the search page 790 includes the following data fields whereby the manager may enter the selected parameters of the user's profile: status 792a, corporate name 792b, corporate account number 792c, industry category 792d, product category 792e, and SIC number (not shown), a transaction date from 792f, and a transaction date to 792g. After the selected search parameters have been entered in step 676, the currency issuer's manager clicks on a “search” button 794a to conduct a search of the primary user's profiles with the selected parameters. In a further illustrative embodiment of this invention, the currency issuer's manager may activate a reset button 794b to reset the search parameters, or a “cancel” button 794c to cancel the entered parameters.

After the search button 794a has been actuated, step 687 displays (FIG. 6B) a “primary user profile search results” web page 810 as shown in FIG. 7F. This web page 810 displays a list of the associated primary user profiles based on the search parameters entered. In particular, the web page 810 displays for each primary user's profile the following display fields: the primary user's name 812, the user's account number 812b, the industry category 812c, the product category 812d, the status 812e (pending, approved/active, declined, suspended—may use an existing currency balance but no future purchases and locked—may not use existing balance or make future purchases), and transaction date 812f. Specific primary user's profiles may be viewed by clicking on the corporate name link 812a′. Further, the web page 810 includes a “go back” button 814, which may be actuated by the currency issuer's manager to permit the manager to enter new search parameters and to initiate a new search.

In step 680 (FIG. 6B), a “primary user profile approval” web page 820 is displayed as shown in FIG. 7G. This profile approval web page 820 is a modified version of the “primary user profile (application)” web page 760 (FIG. 7B), and is displayed when opening a new account or updating an existing account of a primary user. The currency issuer's manager may review new or existing primary user profiles, and update the profile status. Next, the currency issuer's manager decides in step 684 whether or not to approve the new account profile by clicking on either an “approve” button 826b or a “decline” button 826c. For new accounts, once the status is changed from the default ‘P’ (pending) status to ‘A’ (approved) or ‘D’ (declined), a message, e.g., illustratively an email, will be automatically generated and sent to the corporate contact or user's manager on file by either step 686 or 688, respectively. The email sent to the approved primary user will contain a primary user account number. Primary user accounts may also be ‘S’ (suspended) where no additional purchase's can be made (but may continue to distribute their existing currency unit balance) or ‘L’ (locked) where no additional purchases can be made and they may not continue to use their current currency unit balance. The currency issuer's manager may also set-up or change the current selling price, individual award limits and an unique corporate identifier code (for transaction processing) by clicking on to a “go back to a primary user profile search results screen” button 828b, before updating and entering data into the enter selling price entry field, the enter individual award miles limited entry field, and the enter unique corporate identified code data entry field. After emailing messages as to whether the primary user account has been approved in step 686 or disapproved in step 680, the program 600 returns to the main corporate page FIND in step 690.

After a primary user account profile as shown on the web page 820 has been approved, the account may be administered in step 692 as shown in FIG. 6B. Approved by the currency issuer's manager, the primary user's account as approved in step 684 is created in step 696. Alternatively, the currency user's manager may actuate the “update account” button 828a, as shown in FIG. 7G, whereby the data previously entered in the data entry fields 822a-l and 824a-g may be updated. As a third option, the primary user's manager may cancel in step 698 the completed and approved primary user profile account.

After a primary user has been identified in step 604 (FIG. 6A) as having an existing account, which was logged-into when the user's manager enters the primary user's name and pass word as shown generally in FIG. 6A and in detail in FIG. 7A by using the “primary user login” web page 750. In an illustrative embodiment of this invention, when the user's manager actuates in step 604 the “log into existing account” button 754a, the process moves to step 630 to login to the existing account before moving to step 632. In step 632, a “manage miles home” web page 950 is displayed as shown in FIG. 7T to permit the primary user's manager to view the account balance of its currency units and to click in step 632 on either a “purchase online currency” button 954a or a “purchase currency certificate” button 954b.

In turn, the primary user's manager may link from the “manage miles home” web page 950 to step 614, wherein a “purchase primary user currency units” web page 830 (FIG. 7H) is displayed. As explained above, the page 830 permits the primary user's manager to purchase in step 614 online currency units by clicking on its “purchase online currency units” button 832a or to purchase certificate units by clicking on the “purchase certificate currency units” button 832b. In particular, the primary user links in step 632 to this web page 830 from the “manage currency units home” web page 950 (FIG. 7T) (after login in step 630 at the home page 750) (FIG. 7A). The web page 950 includes a button 954a to purchase online currency units, a link 954b to purchase certificate currency units, a link 800h to the account profile shown on the web page 820 (FIG. 7G), a link 800b to more information about purchasing online currency units miles (host computer 14), a link to more information about purchasing certificate currency units (host computer 14) (not shown), a “purchase certificate currency units” button (not shown), a link to the “primary user currency units” home page (host computer 14), a link 800g to log out of the primary user account (host computer 14) (FIG. 7H), and a link 800a to the primary user's currency units program (host computer 14).

Upon actuating the “purchase online currency units” button 832a (FIG. 7H), the process proceeds in step 616 (FIG. 6A) to purchase the online currency units. In particular, step 616 illustratively validates in real time the particular primary user and its manager that have access to this system. If the primary user is validated, step 618 displays a purchase online currency units web page 840 as shown in FIG. 7I, which in general allows the primary user's manager to purchase online currency units and review their purchase details. The total costs of the currency units to be purchased is displayed, and there is added functionality to allow the user to select a different amount of currency units to purchase, and dynamically recalculate the costs of those miles. In particular, the “purchase online primary user currency units” web page 840 includes data display fields for the following information: a primary user name 841a, and a primary user account number 841b, a data entry field for a number of currency units to be purchased 842, and a “calculate” button 844. In an illustrative embodiment of this invention, there is an option to select different amounts of currency units to purchase from the “drop down list” data field/box 842, which dynamically recalculates all applicable costs (including taxes) once the “calculate” button 844 is pressed. The particulars of the cost of the currency units is broken down and displayed in the following data display fields: expiration date (optional) 846a, per currency unit costs 845b, total currency units cost 846c, processing fee (optional) 846d, USFF—frequent flyer tax (7.5%—is applied to the price of all transactions) 846e, GST 7%—applied to the price and processing fee of all Canadian transactions except for residents from Nova Scotia, Newfoundland and New Brunswick) 846f, QST (7.5%—applied to the price and processing fee all transactions from residents of Quebec) not shown, and HST (15%—applied to the processing fee of all transactions from residents of Nova Scotia, Newfoundland and New Brunswick) not shown. The total cost of the entered number of currency units is displayed in the total purchase cost display field 846h. To continue the purchasing step, the primary user's manager clicks onto the “continue purchase” button 848.

After the continue purchase button 848 is actuated, the second step of purchasing is effected by displaying a “purchase online currency units—step 2” web page 850 as shown in FIG. 7J. The web page 850 displays generally the payment and billing information depending on the primary user's preferred method of payment (credit card, corporate check or wire transfer). For credit card payments, it is required in one illustrative embodiment of this invention that the billing address be the same as the addressed associated with the credit card. Upon acceptance of the terms and conditions, the credit card is charged and the transaction is completed. In particular, the web page 850 includes the following display fields: primary user name (not shown), primary user account number (not shown), address information (not shown) and select method of payment—drop down box (credit card, wire order, or corporate check) 852a. The primary user's manager inputs the selected payment method in the data entry field 852a. If the selected method was by credit card, then the manager will fill in the following data entry fields: card holder's first name 852b, card holder's last name 852c, credit card statement zip code 842g, credit card (type) 854d, credit card number 854e, expiration month 852f, expiration year 852i, country 852h and amount billed (not shown). The terms and conditions for credit cards purchased are displayed for the primary user's manager in the display field or box 852j and, if approved, the manager checks the “I approve” checkbox 852k. After approving the conditions, the primary user's manager actuates a “purchase now” button 854a, whereby the credit card is charged and the transaction is completed. The manager can also cancel a transaction by clicking on the “reset” button 852b, and/or change the data entered into the data entry fields 852a-h by actuating the “reset” button 854c.

Step 622 (FIG. 6A) determines whether or not payment has been successfully processed. In the example of paying in step 620 by credit card, payment is completed successfully when the primary user's manager actuates the “purchase now” button 854a (FIG. 7J). In a further illustrative embodiment where payment is made by check or wire, the process is not successfully completed until the check has cleared the primary user's bank. If payment is not successfully made, step 624 initiates the transmission of a message, e.g., by Email, to the primary user purchasing the currency units informing it that the payment process had failed.

If payment has been successfully completed as determined in step 622, step 626 (FIG. 6A) will post the purchased currency units to the account of the primary user making the purchase. The accounts of the primary user or users are maintained by the host computer 14 in the data base of accounts 18 as shown in FIG. 1. After posting the currency units, step 628 generates and displays a “purchase online primary user currency confirmation” web page 860 as shown in FIG. 7K. This web page 860 displays the confirmation number, the quantity and the cost of the primary user online currency units purchased, along with all applicable taxes and processing fees. There are also dynamic payment instructions displayed depending on the payment type selected on the payment screen. In particular, the web page 860 includes the following display fields: payment instructions (wire order, primary user check) 862a, credit card message 862b, the confirmation number 862c, the total online currency units purchased 862d, expiration date 862e, per currency unit cost 862f, total currency unit cost 862g, processing fee 862h, applicable taxes 862i and k, and the total purchase cost 862l.

After displaying the confirmation number in step 628 (FIG. 6A), the process 600 moves to step 654 to test whether the purchased currency points have been posted to the primary user's account. If posted, the process moves to step 658, whereby the process 600 is returned to the manage currency unit home page 950 (FIG. 7T), which permits the user's manager to view a summary of its account. If the points are not posted, step 656 cancels the purchase of the on-line currency units, notifies the primary user's manager that the on-line currency units were not purchased, and effects a refund to the primary user's credit card. If in step 614 (FIG. 6A), the primary user's manager clicks the purchase certificate currency button 832b (FIG. 7H), the process moves to step 631. In step 631, the process 600 returns to the manage user currency units web page 950 (FIG. 7T) to provide a summary of the user's currency account.

If on the other hand, the primary user manager had actuated in step 632 (FIG. 6A) the “purchase certificate currency units” button 954b (FIG. 7T), which appears on a “manage currency units home” web page 950 as shown in FIG. 7T (as opposed to the “purchase online currency units” button 954a), the program moves to step 634, as shown in FIG. 6A. Step 634 determines (among other functions) whether the primary user wants to purchase online currency units or certificate currency units. If step 634 determines that the manager does not want to purchase online currency units (in other words, the manager wants to order certificate currency units), the process moves to step 660, which displays a “purchase primary user certificate currency units” web page 870 as shown in FIG. 7L. The web page 870 allows the primary user to purchase certificate dividend currency units by selecting the desired denominations and entering the quantity of each. This web page 870 also allows the primary user to review its purchase details. It has the added built-in functionality to allow the primary user to select a different certificate denomination or change the quantity of certificates to be purchased and to dynamically recalculate the costs of these currency units. In particular, the web page 870 includes the following display fields: primary user name 871a and its account number 871b. The primary user's manager also enters for each set of certificates the amount (denomination) in data field 872a and the quantity of certificate currency units to be purchased in the data field 872b. Then the total currency units for each set of certificates is calculated and is displayed in the display field 872c. After the primary user's manager has selected and entered the miles per certificate and the quantity of certificates, step 660 (FIG. 6A) dynamically recalculates all of the applicable costs when the primary user actuates the “calculate” button 874. In particular, web page 870 includes the following display fields: expiration date (optional) 876b, the cost per currency unit 876c, the total currency units cost 876d, the processing fee 876e, the fulfillment fee (not shown), the USFF—frequent flyer tax 876f (7.5%) as applied to the price of all transactions, the GST (7%) tax 876g applied to the price and processing fee of all Canadian transactions except for residents from Nova Scotia, Newfoundland and New Brunswick 876h, the QST (7.5%) applied to the price and processing fee for all transactions from residents of Quebec on the HST tax (15%) applied to the price and processing fee of all transactions from residents of Nova Scotia, Newfoundland and New Brunswick (not shown), and the total purchase cost 876h.

If the primary user's manager desires to continue the purchase of certificate currency units, the manager clicks-on a continue purchase button 878 as shown in FIG. 7L, which moves the process to step 662. In step 662, a “purchase certificate currency units—step 2” web page 880 is displayed in FIG. 7M. This web page 880 displays the total cost of the currency units purchased and captures payment and billing information depending on the primary user's preferred method of payment. For credit card payments, it may be required in one illustrative embodiment of this invention that the billing address be the same as the address associated with the credit card. In particular, the web page 880 includes the following display fields: the primary user name (not shown), the primary user account number (not shown) and the user's address information (not shown). The primary user manager selects one of the methods of payment including credit card, wire or check, and enters that method into a data entry field 881. If the selected method is by credit card, the manager also has to enter data into the following data entry fields: credit card holder's first name 882a, the card holder's last name 882b, the credit card statement zip code 882f, the credit card (type) 882c, the credit card's number 882d, the card's expiration month 882e, the card's expiration year 882h, and the county 882g. The total currency units are automatically calculated and displayed (not shown), and the terms and conditions of this sale of currency units is displayed in the display field or box 884 and, if acceptable, the primary user's manager checks the “I accept” box 886. Upon acceptance of the terms and conditions, the credit card account is charged and the transaction is completed. At this stage, the primary user's manager has the option of approving the currency units purchase, revising or resetting it, and canceling it. To approve the purchase, the manager clicks-on the purchase now button 888a. To revise, the manager actuates the reset button 888b, and to cancel, the manager clicks-on to the cancel button 888c.

Continuing in step 662 (FIG. 6A) and after actuating the purchase now button 888a (FIG. 7M), a “purchase certificate currency units” (order certificates) web page 890 as shown in FIG. 7N is displayed on the primary user manager's terminal 24 (FIG. 1). This web page 890 captures the shipping information required to deliver to the primary user the certificate currency units. In particular, web page 890 includes data entry fields for collecting the following shipping data: the primary user name 892a, the contact's or manager's first name 892c, the contact's last name 892b, and the address information 892d. If the manager wishes to continue with the certificate purchase, the manager actuates a continue button 894, whereby step 664 determines whether the payment process (see discussion above concerning similar step 622) has been completed successfully. If not completed successfully, step 666 transmits a message, e.g., by Email, to the corresponding primary user's manager that the payment process was not completed successfully and the certificate purchase was cancelled. If payment was made as confirmed in step 664, step 668 displays a “purchase certificate currency confirmation” web page 900 as shown in FIG. 7O that shows to the corresponding primary user's manager a confirmation number and the details of the certificate purchase. This web page 900 displays the quantity and cost of the primary user currency units purchased (online or certificate), along with applicable taxes and processing fees. In particular, the web page 900 includes the following data display fields: selected payment method 902a, the confirmation number 902d, the number of certificate currency units per certificate 902e, the quantity of certificates 902f, the total certificate currency units 902g, the total currency units purchased 902h, the expiration date 902i, the total currency units cost 902r, the per currency unit cost 902j, total currency units cost 902k, the processing fee 902l, the applicable taxes 902m and n, and the total purchase cost 902o. Next in step 670, the transactions of purchasing currency certificates are sent, illustratively as a batch file, to a “fulfillment” site or entity, which interacts with the donee or recipient of the currency certificate as will be explained with respect to FIG. 6C. Thereafter in step 631, the process 600 returns the user to the manage user currency units web page 950 (FIG. 7T) to determine if the next required action is required, i.e., to award miles.

If the primary user's manager clicks in step 632 (FIG. 6A) on the “award currency units” button 954c that appears on the manage currency units home web page 950 (FIG. 7T), the process 600 moves to step 634. Step 634 displays an “award online primary user currency home” web page 960 as shown in FIG. 7U. This web page 960 allows the primary user to award its purchased currency units either online or to print a certificate to be given to the recipient (and redeemed online as will be explained below). In particular, web page 960 includes a link 964c to the account profile, an “award online currency units” button 964a, an “award certificates” button 964b, a link to the primary currency home page (not shown) (hosted on computer 14), a link to log out of the primary user account (host computer 14), a link to information about the primary user currency program (host computer 14), and various links to the loyalty program or the primary user web site (i.e., home, computer service, loyalty program information etc).

After actuating in step 634 the “award online currency units” button 964a, the process 600 moves to step 640, which displays an award online currency units web page 970 as shown in FIG. 7V. This web page 970 allows the primary user to award its online primary user currency units to selected of the individual currency recipients. Once the recipient's account information and the amount of currency units to be awarded by the primary user is entered into the data entry fields 972a-e of the web page 970, the primary user clicks in step 640 on the award currency units now button 974 to award the currency units to the selected currency recipient(s). In particular, the web page 970 includes the following data display fields: the currency account number of the recipient 972a, the last name of the recipient 972b, the first name of the currency recipient 972c, the email address of the currency recipient 972d, and the number of currency units to be awarded 972e.

After each recipient's data is entered in step 640, step 642 determines whether the primary user has a sufficient number of currency units in its account to purchase all of the units which were entered in the data fields 972e (FIG. 7V) in step 640. If there are not sufficient currency units, the process 600 moves to step 646, which cancels this currency awarding transaction, before returning to step 658 to return to the manage user currency web page 950 (FIG. 7T) which presents a summary of the user's account. If the primary user has a sufficient number currency units to make the awards entered into the web page 970 (FIG. 7V) as determined by step 642, the process 600 moves to step 644, which conducts a validation of the recipient's account number, to determine a valid format and also to determine that the account is valid and its information can be confirmed. If valid as determined in step 644, a signal indicative thereof is generated. If a recipient is not validated as determined in step 646, step 646 cancels the currency units awarding transaction for that or those recipients. On the other hand if the recipient is validated as indicated by the indicative signal, step 650 posts the awarded currency units to the recipient's account, before step 652 generates a confirmation number which is displayed in the display field 976 of the web page 970 along with a confirmation message. If the currency units are successfully deposited to the accounts of the designated recipients, the process proceeds to step 658, thereby returning to the manager user currency units home page 950 (FIG. 7T). If the currency units are not successfully posted to the accounts of the designated recipients, step 656 cancels the awarding transaction(s) to the corresponding recipients and emails messages to the corresponding recipients indicative of failing to post their award.

In an illustrative embodiment of this invention, the award online currency web page 970 includes a link (not shown in FIG. 7V) to a print certificate. When the primary user manager clicks onto the print certificate link, the process 600 then displays an “award online certificate—home” page 980 as shown in FIG. 7W. This web page 980 enables the primary user to give a certificate to a selected recipient, to gather contact data about the recipient, and to set the number of currency units to be given to the recipient. It is not necessary to have recipient information to print a certificate. The primary currency user can print and distribute without knowing recipient information, because the currency recipient can perform the redemptions. The web page 980 includes the following data entry fields to facilitate the entry by the primary user of the currency recipient's data: the recipient's account number 982a, the recipient's first and last names 982b and c, the recipient's email address 982d, and the number of currency units to be awarded to the recipient 982e.

When the primary user clicks on a “preview certificate” button 984, the process moves to the next step (not shown), which displays an “award online certificate—print certificate” web page 990 as shown in FIG. 7X. This web page 990 displays an online certificate to be given by the primary user, permitting the primary user manager to preview the online currency certificate before giving it to the selected currency recipient. The recipient will redeem the certificate online as will be discussed below with respect to FIG. 6C. In particular, the web page 990 includes the following data display fields: a congratulations message 992a, the number of currency units awarded 992b, the recipient's first and last names 992c, and an unique certificate number 992d. The host computer 14 generates the unique certificate numbers to be printed on the certificates to be issued. The primary user previews this certificate shown on the web page 990 to determine whether it is ready to be given to the selected currency recipient and, if ready, actuates a “print certificate” button 994b, whereby the certificate is “printed out” at the terminal 24 to provide a hard copy of the certificate to be given to the currency recipient. After printing out the certificate, the primary user will return to the award miles home web page 980 as shown in FIG. 7W. If the certificate needs to be changed, the primary user can click on the “cancel” button 994a, whereby the process returns to the previous web page 980 to permit the primary user to revise the certificate. In an alternative embodiment of this invention, the certificate could be sent as an email to the designated recipient, after the certificate has been redeemed by the designated currency recipient.

Further as shown in FIG. 7W, the award online certificates—home web page 980 includes an award currency transaction search link 982f. When the primary user manager clicks-on the link 982f, the process links to an “awarded primary user currency search page” 1000 as shown in FIG. 7Y. This web page 1000 allows the primary user to search through all of the currency units awarded transactions by entering the confirmation number, account number, first and last name or status. It also has the added built-in functionality to search by transaction date range, minimizing returned results of all relevant transaction. In particular, the web page 1000 includes means for entering search parameters in the following data entry fields to find a particular award transaction: confirmation number 1002a, account number 1002b, the first name 1002c, the last name 1002d, the status (completed, pending or canceled) 1002e, the transaction date from 1002g, the transaction date to 1002i, and the purchase type 1002f. The web page 1000 further includes a search button 1004a, cancel button 1002c, and a reset button 1002b. When the data parameters have been inserted in the data fields 1002a-i, the primary user manager clicks-on the “search” button 1004a, whereby the selected award transactions are displayed on an “awarded primary user currency results” web page 1010 as shown in FIG. 7Z. The manager can also revise the parameters by actuating the reset button 1004, before entering new search parameters. Further, the manager can cancel a search by clicking onto the cancel button 1004c.

Still referring to FIG. 7Z, this “award primary user currency search results” web page 1010 displays the associated transaction details related to the search parameters entered above. The confirmation number, transaction date, recipient's first and last name, number of currency units awarded and the transaction status (complete, pending or canceled) are displayed on the web page 1010. In particular, the web page 1010 includes the following display fields for displaying the search results: the confirmation number 1012a, the transaction date 1012b, the account number 1012c, the last name of the primary user contact 1012d, the number of miles awarded 1012i, and the transaction status (complete, pending or canceled) 1012j. The web page 1010 further includes a “go back” button 1014, which may be actuated by the primary user manager to return to the previous “awarded primary user currency search” web page 1000, wherein the parameters of the search may be revised or cancelled as explained above.

As described above with respect to FIG. 7X, the award online certificate—print certificate web page 990 displays an online certificate for the primary user to print or email to its recipient. As will be described below with respect to FIGS. 6C and 7AC, the recipient can redeem the certificate on line. In particular, the web page 990 provides a congratulations message at the display data field 992a, and a link 992e to a primary user redemption web site set up on the host computer 14. The award recipient may click on the link 992e and is connected in step 710 as shown in FIG. 6C to a “redeem primary user certificate currency units” web site 1040 as shown in FIG. 7AC. Next in step 712, the redeem web page 1040 is displayed, whereby the currency recipient of the awarded currency units enters its account number in data entry field 1042b, and its first and last names in data entry fields 1042c and d. Next in step 714, a procedure stored in the database 18 validates the recipient's account based on criteria is set by the currency issuer, e.g., the name and account number of the currency recipient. Next, step 716 determines whether the current recipient is a valid member of the issuer of the awarded currency units. If not a valid member, step 718 generates and transmits to the invalidated member's terminal 26 a real time error message indicating that the recipient was not validated as a currency member of the related currency issuer and to provide information, whereby the recipient may correct such error or find out the details of why he/she was invalidated. If on the other hand, step 716 validates the currency recipient as a valid member of the related currency issuer, the recipient enters in step 720 its certificate number in the data entry field 1042a of the redeem currency web page 1040. Next, step 722 decrypts the entered certificate number before transmitting it via the Internet 12 to the host computer 14 (FIG. 1), where in step 724 the number of the received certificate is tested as to whether it is valid or not. In particular, the certificate number is compared with a list of all of the certificate numbers that have been validly issued by the related issuer. If the number does not correspond to a number on this list, i.e., the certificate number is not valid, step 726 transmits a real-time error message identifying the type of the error and prompting the recipient to reenter its certificate number. If on the other hand the certificate number is found in step 724 to be valid, the status of the certificate, i.e., whether it was or was not valid, is looked up in a certificate status database. If the certificate has already been redeemed as determined in step 732, step 728 generates and transmits to the currency recipient a real time error message stating that the awarded certificate has been redeemed. On the other hand if step 732 indicates that the awarded certificate has not been redeemed, step 734 sets a flag in the certificate status database 18 indicating that the current certificate has now been redeemed. Thereafter, step 736 displays at the currency recipient's terminal 26 a “redeem corporate certificate miles confirmation” web page 1050, as shown in FIG. 7AD, which displays the confirmation number for the certificate miles redeemed, the recipient's name and account number. In particular, the web page 1050 includes the following display fields: the confirmation number 1052a, the certificate number 1052b, the recipient's account number 1052c, the recipient's last name 1052d, and the recipient's first name 1052e. After displaying the confirmation number on the web page 1050, a message is sent from the host computer 14 to the primary issuer's terminal 28 to transfer the awarded currency units from the primary user's account to the account of the recipient of the awarded currency units. Finally when the transfer of currency units to the recipient has been completed in step 738, step 740 transmits, e.g., by Email, to the recipient to which currency units were awarded a message confirming that the currency has now been deposited to the recipient's account.

The primary user's manager may link from step 632 (FIG. 6A) via either the web page 950 (FIG. 7T) or the web page 960 (FIG. 7U) to step 636, which displays a “purchase primary user currency search” web page 1020 as shown in FIG. 7AA. This web page 1020 enables the primary user to search for online or certificate primary user currency units that have been purchased by the primary user. The primary user can search their purchases by confirmation number, purchase type (online or certificate) and by transaction date range. In particular, the web page 1020 includes that the following data entry fields to permit entry of the parameters for a particular search of the purchased currency units transactions: confirmation number 1022a, the purchase type 1022b, the purchase status 1022c, the transaction date “from” 1022d, and the transaction date “to” 1022e.

After the primary user manager has entered the desired search parameters into the data entry fields 1022a-1022e, the primary user manager may click onto a “search” button 1024a, whereby the transactions are searched and those corresponding to the entered parameter(s) are displayed in step 638 (FIG. 6A). In particular, the web page 1030, as shown in FIG. 7AB, displays the associated transaction details related to the entered search parameters. It displays: the confirmation number, transaction date, purchase type (online/certificate), amount of currency units, quantity of certificates, total currency units purchased and purchase status. In particular, web page 1030 includes the following data display fields to display the associated transaction details: confirmation number 1032a, the transaction date 1032b, the purchase type 1032c, the amount of currency units purchased 1032d, the certificate quantity 1032e, the total currency units purchased 1032f, and the purchase status 1032g.

Referring now to FIG. 7T, there is shown the manage primary user currency web page 950, which includes the “purchase online currency” button 954a, the purchase certificate currency button 954b, the “award currency units” button 954c, and the “convert online currency to certificate currency” button 954d. This web page 950 allows the primary user to view in step 634 (FIG. 6A) its primary user account balance for online and certificate currency units. The link 954a entitles the user to purchase online currency units. The link 954b entitles the user to purchase certificate currency. The link 954c enables the user to award online currency units. A link (not shown) entitles the user to secure a currency units transaction list. A link (not shown) enables the user to award currency units on the transaction list. The web page 950 includes the following data display fields: the name of this user's contact or manager 952a, the user's name 952b, the user's account number (not shown), the total currency purchased by the user 952f, the total miles available to be awarded (not shown), the total miles awarded by the user 952g, the total miles purchased by the user 952j, the user's current account balance 942m, and the total miles purchased 952o.

When the primary user manager clicks on the convert online currency button 954d, the process 600 moves from step 632 to another step (not shown), which displays at a primary user's terminal 24 a “convert online currency—step 1” web page 910 as shown in FIG. 7P. This web page 910 allows the primary user to select and enter into the data entry fields 912a and b the certificate denomination and quantity of certificates respectively, into which the primary user would like to convert to its online currency units. The primary user's manager clicks on a “calculate” button 914 to display the results of the request. The results of the calculation are displayed in the following data display fields: the total miles converted 916a, the online account balance 916b, the expiration date 916c, the fulfillment fee 916d, the Federal taxes 916e, the GST tax 916f, and the total purchase cost 916g. The primary user's manager has the ability to view the results of the calculation based on the originally entered denomination and quantity of certificates and to edit these parameters, before again actuating the calculate button 914 to display the results in the data display fields 916a-g.

If the primary user's manager is satisfied with the displayed cost(s), he/she clicks on the “continue purchase” button 918, whereby the process 600 displays a “convert online currency—step 2” web page 920 as shown in FIG. 7Q. This web page 920 captures the shipping information required to deliver the primary user's certificate currency to the primary user's currency recipient. In particular, the web page 920 includes the following data fields for receiving: the name of the primary user 922a, the first name of the user's contact or manager 922b, the last name of the contact 922c, and address information of the contact 922d-q.

If the primary user's manager wants to convert its online currency, the manager clicks on the continue button 924, where by the process displays the “convert online currency—step 3” web page 930 as shown in FIG. 7R. This web page 930 displays the total cost to convert the primary user's online currency units into certificate currency units, before capturing payment and billing information depending on the customer's preferred method of payment. For credit card payments, it is required in one illustrative embodiment of this invention that the billing address be the same as the address associated with the credit card. Upon acceptance of the terms and conditions, the credit card is charged and the transaction is completed. In particular, the web page 930 includes the following data entry fields for receiving billing data: the user name (not shown), the user account number (not shown), the user address information (not shown), the select method of payment—drop down box (credit card, wire order, or corporate cheque) 931, the card holder's first name 932a, the card holder's last name 932b, the credit card statement zip code 932f, the credit card (type) 932c, the credit card number 932d, the expiration month 932e, the expiration year 932j, and the amount billed (not shown). If the primary user's manager accepts the charges, he/she is prompted to review the terms and conditions of the currency sale as appear in the display window 932h and, if satisfactory, the manager marks the “I accept” checkbox 932i, before clicking on a purchase now button 934a to make the sale final. If the manager is not satisfied with the cost or wishes to change the data, the manager may cancel the transaction by clicking on the “cancel” button 934c or may edit the entered data by actuating the reset button 934b.

After the primary user's manager has accepted the purchase, a “convert online currency confirmation” web page 940 is transmitted to the corresponding primary user's manager's terminal 24 to confirm that the conversion of online to certificate currency units has been successfully completed as shown in FIG. 7S. This web page 940 displays the confirmation number, the total currency units converted, the applicable taxes and the processing fees. There are also dynamic payment instructions displayed depending on the payment type selected on the payment web page 930 as shown in FIG. 7S. In particular, the web page 940 includes data display fields for the following purchase details: the payment instructions (wire order, corporate cheques, credit card) 941, the confirmation number 942a, the total converted currency units 942b, the expiration date 942c, the fulfillment fees 942d, the applicable taxes 942e and f, and the total cost 942g.

Upon actuating the award currency button 954c of the manage user currency units web page 950 (FIG. 7T), the process moves to the “award online certificates—home” web page 980 (FIG. 7W), which includes an award currency transaction search link 982f. When the primary user's manager clicks-on the link 982f, the process links to an “awarded primary user's currency search” page 1000 as shown in FIG. 7Y. This web page 1000 allows the primary user to search through all of the awarded currency units transactions by entering the confirmation number, account number, first and last names of the related currency recipients or status of such transactions. It also has the added built-in functionality to search by transaction date range, minimizing returned results of all relevant transactions. In particular, the web page 1000 includes means for entering the search parameters in the following data entry fields to find a particular award transaction: confirmation number 1002a, the currency account number assigned to the currency recipient by the primary currency issuer 1002b, the first name of the currency recipient 1002c, the last name of the currency recipient 1002d, the status (complete, pending or canceled) 1002e, the transaction date “to” 1002i, the transaction date “from” 1002g, and the purchase type 1002f. The web page 1000 further includes a “search” button 1004a, a cancel button 1002c, and a reset button 1002b. When the data parameters have been inserted in the data fields 1002a-i, the primary user's manager clicks-on the “search” button 1004a, whereby the selected award transactions are displayed on an awarded primary user currency results web page 1010 as shown in FIG. 7Z. The manager can also revise the parameters by actuating the “reset” button 1004, before entering new search parameters. Further, the manager can cancel a search by clicking onto the cancel button 1004c. In particular, the web page 1010 displays the results of selected award transactions upon the following display fields: the confirmation number for a particular transaction 1012a, the date of the particular transaction 1012b, the account number assigned to a particular currency recipient by a primary currency issuer 1012c, the last name of the currency recipient 1012d, the type of transaction (online or certificate) 1012e, whether the certificate has been redeemed 1012f, the number of currency units awarded by the certificate 1012g, the number of certificates 1012h, the total currency units redeemed/awarded 1012i, and the status of the transaction (complete/pending) 1012j. Further, the web page 1010 includes a “go back” button, which the user's manager can actuate to return to the previous web page 1000 and adjust the search parameters.

Benefits, other advantages, objects, and solutions to problems have been described above with regard to specific embodiments. However, the benefits, advantages, solutions to problems, objects, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A system for managing the distribution of currency units from at least one currency issuer to at least a selected one of a plurality of currency recipients associated with the currency issuer who maintains an account for keeping the balance of currency units held by each of its currency recipients, at least one primary user acquiring currency units from the one currency issuer and distributing same to selected of the plurality of currency recipients, each of the currency recipients, the one currency issuer and the one primary user having a computer terminal which is connected to a network, said managing system comprising a host computer which is programmed to:
a) generate and transmit over the network a first message to the one primary user's computer terminal soliciting information as to the characteristics of the one primary user;
b) retrieve the characteristics information entered by the one primary user and generate and transmit over the network to the one currency issuer's computer terminal a second message bearing the retrieved characteristics information whereby the one currency issuer may approve or decline to issue currency units to the one primary user; and
c) respond to the one currency issuer's approval of the one primary user to generate and transmit over the network a third message bearing a unique password to the one primary user's computer terminal, whereby the approved one primary user is enabled to communicate with the one currency issuer to acquire currency.

2. The managing system as claimed in claim 1, wherein said host computer is further programmed to cause the third message to set up an account for the one primary user for keeping the balance of the current units held by the one primary user.

3. The managing system as claimed in claim 2, wherein said host computer is further programmed to respond to the distribution of the currency units from the one primary user to at least a selected one of the plurality of currency recipients, whereby the distributed currency units are deducted from the account of the one primary user and added to the account of the selected one currency recipient.

4. The managing system as claimed in claim 1, wherein said network is the Internet.

5. The managing system as claimed in claim 1, wherein said host computer is further programmed to establish an interface that is accessible by the one primary user and that includes a field for the entry of data from the one primary user for effecting the distribution of currency units from the one primary user to at least a selected one of the plurality of currency recipients.

6. The managing-system as claimed in claim 1, wherein there is further included a second currency issuer that issues a second currency differing from the first currency issued by the first mentioned currency issuer, and said host computer is further programmed to receive from the one currency user a prompt and to determine from the prompt whether the one primary user seeks to acquire the second currency or the first mentioned currency, and to generate and transmit the second message to the second or first mentioned currency issuer according to whether the one primary user sought the first mentioned or second currency, respectively.

7. The managing system as claimed in claim 6, wherein said host computer is further programmed to respond to the approval of the first mentioned currency issuer to transmit to the first mentioned currency issuer the third message bearing a unique password to enable communication with the first mentioned currency issuer, and to respond to the approval of the second mentioned currency issuer to transmit to the second currency issuer the third message bearing its unique password to enable communication with the second currency issuer.

8. The managing system as claimed in claim 1, wherein there is further included a second primary user, and said host computer is further programmed to the receipt of the prompt of the first mentioned primary user to transmit the first message to the first mentioned primary user, and to the receipt of the prompt of the second primary user to transmit the first message to the second primary user.

9. A method for managing the distribution of currency units from at least one currency issuer to selected of a plurality of currency recipients associated with the one currency issuer who maintains an account for keeping the balance of currency units held by each of its recipients, at least one primary user acquiring currency units from the one currency issuer and transmitting same to selected of the plurality of currency recipients, said method comprising the steps of:
a) responding to a request from the one primary user for the approval of the one currency issuer to acquire currency units from the one currency issuer by facilitating a communication of information regarding the characteristics of the one primary user to the one currency issuer, whereby the one currency issuer may approve or decline to issue currency to the one primary user;
b) if the one currency issuer is approved, creating an account for the one primary user to track its balance of currency units;
c) distributing a set of currency units from the one currency issuer to the one currency user; and
d) prompt the adding of the distributed set of currency units to the account of the one primary user.

10. The method of managing as claimed in claim 9, wherein said method further comprises the step of distributing a second set of currency units from the one primary user to the selected one of the plurality of currency recipients.

11. The method of managing as claimed in claim 10, wherein said method further comprises the step of deducting the second set of distributed currency units from the one primary user's account and adding the second set of distributed currency units to the account of the selected one currency recipient.

12. A method for managing the distribution of currency units from at least one currency issuer to selected of a plurality of currency recipients associated with the one currency issuer who maintains an account for keeping the balance of its currency units held by each of its currency recipients, at least one primary user acquiring currency units from the one currency issuer, said method comprising the steps of:
a) gathering and transmitting information about the primary user to the one currency issuer to facilitate its approval or decline to issue currency units of the one currency issuer to the one primary user;
b) if the one currency issuer approves of the primary user information, creating an account for keeping the balance of currency units of the one currency issuer acquired by the one primary user and assigning a pass word to the approved one primary user, whereby the one primary user may gain access to its account; and
c) using the password to gain access to the one primary user's account.

13. A method for managing as claimed in claim 13, wherein said method further comprises the step of transferring a first set of currency units from the one currency issuer to the accessed account of the one primary user.

14. A method of managing as claimed in claim 13, wherein said method further comprises the step of transferring a second set of currency units from the one primary user to selected of the plurality of currency recipients.

15. A method of managing as claimed in claim 14, wherein said method further comprises the step of deducting the second set of distributed currency units from the one primary user's accessed account and adding the second set of distributed currency units to the account(s) of selected of the currency recipient(s).

16. A method managing as claimed in claim 15, wherein said method further comprises the step of selecting which of the plurality of currency recipients to which the one primary user desires to distribute its currency units and the number of it currency units to be distributed to each of the selected currency recipients.

17. A method of managing as claimed in claim 15, wherein said method further comprises the step of comparing the number of currency units in the accessed account of the one primary user with the selected number of currency units to be distributed and, if equal to or more, distributing the selected number of currency units of the one primary user to the account(s) of the selected currency recipient(s).

18. A method of managing the distribution of currency units from at least one currency issuer to at least a selected one of a plurality of currency recipients associated with the currency issuer who maintains an account for keeping the balance of currency units held by each of its currency recipients, the account of each currency recipient being identified by a unique account identification, at least one primary user acquiring currency units from the one currency issuer and distributing same to selected of the plurality of currency recipients, each of the currency recipients, the one currency issuer and the one primary user having a computer terminal which is connected to a network, said method comprising the steps of:
a) prompting the one primary user to determine the number of currency units to be distributed and whether the selected number of currency units are to be transmitted by a first or second transaction, the first transaction differing from the second transaction;
b) if the selected number of currency units are to be transmitted by the first transaction, prompting the one primary user to assign a unique account identification to the currency recipient to which the first transaction will be transmitted; and
c) if the selected number of currency units are to be transmitted by the second transaction, assigning a unique identification to the second transaction.

19. The managing method as claimed in claim 18, wherein said method further comprises a step of effecting the first transaction by adding the selected number of currency units to the account of the one currency recipient identified by the unique account identification.

20. The managing method as claimed in claim 18, wherein said method further comprises a step of effecting the second transaction by receiving a message from the one currency recipient bearing the unique account identification of its account, and adding the selected number of currency units to the account of the one currency recipient identified by the unique account identification.

21. The managing method as claimed in claim 20, wherein said effecting the second transaction step comprises a sub-step of issuing at least one certificate to the one currency recipient.

22. The managing method as claimed in claim 21, wherein the steps of said method are effected by a programmed host computer, said host computer programmed to establish a cite for the redemption of the certificate, and said method further comprised the step of imparting to the certificate an address to the redemption site, whereby the one currency recipient can transmit its unique account identification to the redemption site.

23. The managing method as claimed in claim 20. wherein the message from the one currency recipient bears the unique identification of the second transaction, said method comprises the further steps of receiving the one currency recipient's message and storing the unique identification of the received second transaction.

24. The managing method as claimed in claim 23, wherein said method comprises the further steps of receiving a second message from the one currency recipient and comparing the unique identification of the second transaction carried by the second message with all of the previously stored unique identifications and, if a match of the unique identifications is not found, adding the selected number of currency units to the account of the one currency recipient identified by the unique account identification.

25. The managing method as claimed in claim 24, wherein said method comprises the further steps of determining whether a match of unique identifications is found and, if a match of the unique identifications borne by received messages is found, transmitting to the one currency recipient a message over the network that the certificate bearing the unique identification borne by the second message has been previously redeemed.

26. The managing method as claimed in claim 18, wherein said method comprises the further steps of storing each unique account identification that is assigned to a second transaction and, upon receipt of a message from the one currency recipient that bares its unique identification, marking the corresponding previously stored currency unit account identification to indicate that the second transaction that bares the unique account identification had been redeemed.

27. A method for managing the distribution of currency units from at least one currency issuer to selected of a plurality of currency recipients associated with the one currency issuer who maintains an account for keeping the balance of the currency units held by each of its currency recipients, at least one primary user acquiring currency units from the currency issuer, said method comprising the steps of:
a) in response to the request of the one primary user, effecting a plurality of transactions to acquire currency units from the one currency issuer, the characteristics of each of the plurality of transactions being determined by a plurality of parameters;
b) storing each of the plurality of transactions in a memory;
c) selecting the parameter(s) of the desired characteristics; and
d) search the stored transactions for the desired characteristics set by the parameters.

28. The managing method as claimed in claim 27, wherein said method comprises the further steps of determining whether a transaction will be of a first or second type, the transaction of the first type includes a unique account identification of the currency recipient to which the first type of transaction will be transmitted, the transaction of the second type includes a unique identification of the transaction of the second type, the parameters indicating whether the transaction is either of the first or second type.

29. The managing method as claimed in claim 28, wherein said parameter(s) are selected from a group comprising the date of effecting the transaction, the manner of payment by the primary user, the status of acceptance by the currency issuer to distribute currency units to a particular primary user, and the identification attached to a message confirming the acceptance of an order for currency units placed by a primary user.

30. A method for managing the distribution of currency units from at least one currency issuer to selected of a plurality of currency recipients associated with the currency issuer who maintains an account for keeping the balance of the currency units held by each of its currency recipients, at least one primary user acquiring currency units from the one currency issuer and having an account for storing the number of currency units received from the one currency issuer, said method comprising the steps of:
a) in response to the request of the one primary user, effecting a plurality of transactions to distribute the currency units stored in the one primary user's account to select of the plurality of currency recipients;
b) storing each of the plurality of effected transactions in a memory;
c) select the parameter(s) of the desired transaction characteristics; and
d) search the effected transactions stored in the memory for the desired characteristics set by the parameters.

31. The managing method as claimed in claim 30, wherein said method comprises the further steps of determining whether a transaction will be of a first or second type, the transaction of the first type includes a unique account identification of the currency recipient to which the first type of transaction will be transmitted, the transaction of the second type includes a unique identification of the transaction of the second type, the parameters indicating whether a transaction is either of the first or second type.

32. The managing method as claimed in claim 31, wherein said parameter(s) are selected from a group comprising the date of effecting the transaction, the status of acceptance by the one currency issuer to distribute currency units to a particular primary user, the manner of payment by the primary user, the number of currency units accumulated, and the identification attached to a message confirming the acceptance of an order for currency units placed by the one primary user.
